(19) United States
(12) Patent Application Publication
(10) Pub. No.: US 2025/0350987 A1
(43) Pub. Date: Nov. 13, 2025

(54) Channel State Information Report Triggering

(71) Applicant: Comcast Cable Communications, LLC, Philadelphia, PA (US)

(72) Inventors: Ali Cagatay Cirik, Chantilly, VA (US); Gautham Prasad, Herndon, VA (US); Esmael Hejazi Dinan, McLean, VA (US); Hsin-Hsi Tsai, Taichung City (TW); Hua Zhou, Vienna, VA (US); Hyoungsuk Jeon, Centreville, VA (US); Kyungmin Park, Vienna, VA (US); Mohammad Ghadir Khoshkholgh Dashtaki, Reston, VA (US)

(21) Appl. No.: 19/203,512

(22) Filed: May 9, 2025

Related U.S. Application Data
(60) Provisional application No. 63/644,735, filed on May 9, 2024.

(51) Int. Cl. H04W 24/10

(52) U.S. Cl. CPC H04W 24/10

(57) ABSTRACT

A wireless device may communicate with a base station. CSI reporting may be initiated by a wireless device. Candidate reference signals may be provided to the wireless device. Multiple counters may be used for the candidate reference signals such that each candidate reference signal may have a respective counter. A counter of a candidate reference signal may be incremented, for example, based on a radio link quality of the candidate reference signal being better than (e.g., by a threshold value) a radio link quality of a current reference signal used for CSI reporting. A CSI report for the candidate reference signal may be triggered, for example, based on the counter of the candidate reference signal reaching a maximum count.

### CROSS-REFERENCE TO RELATED APPLICATIONS

This application claims the benefit of U.S. Provisional Application No. 63/644,735 filed on May 9, 2024. The above-referenced application is hereby incorporated by reference in its entirety.

### BACKGROUND

A wireless device communicates with a base station. The wireless device receives configuration parameters for communicating with the base station via a cell. The wireless device uses configuration parameters to determine power for uplink transmission.

### SUMMARY

The following summary presents a simplified summary of certain features. The summary is not an extensive overview and is not intended to identify key or critical elements.

A wireless device may communicate with a base station. The wireless device may send a report, such as a channel state information (CSI) report, to the base station. Such a CSI report may be triggered by the wireless device, for example, based on radio link quality measurements. Radio resource control (RRC) messaging may be used to configure the wireless device with a list/set of candidate reference signals. Each candidate reference signal in the list/set of candidate reference signals may have a respective counter. The wireless device may increment a counter of a candidate reference signal, for example, based on a radio link quality of the candidate reference signal being better than (e.g., by a threshold value) a radio link quality of a current reference signal used for CSI reporting. The wireless device may trigger a CSI report for the candidate reference signal, for example, based on the counter of the candidate reference signal reaching a maximum count. Additionally or alternatively, the wireless device may evaluate radio link qualities of each candidate reference signal with a common periodicity, for example, to help ensure that CSI report triggering events occur only for candidate reference signals that are consistently better than the current reference signal. Additionally or alternatively, one or more messages (e.g., RRC messaging) may configure a duration of time gap between the wireless device sending a notification of the CSI report and sending the CSI report, for example, to align the base station and the wireless device and/or to help ensure reception of the CSI report.

These and other features and advantages are described in greater detail below.

### BRIEF DESCRIPTION OF THE DRAWINGS

Examples of several of the various embodiments of the present disclosure are described herein with reference to the drawings.

FIG. 1A and FIG. 1B show example communication networks.

FIG. 2A shows an example user plane.

FIG. 2B shows an example control plane configuration.

FIG. 3 shows example of protocol layers.

FIG. 4A shows an example downlink data flow for a user plane configuration.

FIG. 4B shows an example format of a Medium Access Control (MAC) subheader in a MAC Protocol Data Unit (PDU).

FIG. 5A shows an example mapping for downlink channels.

FIG. 5B shows an example mapping for uplink channels.

FIG. 6 shows example radio resource control (RRC) states and RRC state transitions.

FIG. 7 shows an example configuration of a frame.

FIG. 8 shows an example resource configuration of one or more carriers.

FIG. 9 shows an example configuration of bandwidth parts (BWPs).

FIG. 10A shows example carrier aggregation configurations based on component carriers.

FIG. 10B shows example group of cells.

FIG. 11A shows an example mapping of one or more synchronization signal/physical broadcast channel (SS/PBCH) blocks.

FIG. 11B shows an example mapping of one or more channel state information reference signals (CSI-RSs).

FIG. 12A shows examples of downlink beam management procedures.

FIG. 12B shows examples of uplink beam management procedures.

FIG. 13A shows an example four-step random access procedure.

FIG. 13B shows an example two-step random access procedure.

FIG. 13C shows an example two-step random access procedure.

FIG. 14A shows an example of control resource set (CORESET) configurations.

FIG. 14B shows an example of a control channel element to resource element group (CCE-to-REG) mapping.

FIG. 15A shows an example of communications between a wireless device and a base station.

FIG. 15B shows example elements of a computing device that may be used to implement any of the various devices described herein

FIG. 16A, FIG. 16B, FIG. 16C, and FIG. 16D show examples of uplink and downlink signal transmission.

FIG. 17 shows an example of uplink transmission using a transmission configuration indicator (TCI) state.

FIG. 18A and FIG. 18B show examples of TCI state indication.

FIG. 19A, FIG. 19B, and FIG. 19C show examples of channel state information (CSI) reporting, triggered by a network.

FIG. 20A, FIG. 20B, and FIG. 20C show examples of CSI reporting, triggered by a wireless device.

FIG. 21 shows an example of a first mode/option for wireless device-initiated beam reporting, such as user equipment (UE)-initiated beam reporting (UEIBR).

FIG. 22 shows an example of a second mode/option for wireless device-initiated beam reporting, such as UEIBR.

FIG. 23 shows an example for beam failure recovery.

FIG. 24 shows an example for triggering a wireless device-initiated beam report.

FIG. 25 shows an example for triggering a wireless device-initiated beam report.

FIG. 26 shows an example method of CSI report triggering.

FIG. 27 shows an example method of CSI report triggering.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of wireless communication systems.

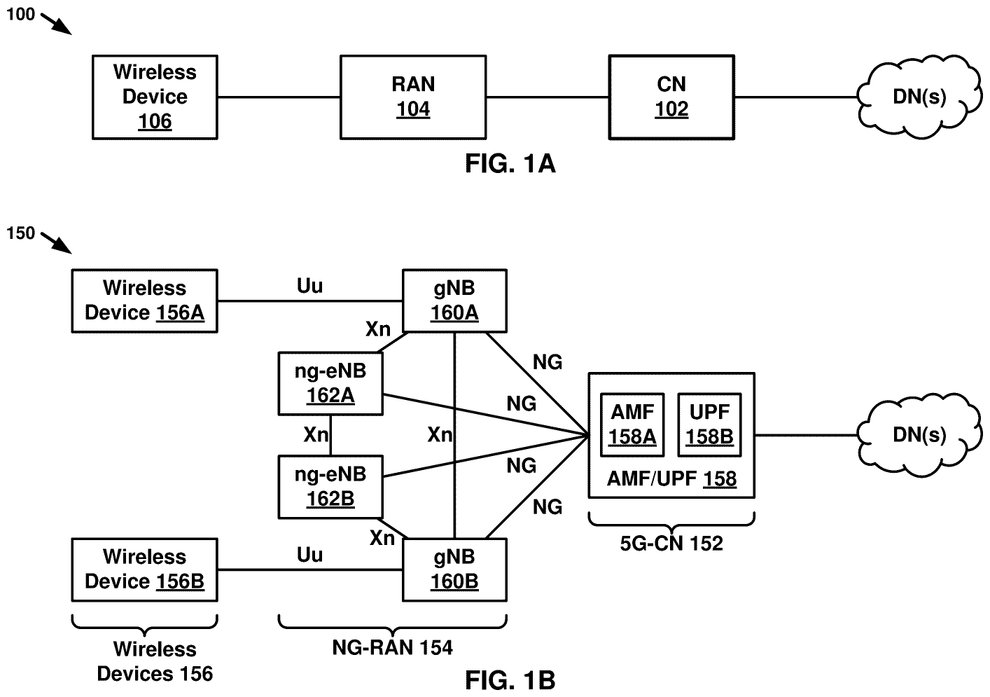

FIG. 1A shows an example communication network 100. The communication network 100 may comprise a mobile communication network). The communication network 100 may comprise, for example, a public land mobile network (PLMN) operated/managed/run by a network operator. The communication network 100 may comprise one or more of a core network (CN) 102, a radio access network (RAN) 104, and/or a wireless device 106. The communication network 100 may comprise, and/or a device within the communication network 100 may communicate with (e.g., via CN 102), one or more data networks (DN(s)) 108. The wireless device 106 may communicate with one or more DNs 108, such as public DNS (e.g., the Internet), private DNs, and/or intra-operator DNs. The wireless device 106 may communicate with the one or more DNs 108 via the RAN 104 and/or via the CN 102. The CN 102 may provide/configure the wireless device 106 with one or more interfaces to the one or more DNs 108. As part of the interface functionality, the CN 102 may set up end-to-end connections between the wireless device 106 and the one or more DNs 108, authenticate the wireless device 106, provide/configure charging functionality, etc.

The wireless device 106 may communicate with the RAN 104 via radio communications over an air interface. The RAN 104 may communicate with the CN 102 via various communications (e.g., wired communications and/or wireless communications). The wireless device 106 may establish a connection with the CN 102 via the RAN 104. The RAN 104 may provide/configure scheduling, radio resource management, and/or retransmission protocols, for example, as part of the radio communications. The communication direction from the RAN 104 to the wireless device 106 over/via the air interface may be referred to as the downlink and/or downlink communication direction. The communication direction from the wireless device 106 to the RAN 104 over/via the air interface may be referred to as the uplink and/or uplink communication direction. Downlink transmissions may be separated and/or distinguished from uplink transmissions, for example, based on at least one of: frequency division duplexing (FDD), time-division duplexing (TDD), any other duplexing schemes, and/or one or more combinations thereof.

As used throughout, the term “wireless device” may comprise one or more of: a mobile device, a fixed (e.g., non-mobile) device for which wireless communication is configured or usable, a computing device, a node, a device capable of wirelessly communicating, or any other device capable of sending and/or receiving signals. As non-limiting examples, a wireless device may comprise, for example: a telephone, a cellular phone, a Wi-Fi phone, a smartphone, a tablet, a computer, a laptop, a sensor, a meter, a wearable device, an Internet of Things (IoT) device, a hotspot, a cellular repeater, a vehicle roadside unit (RSU), a relay node, an automobile, a wireless user device (e.g., user equipment (UE), a user terminal (UT), etc.), an access terminal (AT), a mobile station, a handset, a wireless transmit and receive unit (WTRU), a wireless communication device, and/or any combination thereof.

The RAN 104 may comprise one or more base stations (not shown). As used throughout, the term “base station” may comprise one or more of: a base station, a node, a Node B (NB), an evolved NodeB (eNB), a gNB, an ng-eNB, a relay node (e.g., an integrated access and backhaul (IA B) node), a donor node (e.g., a donor eNB, a donor gNB, etc.), an access point (e.g., a Wi-Fi access point), a transmission and reception point (TRP), a computing device, a device capable of wirelessly communicating, or any other device capable of sending and/or receiving signals. A base station may comprise one or more of each element listed above. For example, a base station may comprise one or more TRPs. As other non-limiting examples, a base station may comprise for example, one or more of: a Node B (e.g., associated with Universal Mobile Telecommunications System (UMTS) and/or third-generation (3G) standards), an Evolved Node B (eNB) (e.g., associated with Evolved-Universal Terrestrial Radio Access (E-UTRA) and/or fourth-generation (4G) standards), a remote radio head (RRH), a baseband processing unit coupled to one or more remote radio heads (RRH s), a repeater node or relay node used to extend the coverage area of a donor node, a Next Generation Evolved Node B (ng-eNB), a Generation Node B (gNB) (e.g., associated with NR and/or fifth-generation (5G) standards), an access point (AP) (e.g., associated with, for example, Wi-Fi or any other suitable wireless communication standard), any other generation base station, and/or any combination thereof. A base station may comprise one or more devices, such as at least one base station central device (e.g., a gNB Central Unit (gNB-CU)) and at least one base station distributed device (e.g., a gNB Distributed Unit (gNB-DU)).

A base station (e.g., in the RAN 104) may comprise one or more sets of antennas for communicating with the wireless device 106 wirelessly (e.g., via an over the air interface). One or more base stations may comprise sets (e.g., three sets or any other quantity of sets) of antennas to respectively control multiple cells or sectors (e.g., three cells, three sectors, any other quantity of cells, or any other quantity of sectors). The size of a cell may be determined by a range at which a receiver (e.g., a base station receiver) may successfully receive transmissions from a transmitter (e.g., a wireless device transmitter) operating in the cell. One or more cells of base stations (e.g., by alone or in combination with other cells) may provide/configure a radio coverage to the wireless device 106 over a wide geographic area to support wireless device mobility. A base station comprising three sectors (e.g., or n-sector, where n refers to any quantity n) may be referred to as a three-sector site (e.g., or an n-sector site) or a three-sector base station (e.g., an n-sector base station).

One or more base stations (e.g., in the RAN 104) may be implemented as a sectored site with more or less than three sectors. One or more base stations of the RAN 104 may be implemented as an access point, as a baseband processing device/unit coupled to several RRHs, and/or as a repeater or relay node used to extend the coverage area of a node (e.g., a donor node). A baseband processing device/unit coupled to RRHs may be part of a centralized or cloud RAN architecture, for example, where the baseband processing device/unit may be centralized in a pool of baseband processing devices/units or virtualized. A repeater node may amplify and send (e.g., transmit, retransmit, rebroadcast, etc.) a radio signal received from a donor node. A relay node may perform the substantially the same/similar functions as a repeater node. The relay node may decode the radio signal received from the donor node, for example, to remove noise before amplifying and sending the radio signal.

The RAN 104 may be deployed as a homogenous network of base stations (e.g., macrocell base stations) that have similar antenna patterns and/or similar high-level transmit powers. The RAN 104 may be deployed as a heterogeneous network of base stations (e.g., different base stations that have different antenna patterns). In heterogeneous networks, small cell base stations may be used to provide/configure small coverage areas, for example, coverage areas that overlap with comparatively larger coverage areas provided/configured by other base stations (e.g., macrocell base stations). The small coverage areas may be provided/configured in areas with high data traffic (or so-called “hotspots”) or in areas with a weak macrocell coverage. Examples of small cell base stations may comprise, in order of decreasing coverage area, microcell base stations, picocell base stations, and femtocell base stations or home base stations.

Examples described herein may be used in a variety of types of communications. For example, communications may be in accordance with the Third-Generation Partnership Project (3GPP) (e.g., one or more network elements similar to those of the communication network 100), communications in accordance with Institute of Electrical and Electronics Engineers (IEEE), communications in accordance with International Telecommunication Union (ITU), communications in accordance with International Organization for Standardization (ISO), etc. The 3GPP has produced specifications for multiple generations of mobile networks: a 3G network known as UMTS, a 4G network known as Long-Term Evolution (LTE) and LTE Advanced (LTE-A), and a 5G network known as 5G System (5GS) and NR system. 3GPP may produce specifications for additional generations of communication networks (e.g., 6G and/or any other generation of communication network). Examples may be described with reference to one or more elements (e.g., the RAN) of a 3GPP 5G network, referred to as a next-generation RAN (NG-RAN), or any other communication network, such as a 3GPP network and/or a non-3GPP network. Examples described herein may be applicable to other communication networks, such as 3G and/or 4G networks, and communication networks that may not yet be finalized/specified (e.g., a 3GPP 6G network), satellite communication networks, and/or any other communication network. NG-RAN implements and updates 5G radio access technology referred to as NR and may be provisioned to implement 4G radio access technology and/or other radio access technologies, such as other 3GPP and/or non-3GPP radio access technologies.

FIG. 1B shows an example communication network 150. The communication network may comprise a mobile communication network. The communication network 150 may comprise, for example, a PLMN operated/managed/run by a network operator. The communication network 150 may comprise one or more of: a CN 152 (e.g., a 5G core network (5G-CN)), a RAN 154 (e.g., an NG-RAN), and/or wireless devices 156A and 156B (collectively wireless device(s) 156). The communication network 150 may comprise, and/or a device within the communication network 150 may communicate with (e.g., via CN 152), one or more data networks (DN(s)) 170. These components may be implemented and operate in substantially the same or similar manner as corresponding components described with respect to FIG. 1A.

The CN 152 (e.g., 5G-CN) may provide/configure the wireless device(s) 156 with one or more interfaces to one or more DNs 170, such as public DNS (e.g., the Internet), private DNS, and/or intra-operator DNs. As part of the interface functionality, the CN 152 (e.g., 5G-CN) may set up end-to-end connections between the wireless device(s) 156 and the one or more DNs, authenticate the wireless device(s) 156, and/or provide/configure charging functionality. The CN 152 (e.g., the 5G-CN) may be a service-based architecture, which may differ from other CNs (e.g., such as a 3GPP 4G CN). The architecture of nodes of the CN 152 (e.g., 5G-CN) may be defined as network functions that offer services via interfaces to other network functions. The network functions of the CN 152 (e.g., 5G CN) may be implemented in several ways, for example, as network elements on dedicated or shared hardware, as software instances running on dedicated or shared hardware, and/or as virtualized functions instantiated on a platform (e.g., a cloud-based platform).

The CN 152 (e.g., 5G-CN) may comprise an Access and Mobility Management Function (AMF) device 158A and/or a User Plane Function (UPF) device 158B, which may be separate components or one component AMF/UPF device 158. The UPF device 158B may serve as a gateway between a RAN 154 (e.g., NG-RAN) and the one or more DNs 170. The UPF device 158B may perform functions, such as: packet routing and forwarding, packet inspection and user plane policy rule enforcement, traffic usage reporting, uplink classification to support routing of traffic flows to the one or more DNs 170, quality of service (QOS) handling for the user plane (e.g., packet filtering, gating, uplink/downlink rate enforcement, and uplink traffic verification), downlink packet buffering, and/or downlink data notification triggering. The UPF device 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The wireless device(s) 156 may be configured to receive services via a PDU session, which may be a logical connection between a wireless device and a DN.

The AMF device 158A may perform functions, such as: Non-Access Stratum (NAS) signaling termination, NAS signaling security, Access Stratum (AS) security control, inter-CN node signaling for mobility between access networks (e.g., 3GPP access networks and/or non-3GPP networks), idle mode wireless device reachability (e.g., idle mode UE reachability for control and execution of paging retransmission), registration area management, intra-system and inter-system mobility support, access authentication, access authorization including checking of roaming rights, mobility management control (e.g., subscription and policies), network slicing support, and/or session management function (SMF) selection. NAS may refer to the functionality operating between a CN and a wireless device, and AS may refer to the functionality operating between a wireless device and a RAN.

The CN 152 (e.g., 5G-CN) may comprise one or more additional network functions that may not be shown in FIG. 1B. The CN 152 (e.g., 5G-CN) may comprise one or more devices implementing at least one of: a Session Management Function (SMF), an NR Repository Function (NRF), a Policy Control Function (PCF), a Network Exposure Function (NEF), a Unified Data Management (UDM), an Application Function (AF), an Authentication Server Function (AUSF), and/or any other function.

The RAN 154 (e.g., NG-RAN) may communicate with the wireless device(s) 156 via radio communications (e.g., an over the air interface). The wireless device(s) 156 may communicate with the CN 152 via the RAN 154. The RAN 154 (e.g., NG-RAN) may comprise one or more first-type base stations (e.g., gNBs comprising a gNB 160A and a gNB 160B (collectively gNBs 160)) and/or one or more second-type base stations (e.g., ng eNBs comprising an ng-eNB 162A and an ng-eNB 162B (collectively ng eNBs 162)). The RAN 154 may comprise one or more of any quantity of types of base station. The gNBs 160 and ng eNBs 162 may be referred to as base stations. The base stations (e.g., the gNBs 160 and ng eNBs 162) may comprise one or more sets of antennas for communicating with the wireless device(s) 156 wirelessly (e.g., an over an air interface). One or more base stations (e.g., the gNBs 160 and/or the ng eNBs 162) may comprise multiple sets of antennas to respectively control multiple cells (or sectors). The cells of the base stations (e.g., the gNBs 160 and the ng-eNBs 162) may provide a radio coverage to the wireless device(s) 156 over a wide geographic area to support wireless device mobility.

The base stations (e.g., the gNBs 160 and/or the ng-eNBs 162) may be connected to the CN 152 (e.g., 5G CN) via a first interface (e.g., an NG interface) and to other base stations via a second interface (e.g., an Xn interface). The NG and Xn interfaces may be established using direct physical connections and/or indirect connections over an underlying transport network, such as an internet protocol (IP) transport network. The base stations (e.g., the gNBs 160 and/or the ng-eNBs 162) may communicate with the wireless device(s) 156 via a third interface (e.g., a Uu interface). A base station (e.g., the gNB 160A) may communicate with the wireless device 156A via a Uu interface. The NG, Xn, and Uu interfaces may be associated with a protocol stack. The protocol stacks associated with the interfaces may be used by the network elements shown in FIG. 1B to exchange data and signaling messages. The protocol stacks may comprise two planes: a user plane and a control plane. Any other quantity of planes may be used (e.g., in a protocol stack). The user plane may handle data of interest to a user. The control plane may handle signaling messages of interest to the network elements.

One or more base stations (e.g., the gNBs 160 and/or the ng-eNBs 162) may communicate with one or more AMF/UPF devices, such as the AMF/UPF 158, via one or more interfaces (e.g., NG interfaces). A base station (e.g., the gNB 160A) may be in communication with, and/or connected to, the UPF 158B of the AMF/UPF 158 via an NG-User plane (NG-U) interface. The NG-U interface may provide/perform delivery (e.g., non-guaranteed delivery) of user plane PDUs between a base station (e.g., the gNB 160A) and a UPF device (e.g., the UPF 158B). The base station (e.g., the gNB 160A) may be in communication with, and/or connected to, an AMF device (e.g., the AMF 158A) via an NG-Control plane (NG-C) interface. The NG-C interface may provide/perform, for example, NG interface management, wireless device context management (e.g., UE context management), wireless device mobility management (e.g., UE mobility management), transport of NAS messages, paging, PDU session management, configuration transfer, and/or warning message transmission.

A wireless device may access the base station, via an interface (e.g., Uu interface), for the user plane configuration and the control plane configuration. The base stations (e.g., gNBs 160) may provide user plane and control plane protocol terminations towards the wireless device(s) 156 via the Uu interface. A base station (e.g., the gNB 160A) may provide user plane and control plane protocol terminations toward the wireless device 156A over a Uu interface associated with a first protocol stack. A base station (e.g., the ng-eNBs 162) may provide Evolved UMTS Terrestrial Radio Access (E UTRA) user plane and control plane protocol terminations towards the wireless device(s) 156 via a Uu interface (e.g., where E UTRA may refer to the 3GPP 4G radio-access technology). A base station (e.g., the ng-eNB 162B) may provide E UTRA user plane and control plane protocol terminations towards the wireless device 156B via a Uu interface associated with a second protocol stack. The user plane and control plane protocol terminations may comprise, for example, NR user plane and control plane protocol terminations, 4G user plane and control plane protocol terminations, etc.

The CN 152 (e.g., 5G-CN) may be configured to handle one or more radio accesses (e.g., NR, 4G, and/or any other radio accesses). It may also be possible for an NR network/device (or any first network/device) to connect to a 4G core network/device (or any second network/device) in a non-standalone mode (e.g., non-standalone operation). In a non-standalone mode/operation, a 4G core network may be used to provide (or at least support) control-plane functionality (e.g., initial access, mobility, and/or paging). Although only one AMF/UPF 158 is shown in FIG. 1B, one or more base stations (e.g., one or more gNBs and/or one or more ng-eNBs) may be connected to multiple AMF/UPF nodes, for example, to provide redundancy and/or to load share across the multiple AMF/UPF nodes.

An interface (e.g., Uu, Xn, and/or NG interfaces) between network elements (e.g., the network elements shown in FIG. 1B) may be associated with a protocol stack that the network elements may use to exchange data and signaling messages. A protocol stack may comprise two planes: a user plane and a control plane. Any other quantity of planes may be used (e.g., in a protocol stack). The user plane may handle data associated with a user (e.g., data of interest to a user). The control plane may handle data associated with one or more network elements (e.g., signaling messages of interest to the network elements).

The communication network 100 in FIG. 1A and/or the communication network 150 in FIG. 1B may comprise any quantity/number and/or type of devices, such as, for example, computing devices, wireless devices, mobile devices, handsets, tablets, laptops, internet of things (IoT) devices, hotspots, cellular repeaters, computing devices, and/or, more generally, user equipment (e.g., UE). Although one or more of the above types of devices may be referenced herein (e.g., UE, wireless device, computing device, etc.), it should be understood that any device herein may comprise any one or more of the above types of devices or similar devices. The communication network, and any other network referenced herein, may comprise an LTE network, a 5G network, a satellite network, and/or any other network for wireless communications (e.g., any 3GPP network and/or any non-3GPP network). Apparatuses, systems, and/or methods described herein may generally be described as implemented on one or more devices (e.g., wireless device, base station, eNB, gNB, computing device, etc.), in one or more networks, but it will be understood that one or more features and steps may be implemented on any device and/or in any network.

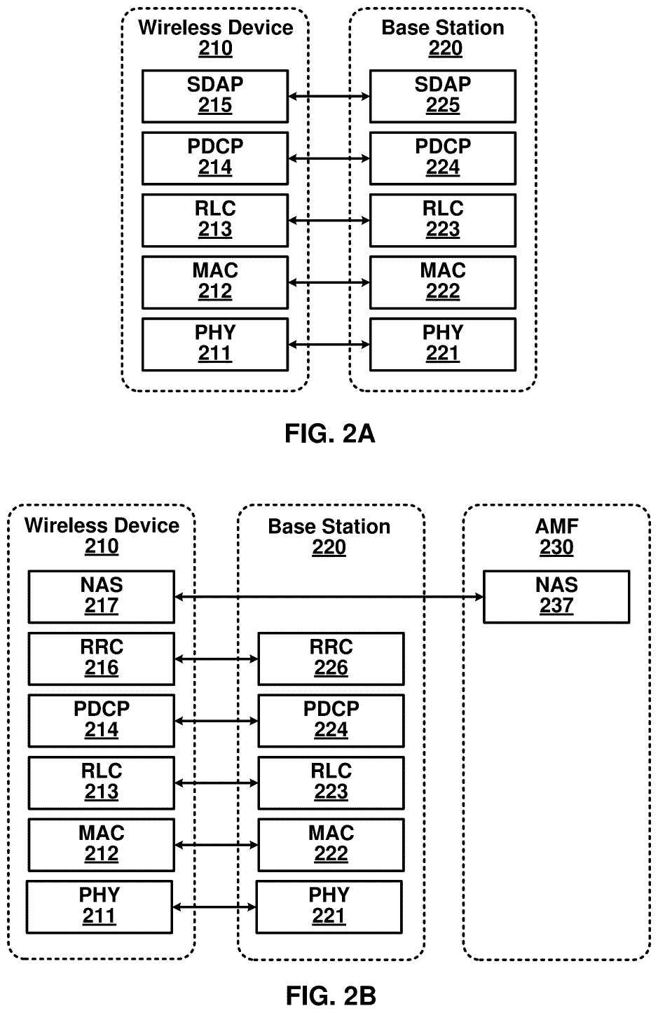

FIG. 2A shows an example user plane configuration. The user plane configuration may comprise, for example, an NR user plane protocol stack. FIG. 2B shows an example control plane configuration. The control plane configuration may comprise, for example, an NR control plane protocol stack. One or more of the user plane configuration and/or the control plane configuration may use a Uu interface that may be between a wireless device 210 and a base station 220. The protocol stacks shown in FIG. 2A and FIG. 2B may be substantially the same or similar to those used for the Uu interface between, for example, the wireless device 156A and the base station 160A shown in FIG. 1B.

A user plane configuration (e.g., an NR user plane protocol stack) may comprise multiple layers (e.g., five layers or any other quantity of layers) implemented in the wireless device 210 and the base station 220 (e.g., as shown in FIG. 2A). At the bottom of the protocol stack, physical layers (PHYs) 211 and 221 may provide transport services to the higher layers of the protocol stack and may correspond to layer 1 of the Open Systems Interconnection (OSI) model. The protocol layers above PHY 211 may comprise a medium access control layer (MAC) 212, a radio link control layer (RLC) 213, a packet data convergence protocol layer (PDCP) 214, and/or a service data application protocol layer (SDAP) 215. The protocol layers above PHY 221 may comprise a medium access control layer (MAC) 222, a radio link control layer (RLC) 223, a packet data convergence protocol layer (PDCP) 224, and/or a service data application protocol layer (SDAP) 225. One or more of the four protocol layers above PHY 211 may correspond to layer 2, or the data link layer, of the OSI model. One or more of the four protocol layers above PHY 221 may correspond to layer 2, or the data link layer, of the OSI model.

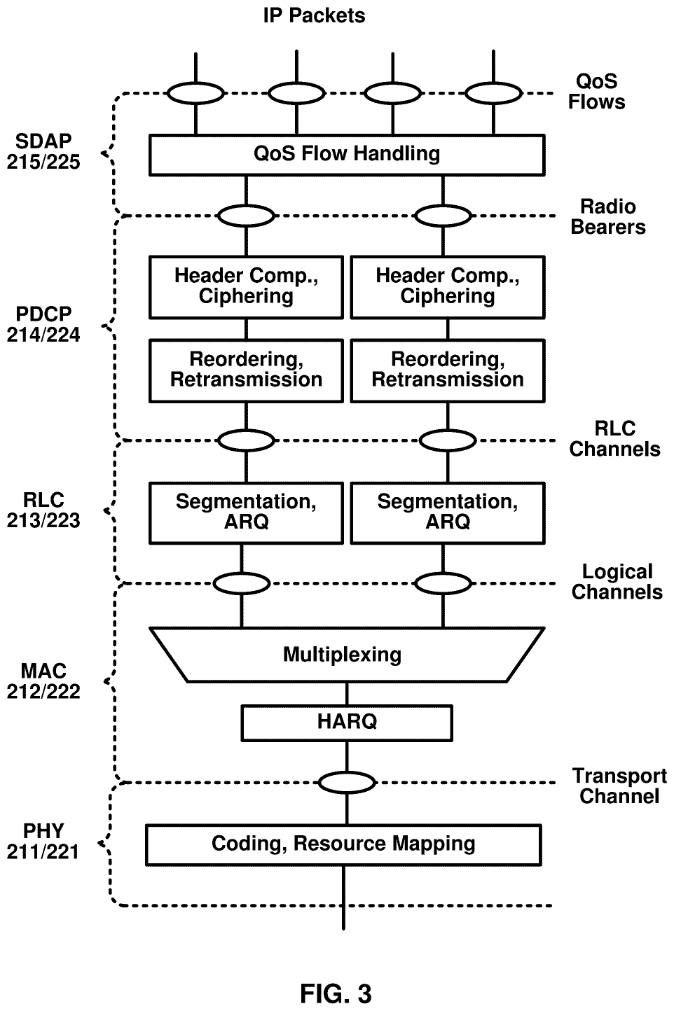

FIG. 3 shows an example of protocol layers. The protocol layers may comprise, for example, protocol layers of the NR user plane protocol stack. One or more services may be provided between protocol layers. SDAPs (e.g., SDAPS 215 and 225 shown in FIG. 2A and FIG. 3) may perform Quality of Service (QOS) flow handling. A wireless device (e.g., the wireless devices 106, 156A, 156B, and 210) may receive services through/via a PDU session, which may be a logical connection between the wireless device and a DN. The PDU session may have one or more QoS flows 310. A UPF (e.g., the UPF 158B) of a CN may map IP packets to the one or more QoS flows of the PDU session, for example, based on one or more QoS requirements (e.g., in terms of delay, data rate, error rate, and/or any other quality/service requirement). The SDAPs 215 and 225 may perform mapping/de-mapping between the one or more QoS flows 310 and one or more radio bearers 320 (e.g., data radio bearers). The mapping/de-mapping between the one or more QoS flows 310 and the radio bearers 320 may be determined by the SDAP 225 of the base station 220. The SDAP 215 of the wireless device 210 may be informed of the mapping between the QoS flows 310 and the radio bearers 320 via reflective mapping and/or control signaling received from the base station 220. For reflective mapping, the SDAP 225 of the base station 220 may mark the downlink packets with a QoS flow indicator (QFI), which may be monitored/detected/identified/indicated/observed by the SDAP 215 of the wireless device 210 to determine the mapping/de-mapping between the one or more QoS flows 310 and the radio bearers 320.

PDCPs (e.g., the PDCPs 214 and 224 shown in FIG. 2A and FIG. 3) may perform header compression/decompression, for example, to reduce the amount of data that may need to be transmitted (e.g., sent) over the air interface, ciphering/deciphering to prevent unauthorized decoding of data transmitted (e.g., sent) over the air interface, and/or integrity protection (e.g., to ensure control messages originate from intended sources). The PDCPs 214 and 224 may perform retransmissions of undelivered packets, in-sequence delivery and reordering of packets, and/or removal of packets received in duplicate due to, for example, a handover (e.g., an intra-gNB handover). The PDCPs 214 and 224 may perform packet duplication, for example, to improve the likelihood of the packet being received. A receiver may receive the packet in duplicate and may remove any duplicate packets. Packet duplication may be useful for certain services, such as services that require high reliability.

The PDCP layers (e.g., PDCPs 214 and 224) may perform mapping/de-mapping between a split radio bearer and RLC channels (e.g., RLC channels 330) (e.g., in a dual connectivity scenario/configuration). Dual connectivity may refer to a technique that allows a wireless device to communicate with multiple cells (e.g., two cells) or, more generally, multiple cell groups comprising: a master cell group (MCG) and a secondary cell group (SCG). A split bearer may be configured and/or used, for example, if a single radio bearer (e.g., such as one of the radio bearers provided/configured by the PDCPs 214 and 224 as a service to the SDAPs 215 and 225) is handled by cell groups in dual connectivity. The PDCPs 214 and 224 may map/de-map between the split radio bearer and RLC channels 330 belonging to the cell groups.

RLC layers (e.g., RLCs 213 and 223) may perform segmentation, retransmission via Automatic Repeat Request (ARQ), and/or removal of duplicate data units received from MAC layers (e.g., MACs 212 and 222, respectively). The RLC layers (e.g., RLCs 213 and 223) may support multiple transmission modes (e.g., three transmission modes: transparent mode (TM); unacknowledged mode (UM); and acknowledged mode (AM)). The RLC layers may perform one or more of the noted functions, for example, based on the transmission mode an RLC layer is operating. The RLC configuration may be per logical channel. The RLC configuration may not depend on numerologies and/or Transmission Time Interval (TTI) durations (or other durations). The RLC layers (e.g., RLCs 213 and 223) may provide/configure RLC channels as a service to the PDCP layers (e.g., PDCPs 214 and 224, respectively), such as shown in FIG. 3.

The MAC layers (e.g., MACs 212 and 222) may perform multiplexing/demultiplexing of logical channels and/or mapping between logical channels and transport channels. The multiplexing/demultiplexing may comprise multiplexing/demultiplexing of data units/data portions, belonging to the one or more logical channels, into/from Transport Blocks (TBs) delivered to/from the PHY layers (e.g., PHYs 211 and 221, respectively). The MAC layer of a base station (e.g., MAC 222) may be configured to perform scheduling, scheduling information reporting, and/or priority handling between wireless devices via dynamic scheduling. Scheduling may be performed by a base station (e.g., the base station 220 at the MAC 222) for downlink/or and uplink. The MAC layers (e.g., MACs 212 and 222) may be configured to perform error correction(s) via Hybrid Automatic Repeat Request (HARQ) (e.g., one HARQ entity per carrier in case of Carrier Aggregation (CA)), priority handling between logical channels of the wireless device 210 via logical channel prioritization and/or padding. The MAC layers (e.g., MACs 212 and 222) may support one or more numerologies and/or transmission timings. Mapping restrictions in a logical channel prioritization may control which numerology and/or transmission timing a logical channel may use. The MAC layers (e.g., the MACs 212 and 222) may provide/configure logical channels 340 as a service to the RLC layers (e.g., the RLCs 213 and 223).

The PHY layers (e.g., PHYs 211 and 221) may perform mapping of transport channels to physical channels and/or digital and analog signal processing functions, for example, for sending and/or receiving information (e.g., via an over the air interface). The digital and/or analog signal processing functions may comprise, for example, coding/decoding and/or modulation/demodulation. The PHY layers (e.g., PHYs 211 and 221) may perform multi-antenna mapping. The PHY layers (e.g., the PHYs 211 and 221) may provide/configure one or more transport channels (e.g., transport channels 350) as a service to the MAC layers (e.g., the MACs 212 and 222, respectively).

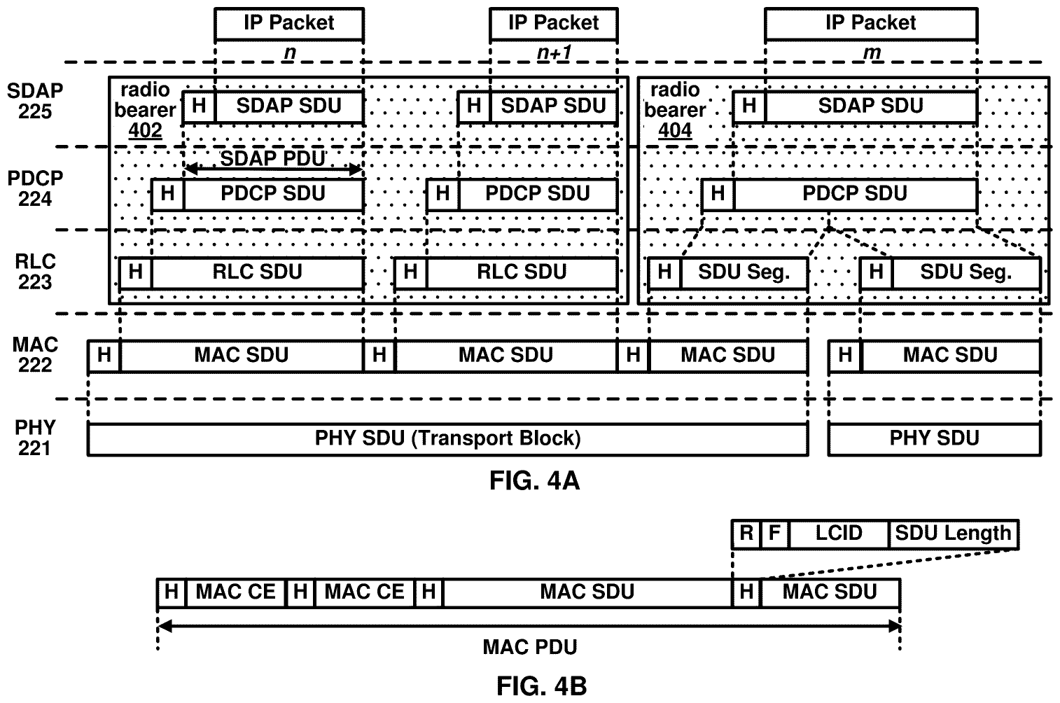

FIG. 4A shows an example downlink data flow for a user plane configuration. The user plane configuration may comprise, for example, the NR user plane protocol stack shown in FIG. 2A. One or more TBs may be generated, for example, based on a data flow via a user plane protocol stack. As shown in FIG. 4A, a downlink data flow of three IP packets (n, n+1, and m) via the NR user plane protocol stack may generate two TBs (e.g., at the base station 220). An uplink data flow via the NR user plane protocol stack may be similar to the downlink data flow shown in FIG. 4A. The three IP packets (n, n+1, and m) may be determined from the two TBs, for example, based on the uplink data flow via an NR user plane protocol stack. A first quantity of packets (e.g., three or any other quantity) may be determined from a second quantity of TBs (e.g., two or another quantity).

The downlink data flow may begin, for example, if the SDAP 225 receives the three IP packets (or other quantity of IP packets) from one or more QoS flows and maps the three packets (or other quantity of packets) to radio bearers (e.g., radio bearers 402 and 404). The SDAP 225 may map the IP packets n and n+1 to a first radio bearer 402 and map the IP packet m to a second radio bearer 404. An SDAP header (labeled with “H” preceding each SDAP SDU shown in FIG. 4A) may be added to an IP packet to generate an SDAP PDU, which may be referred to as a PDCP SDU. The data unit transferred from/to a higher protocol layer may be referred to as a service data unit (SDU) of the lower protocol layer, and the data unit transferred to/from a lower protocol layer may be referred to as a protocol data unit (PDU) of the higher protocol layer. As shown in FIG. 4A, the data unit from the SDAP 225 may be an SDU of lower protocol layer PDCP 224 (e.g., PDCP SDU) and may be a PDU of the SDAP 225 (e.g., SDAP PDU).

Each protocol layer (e.g., protocol layers shown in FIG. 4A) or at least some protocol layers may: perform its own function(s) (e.g., one or more functions of each protocol layer described with respect to FIG. 3), add a corresponding header, and/or forward a respective output to the next lower layer (e.g., its respective lower layer). The PDCP 224 may perform an IP-header compression and/or ciphering. The PDCP 224 may forward its output (e.g., a PDCP PDU, which is an RLC SDU) to the RLC 223. The RLC 223 may optionally perform segmentation (e.g., as shown for IP packet m in FIG. 4A). The RLC 223 may forward its outputs (e.g., two RLC PDUs, which are two MAC SDUs, generated by adding respective subheaders to two SDU segments (SDU Segs)) to the MAC 222. The MAC 222 may multiplex a quantity/number of RLC PDUs (MAC SDUs). The MAC 222 may attach a MAC subheader to an RLC PDU (MAC SDU) to form a TB. The MAC subheaders may be distributed across the MAC PDU (e.g., in an NR configuration as shown in FIG. 4A). The MAC subheaders may be entirely located at the beginning of a MAC PDU (e.g., in an LTE configuration). The NR MAC PDU structure may reduce a processing time and/or associated latency, for example, if the MAC PDU subheaders are computed before assembling the full MAC PDU.

FIG. 4B shows an example format of a MAC subheader in a MAC PDU. A MAC PDU may comprise a MAC subheader (H) and a MAC SDU. Each of one or more MAC subheaders may comprise an SDU length field for indicating the length (e.g., in bytes) of the MAC SDU to which the MAC subheader corresponds; a logical channel identifier (LCID) field for identifying/indicating the logical channel from which the MAC SDU originated to aid in the demultiplexing process; a flag (F) for indicating the size of the SDU length field; and a reserved bit (R) field for future use.

One or more MAC control elements (CEs) may be added to, or inserted into, the MAC PDU by a MAC layer, such as MAC 223 or MAC 222. As shown in FIG. 4B, two MAC CEs may be inserted/added before two MAC PDUs. The MAC CEs may be inserted/added at the beginning of a MAC PDU for downlink transmissions (as shown in FIG. 4B). One or more MAC CEs may be inserted/added at the end of a MAC PDU for uplink transmissions. MAC CEs may be used for in band control signaling. Example MAC CEs may comprise scheduling-related MAC CEs, such as buffer status reports and power headroom reports; activation/deactivation MAC CEs (e.g., MAC CEs for activation/deactivation of PDCP duplication detection, channel state information (CSI) reporting, sounding reference signal (SRS) transmission, and prior configured components); discontinuous reception (DRX)-related MAC CEs; timing advance MAC CEs; and random access-related MAC CEs. A MAC CE may be preceded by a MAC subheader with a similar format as described for the MAC subheader for MAC SDUs and may be identified with a reserved value in the LCID field that indicates the type of control information included in the corresponding MAC CE.

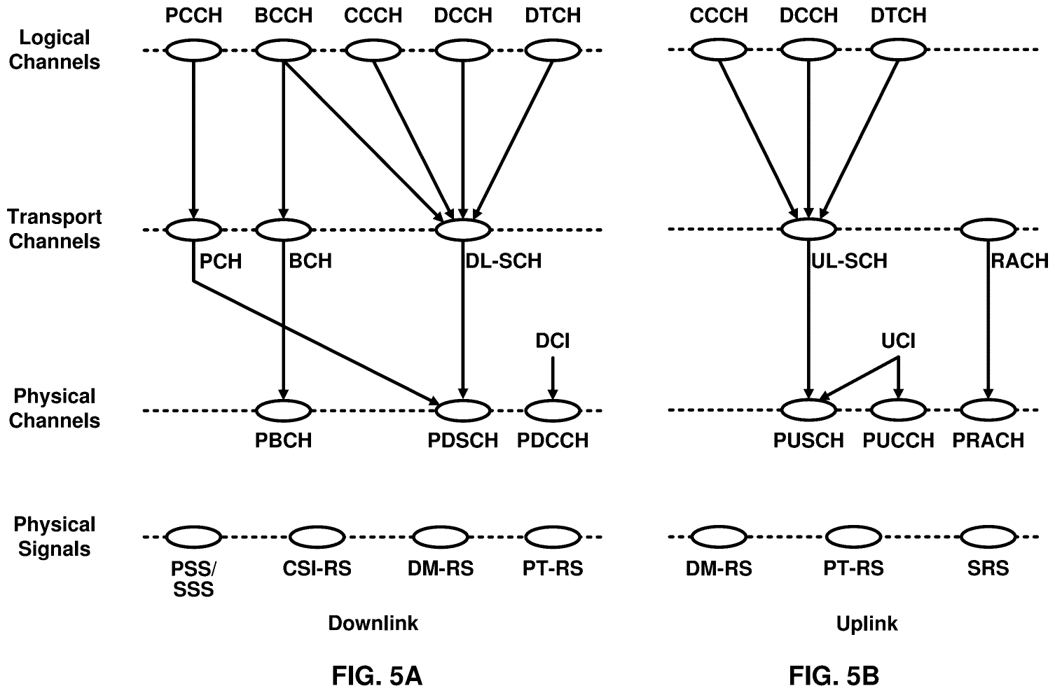

FIG. 5A shows an example mapping for downlink channels. The mapping for uplink channels may comprise mapping between channels (e.g., logical channels, transport channels, and physical channels) for downlink. FIG. 5B shows an example mapping for uplink channels. The mapping for uplink channels may comprise mapping between channels (e.g., logical channels, transport channels, and physical channels) for uplink. Information may be passed through/via channels between the RLC, the MAC, and the PHY layers of a protocol stack (e.g., the NR protocol stack). A logical channel may be used between the RLC and the MAC layers. The logical channel may be classified/indicated as a control channel that may carry control and/or configuration information (e.g., in the NR control plane), or as a traffic channel that may carry data (e.g., in the NR user plane). A logical channel may be classified/indicated as a dedicated logical channel that may be dedicated to a specific wireless device, and/or as a common logical channel that may be used by more than one wireless device (e.g., a group of wireless device).

A logical channel may be defined by the type of information it carries. The set of logical channels (e.g., in an NR configuration) may comprise one or more channels described below. A paging control channel (PCCH) may comprise/carry one or more paging messages used to page a wireless device whose location is not known to the network on a cell level. A broadcast control channel (BCCH) may comprise/carry system information messages in the form of a master information block (MIB) and several system information blocks (SIBs). The system information messages may be used by wireless devices to obtain information about how a cell is configured and how to operate within the cell. A common control channel (CCCH) may comprise/carry control messages together with random access. A dedicated control channel (DCCH) may comprise/carry control messages to/from a specific wireless device to configure the wireless device with configuration information. A dedicated traffic channel (DTCH) may comprise/carry user data to/from a specific wireless device.

Transport channels may be used between the MAC and PHY layers. Transport channels may be defined by how the information they carry is sent/transmitted (e.g., via an over the air interface). The set of transport channels (e.g., that may be defined by an NR configuration or any other configuration) may comprise one or more of the following channels. A paging channel (PCH) may comprise/carry paging messages that originated from the PCCH. A broadcast channel (BCH) may comprise/carry the MIB from the BCCH. A downlink shared channel (DL-SCH) may comprise/carry downlink data and signaling messages, including the SIBs from the BCCH. An uplink shared channel (UL-SCH) may comprise/carry uplink data and signaling messages. A random access channel (RACH) may provide a wireless device with an access to the network without any prior scheduling.

The PHY layer may use physical channels to pass/transfer information between processing levels of the PHY layer. A physical channel may have an associated set of time-frequency resources for carrying the information of one or more transport channels. The PHY layer may generate control information to support the low-level operation of the PHY layer. The PHY layer may provide/transfer the control information to the lower levels of the PHY layer via physical control channels (e.g., referred to as L1/L2 control channels). The set of physical channels and physical control channels (e.g., that may be defined by an NR configuration or any other configuration) may comprise one or more of the following channels. A physical broadcast channel (PBCH) may comprise/carry the MIB from the BCH. A physical downlink shared channel (PDSCH) may comprise/carry downlink data and signaling messages from the DL-SCH, as well as paging messages from the PCH. A physical downlink control channel (PDCCH) may comprise/carry downlink control information (DCI), which may comprise downlink scheduling commands, uplink scheduling grants, and uplink power control commands. A physical uplink shared channel (PUSCH) may comprise/carry uplink data and signaling messages from the UL-SCH and in some instances uplink control information (UCI) as described below. A physical uplink control channel (PUCCH) may comprise/carry UCI, which may comprise HARQ acknowledgments, channel quality indicators (CQI), pre-coding matrix indicators (PMI), rank indicators (RI), and scheduling requests (SR). A physical random access channel (PRACH) may be used for random access.

The physical layer may generate physical signals to support the low-level operation of the physical layer, which may be similar to the physical control channels. As shown in FIG. 5A and FIG. 5B, the physical layer signals (e.g., that may be defined by an NR configuration or any other configuration) may comprise primary synchronization signals (PSS), secondary synchronization signals (SSS), channel state information reference signals (CSI-RS), demodulation reference signals (DM-RS), sounding reference signals (SRS), phase-tracking reference signals (PT-RS), and/or any other signals.

One or more of the channels (e.g., logical channels, transport channels, physical channels, etc.) may be used to carry out functions associated with the control plan protocol stack (e.g., NR control plane protocol stack). FIG. 2B shows an example control plane configuration (e.g., an NR control plane protocol stack). As shown in FIG. 2B, the control plane configuration (e.g., the NR control plane protocol stack) may use substantially the same/similar one or more protocol layers (e.g., PHY 211 and 221, MAC 212 and 222, RLC 213 and 223, and PDCP 214 and 224) as the example user plane configuration (e.g., the NR user plane protocol stack). Similar four protocol layers may comprise the PHYs 211 and 221, the MACs 212 and 222, the RLCs 213 and 223, and the PDCPs 214 and 224. The control plane configuration (e.g., the NR control plane stack) may have radio resource controls (RRCs) 216 and 226 and NAS protocols 217 and 237 at the top of the control plane configuration (e.g., the NR control plane protocol stack), for example, instead of having the SDAPs 215 and 225. The control plane configuration may comprise an AMF 230 comprising the NAS protocol 237.

The NAS protocols 217 and 237 may provide control plane functionality between the wireless device 210 and the AMF 230 (e.g., the AMF 158A or any other AMF) and/or, more generally, between the wireless device 210 and a CN (e.g., the CN 152 or any other CN). The NAS protocols 217 and 237 may provide control plane functionality between the wireless device 210 and the AMF 230 via signaling messages, referred to as NAS messages. There may be no direct path between the wireless device 210 and the AMF 230 via which the NAS messages may be transported. The NAS messages may be transported using the AS of the Uu and NG interfaces. The NAS protocols 217 and 237 may provide control plane functionality, such as authentication, security, a connection setup, mobility management, session management, and/or any other functionality.

The RRCs 216 and 226 may provide/configure control plane functionality between the wireless device 210 and the base station 220 and/or, more generally, between the wireless device 210 and the RAN (e.g., the base station 220). The RRC layers 216 and 226 may provide/configure control plane functionality between the wireless device 210 and the base station 220 via signaling messages, which may be referred to as RRC messages. The RRC messages may be sent/transmitted between the wireless device 210 and the RAN (e.g., the base station 220) using signaling radio bearers and the same/similar PDCP, RLC, MAC, and PHY protocol layers. The MAC layer may multiplex control-plane and user-plane data into the same TB. The RRC layers 216 and 226 may provide/configure control plane functionality, such as one or more of the following functionalities: broadcast of system information related to AS and NAS; paging initiated by the CN or the RAN; establishment, maintenance and release of an RRC connection between the wireless device 210 and the RAN (e.g., the base station 220); security functions including key management; establishment, configuration, maintenance and release of signaling radio bearers and data radio bearers; mobility functions; QoS management functions; wireless device measurement reporting (e.g., the wireless device measurement reporting) and control of the reporting; detection of and recovery from radio link failure (RLF); and/or NAS message transfer. As part of establishing an RRC connection, RRC layers 216 and 226 may establish an RRC context, which may involve configuring parameters for communication between the wireless device 210 and the RAN (e.g., the base station 220).

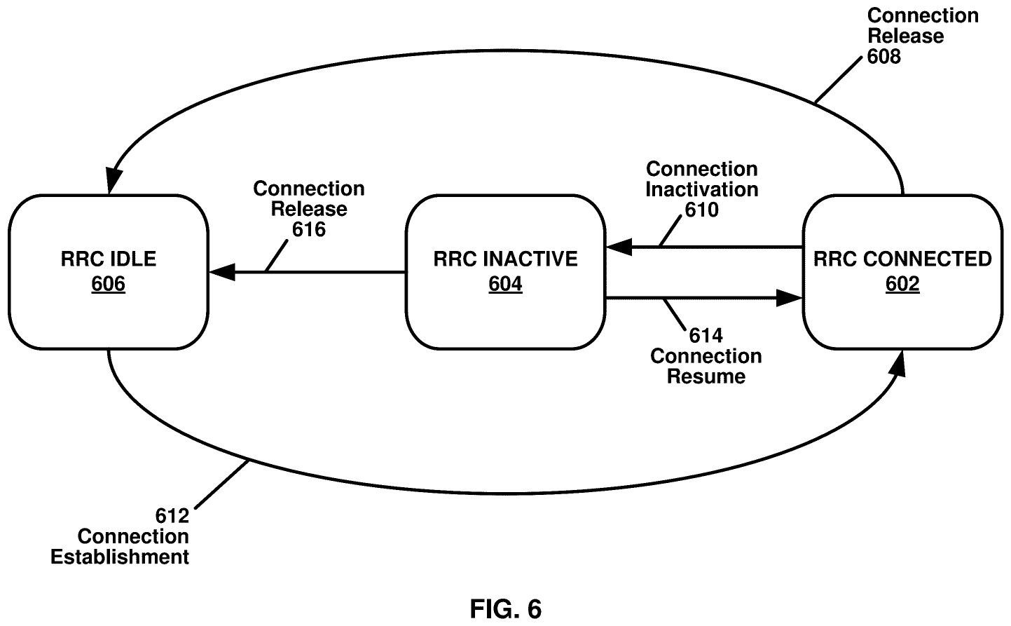

FIG. 6 shows example RRC states and RRC state transitions. An RRC state of a wireless device may be changed to another RRC state (e.g., RRC state transitions of a wireless device). The wireless device may be substantially the same or similar to the wireless device 106, 210, or any other wireless device. A wireless device may be in at least one of a plurality of states, such as three RRC states comprising RRC connected 602 (e.g., RRC_CONNECTED), RRC idle 606 (e.g., RRC_IDLE), and RRC inactive 604 (e.g., RRC_INACTIVE). The RRC inactive 604 may be RRC connected but inactive.

An RRC connection may be established for the wireless device. For example, this may be during an RRC connected state. During the RRC connected state (e.g., during the RRC connected 602), the wireless device may have an established RRC context and may have at least one RRC connection with a base station. The base station may be similar to one of the one or more base stations (e.g., one or more base stations of the RAN 104 shown in FIG. 1A, one of the gNBs 160 or ng-eNBs 162 shown in FIG. 1B, the base station 220 shown in FIG. 2A and FIG. 2B, or any other base stations). The base station with which the wireless device is connected (e.g., has established an RRC connection) may have the RRC context for the wireless device. The RRC context, which may be referred to as a wireless device context (e.g., the UE context), may comprise parameters for communication between the wireless device and the base station. These parameters may comprise, for example, one or more of: AS contexts; radio link configuration parameters; bearer configuration information (e.g., relating to a data radio bearer, a signaling radio bearer, a logical channel, a QoS flow, and/or a PDU session); security information; and/or layer configuration information (e.g., PHY, MAC, RLC, PDCP, and/or SDAP layer configuration information). During the RRC connected state (e.g., the RRC connected 602), mobility of the wireless device may be managed/controlled by an RAN (e.g., the RAN 104 or the NG RAN 154). The wireless device may measure received signal levels (e.g., reference signal levels, reference signal received power, reference signal received quality, received signal strength indicator, etc.) based on one or more signals sent from a serving cell and neighboring cells. The wireless device may report these measurements to a serving base station (e.g., the base station currently serving the wireless device). The serving base station of the wireless device may request a handover to a cell of one of the neighboring base stations, for example, based on the reported measurements. The RRC state may transition from the RRC connected state (e.g., RRC connected 602) to an RRC idle state (e.g., the RRC idle 606) via a connection release procedure 608. The RRC state may transition from the RRC connected state (e.g., RRC connected 602) to the RRC inactive state (e.g., RRC inactive 604) via a connection inactivation procedure 610.

An RRC context may not be established for the wireless device. For example, this may be during the RRC idle state. During the RRC idle state (e.g., the RRC idle 606), an RRC context may not be established for the wireless device. During the RRC idle state (e.g., the RRC idle 606), the wireless device may not have an RRC connection with the base station. During the RRC idle state (e.g., the RRC idle 606), the wireless device may be in a sleep state for the majority of the time (e.g., to conserve battery power). The wireless device may wake up periodically (e.g., once in every discontinuous reception (DRX) cycle) to monitor for paging messages (e.g., paging messages set from the RAN). Mobility of the wireless device may be managed by the wireless device via a procedure of a cell reselection. The RRC state may transition from the RRC idle state (e.g., the RRC idle 606) to the RRC connected state (e.g., the RRC connected 602) via a connection establishment procedure 612, which may involve a random access procedure.

A previously established RRC context may be maintained for the wireless device. For example, this may be during the RRC inactive state. During the RRC inactive state (e.g., the RRC inactive 604), the RRC context previously established may be maintained in the wireless device and the base station. The maintenance of the RRC context may enable/allow a fast transition to the RRC connected state (e.g., the RRC connected 602) with reduced signaling overhead as compared to the transition from the RRC idle state (e.g., the RRC idle 606) to the RRC connected state (e.g., the RRC connected 602). During the RRC inactive state (e.g., the RRC inactive 604), the wireless device may be in a sleep state and mobility of the wireless device may be managed/controlled by the wireless device via a cell reselection. The RRC state may transition from the RRC inactive state (e.g., the RRC inactive 604) to the RRC connected state (e.g., the RRC connected 602) via a connection resume procedure 614. The RRC state may transition from the RRC inactive state (e.g., the RRC inactive 604) to the RRC idle state (e.g., the RRC idle 606) via a connection release procedure 616 that may be the same as or similar to connection release procedure 608.

An RRC state may be associated with a mobility management mechanism. During the RRC idle state (e.g., RRC idle 606) and the RRC inactive state (e.g., the RRC inactive 604), mobility may be managed/controlled by the wireless device via a cell reselection. The purpose of mobility management during the RRC idle state (e.g., the RRC idle 606) or during the RRC inactive state (e.g., the RRC inactive 604) may be to enable/allow the network to be able to notify the wireless device of an event via a paging message without having to broadcast the paging message over the entire mobile communications network. The mobility management mechanism used during the RRC idle state (e.g., the RRC idle 606) or during the RRC idle state (e.g., the RRC inactive 604) may enable/allow the network to track the wireless device on a cell-group level, for example, so that the paging message may be broadcast over the cells of the cell group that the wireless device currently resides within (e.g. instead of sending the paging message over the entire mobile communication network). The mobility management mechanisms for the RRC idle state (e.g., the RRC idle 606) and the RRC inactive state (e.g., the RRC inactive 604) may track the wireless device on a cell-group level. The mobility management mechanisms may do the tracking, for example, using different granularities of grouping. There may be a plurality of levels of cell-grouping granularity (e.g., three levels of cell-grouping granularity: individual cells; cells within a RAN area identified by a RAN area identifier (RAI); and cells within a group of RAN areas, referred to as a tracking area and identified by a tracking area identifier (TAI)).

Tracking areas may be used to track the wireless device (e.g., tracking the location of the wireless device at the CN level). The CN (e.g., the CN 102, the 5G CN 152, or any other CN) may send to the wireless device a list of TAIs associated with a wireless device registration area (e.g., a UE registration area). A wireless device may perform a registration update with the CN to allow the CN to update the location of the wireless device and provide the wireless device with a new the UE registration area, for example, if the wireless device moves (e.g., via a cell reselection) to a cell associated with a TAI that may not be included in the list of TAIs associated with the UE registration area.

RAN areas may be used to track the wireless device (e.g., the location of the wireless device at the RAN level). For a wireless device in an RRC inactive state (e.g., the RRC inactive 604), the wireless device may be assigned/provided/configured with a RAN notification area. A RAN notification area may comprise one or more cell identities (e.g., a list of RAIs and/or a list of TAIs). A base station may belong to one or more RAN notification areas. A cell may belong to one or more RAN notification areas. A wireless device may perform a notification area update with the RAN to update the RAN notification area of the wireless device, for example, if the wireless device moves (e.g., via a cell reselection) to a cell not included in the RAN notification area assigned/provided/configured to the wireless device.

A base station storing an RRC context for a wireless device or a last serving base station of the wireless device may be referred to as an anchor base station. An anchor base station may maintain an RRC context for the wireless device at least during a period of time that the wireless device stays in a RAN notification area of the anchor base station and/or during a period of time that the wireless device stays in an RRC inactive state (e.g., RRC inactive 604).

A base station (e.g., gNBs 160 in FIG. 1B or any other base station) may be split into two parts: a central unit (e.g., a base station central unit, such as a gNB CU) and one or more distributed units (e.g., a base station distributed unit, such as a gNB DU). A base station central unit (CU) may be coupled to one or more base station distributed units (DUs) using an F1 interface (e.g., an F1 interface defined in an NR configuration). The base station CU may comprise the RRC, the PDCP, and the SDAP layers. A base station distributed unit (DU) may comprise the RLC, the MAC, and the PHY layers.

The physical signals and physical channels (e.g., described with respect to FIG. 5A and FIG. 5B) may be mapped onto one or more symbols (e.g., orthogonal frequency divisional multiplexing (OFDM) symbols in an NR configuration or any other symbols). OFDM is a multicarrier communication scheme that sends/transmits data over F orthogonal subcarriers (or tones). The data may be mapped to a series of complex symbols (e.g., M-quadrature amplitude modulation (M-QAM) symbols or M-phase shift keying (M PSK) symbols or any other modulated symbols), referred to as source symbols, and divided into F parallel symbol streams, for example, before transmission of the data. The F parallel symbol streams may be treated as if they are in the frequency domain. The F parallel symbols may be used as inputs to an Inverse Fast Fourier Transform (IFFT) block that transforms them into the time domain. The IFFT block may take in F source symbols at a time, one from each of the F parallel symbol streams. The IFFT block may use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. An OFDM symbol provided/output by the IFFT block may be sent/transmitted over the air interface on a carrier frequency, for example, after one or more processes (e.g., addition of a cyclic prefix) and up-conversion. The F parallel symbol streams may be mixed, for example, using a Fast Fourier Transform (FFT) block before being processed by the IFFT block. This operation may produce Discrete Fourier Transform (DFT)-precoded OFDM symbols and may be used by one or more wireless devices in the uplink to reduce the peak to average power ratio (PAPR). Inverse processing may be performed on the OFDM symbol at a receiver using an FFT block to recover the data mapped to the source symbols.

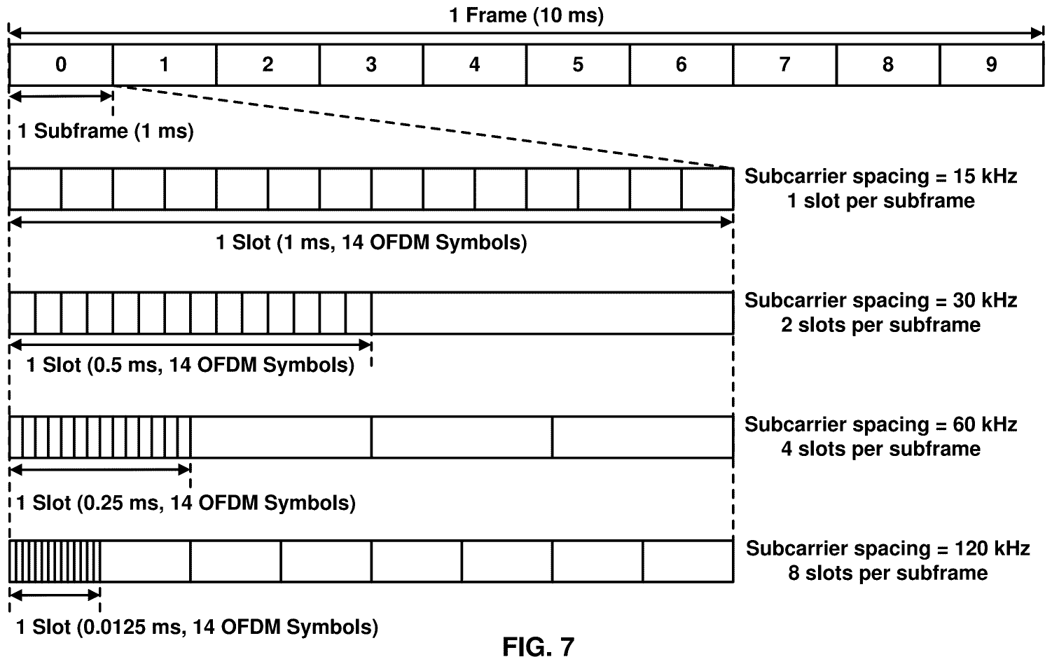

FIG. 7 shows an example configuration of a frame. The frame may comprise, for example, an NR radio frame into which OFDM symbols may be grouped. A frame (e.g., an NR radio frame) may be identified/indicated by a system frame quantity/number (SFN) or any other value. The SFN may repeat with a period of 1024 frames. One NR frame may be 10 milliseconds (ms) in duration and may comprise 10 subframes that are 1 ms in duration. A subframe may be divided into one or more slots (e.g., depending on numerologies and/or different subcarrier spacings). Each of the one or more slots may comprise, for example, 14 OFDM symbols per slot. Any quantity of symbols, slots, or duration may be used for any time interval.

The duration of a slot may depend on the numerology used for the OFDM symbols of the slot. A flexible numerology may be supported, for example, to accommodate different deployments (e.g., cells with carrier frequencies below 1 GHz up to cells with carrier frequencies in the mm-wave range). A flexible numerology may be supported, for example, in an NR configuration or any other radio configurations. A numerology may be defined in terms of subcarrier spacing and/or cyclic prefix duration. Subcarrier spacings may be scaled up by powers of two from a baseline subcarrier spacing of 15 kHz. Cyclic prefix durations may be scaled down by powers of two from a baseline cyclic prefix duration of 4.7 μs, for example, for a numerology in an NR configuration or any other radio configurations. Numerologies may be defined with the following subcarrier spacing/cyclic prefix duration combinations: 15 kHz/4.7 μs; 30 kHz/2.3 μs; 60 KHz/1.2 μs; 120 kHz/0.59 μs; 240 kHz/0.29 μs, and/or any other subcarrier spacing/cyclic prefix duration combinations.

A slot may have a fixed quantity/number of OFDM symbols (e.g., 14 OFDM symbols). A numerology with a higher subcarrier spacing may have a shorter slot duration and more slots per subframe. Examples of numerology-dependent slot duration and slots-per-subframe transmission structure are shown in FIG. 7 (the numerology with a subcarrier spacing of 240 kHz is not shown in FIG. 7). A subframe (e.g., in an NR configuration) may be used as a numerology-independent time reference. A slot may be used as the unit upon which uplink and downlink transmissions are scheduled. Scheduling (e.g., in an NR configuration) may be decoupled from the slot duration. Scheduling may start at any OFDM symbol. Scheduling may last for as many symbols as needed for a transmission, for example, to support low latency. These partial slot transmissions may be referred to as mini-slot or sub-slot transmissions.

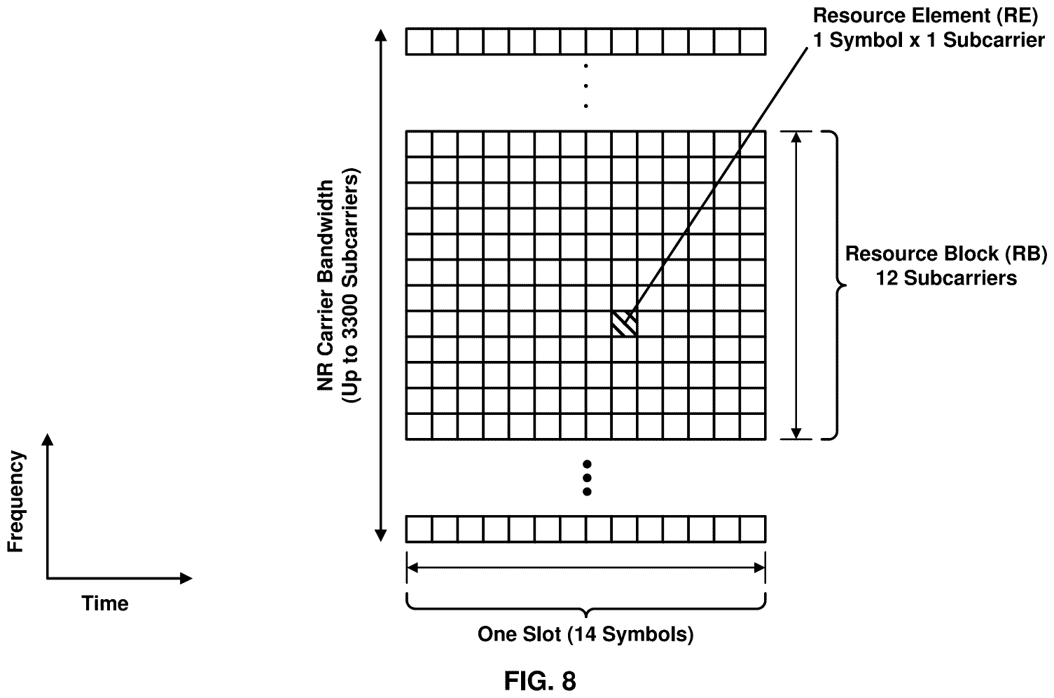

FIG. 8 shows an example resource configuration of one or more carriers. The resource configuration of may comprise a slot in the time and frequency domain for an NR carrier or any other carrier. The slot may comprise resource elements (REs) and resource blocks (RBs). A resource element (RE) may be the smallest physical resource (e.g., in an NR configuration). An RE may span one OFDM symbol in the time domain by one subcarrier in the frequency domain, such as shown in FIG. 8. An RB may span twelve consecutive REs in the frequency domain, such as shown in FIG. 8. A carrier (e.g., an NR carrier) may be limited to a width of a certain quantity of RBs and/or subcarriers (e.g., 275 RBs or 275×12=3300 subcarriers). Such limitation(s), if used, may limit the carrier (e.g., NR carrier) frequency based on subcarrier spacing (e.g., carrier frequency of 50, 100, 200, and 400 MHz for subcarrier spacings of 15, 30, 60, and 120 kHz, respectively). A 400 MHz bandwidth may be set based on a 400 MHz per carrier bandwidth limit. Any other bandwidth may be set based on a per carrier bandwidth limit.

A single numerology may be used across the entire bandwidth of a carrier (e.g., an NR such as shown in FIG. 8). In other example configurations, multiple numerologies may be supported on the same carrier. NR and/or other access technologies may support wide carrier bandwidths (e.g., up to 400 MHz for a subcarrier spacing of 120 kHz). Not all wireless devices may be able to receive the full carrier bandwidth (e.g., due to hardware limitations and/or different wireless device capabilities). Receiving and/or utilizing the full carrier bandwidth may be prohibitive, for example, in terms of wireless device power consumption. A wireless device may adapt the size of the receive bandwidth of the wireless device, for example, based on the amount of traffic the wireless device is scheduled to receive (e.g., to reduce power consumption and/or for other purposes). Such an adaptation may be referred to as bandwidth adaptation.

Configuration of one or more bandwidth parts (BWPs) may support one or more wireless devices not capable of receiving the full carrier bandwidth. BWPs may support bandwidth adaptation, for example, for such wireless devices not capable of receiving the full carrier bandwidth. A BWP (e.g., a BWP of an NR configuration) may be defined by a subset of contiguous RBs on a carrier. A wireless device may be configured (e.g., via an RRC layer) with one or more downlink BWPs per serving cell and one or more uplink BWPs per serving cell (e.g., up to four downlink BWPs per serving cell and up to four uplink BWPs per serving cell). One or more of the configured BWPs for a serving cell may be active, for example, at a given time. The one or more BWPs may be referred to as active BWPs of the serving cell. A serving cell may have one or more first active BWPs in the uplink carrier and one or more second active BWPs in the secondary uplink carrier, for example, if the serving cell is configured with a secondary uplink carrier.

A downlink BWP from a set of configured downlink BWPs may be linked with an uplink BWP from a set of configured uplink BWPs (e.g., for unpaired spectra). A downlink BWP and an uplink BWP may be linked, for example, if a downlink BWP index of the downlink BWP and an uplink BWP index of the uplink BWP are the same. A wireless device may expect that the center frequency for a downlink BWP is the same as the center frequency for an uplink BWP (e.g., for unpaired spectra).

A base station may configure a wireless device with one or more control resource sets (CORESETs) for at least one search space. The base station may configure the wireless device with one or more CORESETS, for example, for a downlink BWP in a set of configured downlink BWPs on a primary cell (PCell) or on a secondary cell (SCell). A search space may comprise a set of locations in the time and frequency domains where the wireless device may monitor/find/detect/identify control information. The search space may be a wireless device-specific search space (e.g., a UE-specific search space) or a common search space (e.g., potentially usable by a plurality of wireless devices or a group of wireless user devices). A base station may configure a group of wireless devices with a common search space, on a PCell or on a primary secondary cell (PSCell), in an active downlink BWP.

A base station may configure a wireless device with one or more resource sets for one or more PUCCH transmissions, for example, for an uplink BWP in a set of configured uplink BWPs. A wireless device may receive downlink receptions (e.g., PDCCH or PDSCH) in a downlink BWP, for example, according to a configured numerology (e.g., a configured subcarrier spacing and/or a configured cyclic prefix duration) for the downlink BWP. The wireless device may send/transmit uplink transmissions (e.g., PUCCH or PUSCH) in an uplink BWP, for example, according to a configured numerology (e.g., a configured subcarrier spacing and/or a configured cyclic prefix length for the uplink BWP).

One or more BWP indicator fields may be provided/comprised in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a wireless device with a default downlink BWP within a set of configured downlink BWPs associated with a PCell. A default downlink BWP may be an initial active downlink BWP, for example, if the base station does not provide/configure a default downlink BWP to/for the wireless device. The wireless device may determine which BWP is the initial active downlink BWP, for example, based on a CORESET configuration obtained using the PBCH.

A base station may configure a wireless device with a BWP inactivity timer value for a PCell. The wireless device may start or restart a BWP inactivity timer at any appropriate time. The wireless device may start or restart the BWP inactivity timer, for example, if one or more conditions are satisfied. The one or more conditions may comprise at least one of: the wireless device detects DCI indicating an active downlink BWP other than a default downlink BWP for a paired spectra operation; the wireless device detects DCI indicating an active downlink BWP other than a default downlink BWP for an unpaired spectra operation; and/or the wireless device detects DCI indicating an active uplink BWP other than a default uplink BWP for an unpaired spectra operation. The wireless device may start/run the BWP inactivity timer toward expiration (e.g., increment from zero to the BWP inactivity timer value, or decrement from the BWP inactivity timer value to zero), for example, if the wireless device does not detect DCI during a time interval (e.g., 1 ms or 0.5 ms). The wireless device may switch from the active downlink BWP to the default downlink BWP, for example, if the BWP inactivity timer expires.

A base station may semi-statically configure a wireless device with one or more BWPs. A wireless device may switch an active BWP from a first BWP to a second BWP, for example, based on (e.g., after or in response to) receiving DCI indicating the second BWP as an active BWP. A wireless device may switch an active BWP from a first BWP to a second BWP, for example, based on (e.g., after or in response to) an expiry of the BWP inactivity timer (e.g., if the second BWP is the default BWP).

A downlink BWP switching may refer to switching an active downlink BWP from a first downlink BWP to a second downlink BWP (e.g., the second downlink BWP is activated and the first downlink BWP is deactivated). An uplink BWP switching may refer to switching an active uplink BWP from a first uplink BWP to a second uplink BWP (e.g., the second uplink BWP is activated and the first uplink BWP is deactivated). Downlink and uplink BWP switching may be performed independently (e.g., in paired spectrum/spectra). Downlink and uplink BWP switching may be performed simultaneously (e.g., in unpaired spectrum/spectra). Switching between configured BWPs may occur, for example, based on RRC signaling, DCI signaling, expiration of a BWP inactivity timer, and/or an initiation of random access.

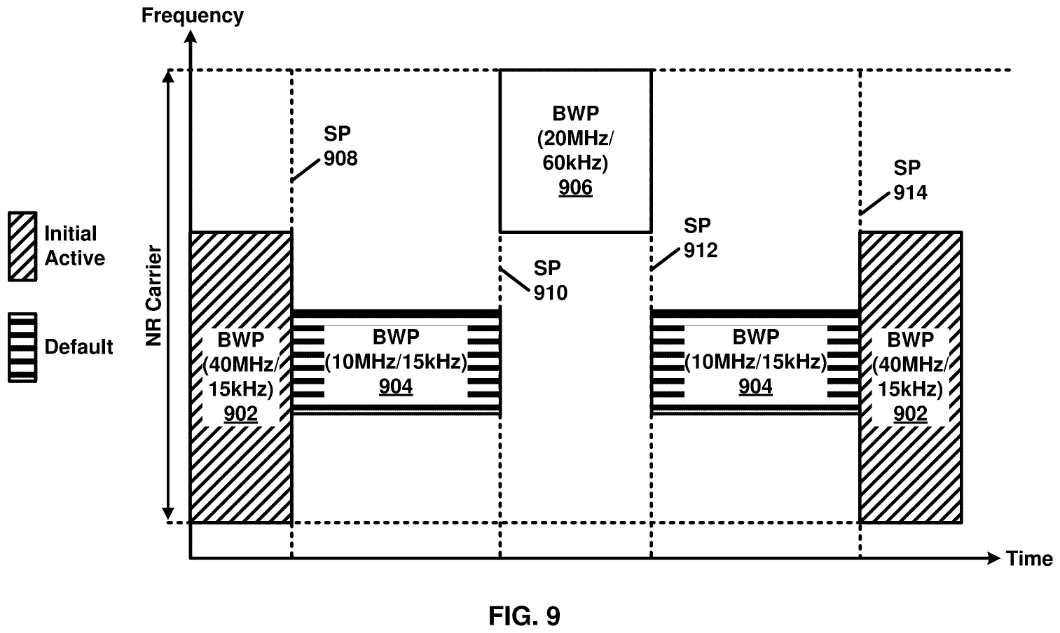

FIG. 9 shows an example of configured BWPs. Bandwidth adaptation using multiple BWPs (e.g., three configured BWPs for an NR carrier) may be available. A wireless device configured with multiple BWPs (e.g., the three BWPs) may switch from one BWP to another BWP at a switching point. The BWPs may comprise: a BWP 902 having a bandwidth of 40 MHz and a subcarrier spacing of 15 kHz; a BWP 904 having a bandwidth of 10 MHz and a subcarrier spacing of 15 kHz; and a BWP 906 having a bandwidth of 20 MHz and a subcarrier spacing of 60 kHz. The BWP 902 may be an initial active BWP, and the BWP 904 may be a default BWP. The wireless device may switch between BWPs at switching points. The wireless device may switch from the BWP 902 to the BWP 904 at a switching point 908. The switching at the switching point 908 may occur for any suitable reasons. The switching at a switching point 908 may occur, for example, based on (e.g., after or in response to) an expiry of a BWP inactivity timer (e.g., indicating switching to the default BWP). The switching at the switching point 908 may occur, for example, based on (e.g., after or in response to) receiving DCI indicating BWP 904 as the active BWP. The wireless device may switch at a switching point 910 from an active BWP 904 to the BWP 906, for example, after or in response to receiving DCI indicating BWP 906 as a new active BWP. The wireless device may switch at a switching point 912 from an active BWP 906 to the BWP 904, for example, a based on (e.g., after or in response to) an expiry of a BWP inactivity timer. The wireless device may switch at the switching point 912 from an active BWP 906 to the BWP 904, for example, after or in response to receiving DCI indicating BWP 904 as a new active BWP. The wireless device may switch at a switching point 914 from an active BWP 904 to the BWP 902, for example, after or in response to receiving DCI indicating the BWP 902 as a new active BWP.

Wireless device procedures for switching BWPs on a secondary cell may be the same/similar as those on a primary cell, for example, if the wireless device is configured for a secondary cell with a default downlink BWP in a set of configured downlink BWPs and a timer value. The wireless device may use the timer value and the default downlink BWP for the secondary cell in the same/similar manner as the wireless device uses the timer value and/or default BWPs for a primary cell. The timer value (e.g., the BWP inactivity timer) may be configured per cell (e.g., for one or more BWPs), for example, via RRC signaling or any other signaling. One or more active BWPs may switch to another BWP, for example, based on an expiration of the BWP inactivity timer.

Two or more carriers may be aggregated and data may be simultaneously sent/transmitted to/from the same wireless device using carrier aggregation (CA) (e.g., to increase data rates). The aggregated carriers in CA may be referred to as component carriers (CCs). There may be a quantity/number of serving cells for the wireless device (e.g., one serving cell for a CC), for example, if CA is configured/used. The CCs may have multiple configurations in the frequency domain.

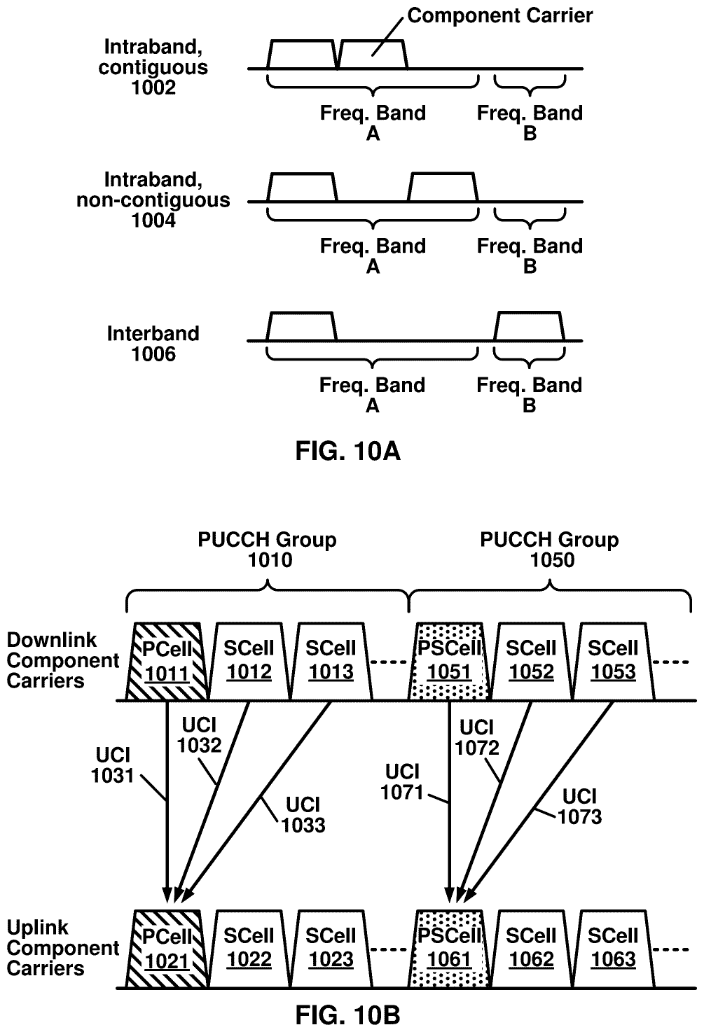

FIG. 10A shows example CA configurations based on CCs. As shown in FIG. 10A, three types of CA configurations may comprise an intraband (contiguous) configuration 1002, an intraband (non-contiguous) configuration 1004, and/or an interband configuration 1006. In the intraband (contiguous) configuration 1002, two CCs may be aggregated in the same frequency band (frequency band A) and may be located directly adjacent to each other within the frequency band. In the intraband (non-contiguous) configuration 1004, two CCs may be aggregated in the same frequency band (frequency band A) but may be separated from each other in the frequency band by a gap. In the interband configuration 1006, two CCs may be located in different frequency bands (e.g., frequency band A and frequency band B, respectively).

A network may set the maximum quantity of CCs that can be aggregated (e.g., up to 32 CCs may be aggregated in NR, or any other quantity may be aggregated in other systems). The aggregated CCs may have the same or different bandwidths, subcarrier spacing, and/or duplexing schemes (TDD, FDD, or any other duplexing schemes). A serving cell for a wireless device using CA may have a downlink CC. One or more uplink CCs may be optionally configured for a serving cell (e.g., for FDD). The ability to aggregate more downlink carriers than uplink carriers may be useful, for example, if the wireless device has more data traffic in the downlink than in the uplink.

One of the aggregated cells for a wireless device may be referred to as a primary cell (PCell), for example, if a CA is configured. The PCell may be the serving cell that the wireless initially connects to or access to, for example, during or at an RRC connection establishment, an RRC connection reestablishment, and/or a handover. The PCell may provide/configure the wireless device with NAS mobility information and the security input. Wireless device may have different PCells. For the downlink, the carrier corresponding to the PCell may be referred to as the downlink primary CC (DL PCC). For the uplink, the carrier corresponding to the PCell may be referred to as the uplink primary CC (UL PCC). The other aggregated cells (e.g., associated with CCs other than the DL PCC and UL PCC) for the wireless device may be referred to as secondary cells (SCells). The SCells may be configured, for example, after the PCell is configured for the wireless device. An SCell may be configured via an RRC connection reconfiguration procedure. For the downlink, the carrier corresponding to an SCell may be referred to as a downlink secondary CC (DL SCC). For the uplink, the carrier corresponding to the SCell may be referred to as the uplink secondary CC (UL SCC).

Configured SCells for a wireless device may be activated or deactivated, for example, based on traffic and channel conditions. Deactivation of an SCell may cause the wireless device to stop PDCCH and PDSCH reception on the SCell and PUSCH, SRS, and CQI transmissions on the SCell. Configured SCells may be activated or deactivated, for example, using a MAC CE (e.g., the MAC CE described with respect to FIG. 4B). A MAC CE may use a bitmap (e.g., one bit per SCell) to indicate which SCells (e.g., in a subset of configured SCells) for the wireless device are activated or deactivated. Configured SCells may be deactivated, for example, based on (e.g., after or in response to) an expiration of an SCell deactivation timer (e.g., one SCell deactivation timer per SCell may be configured).

DCI may comprise control information, such as scheduling assignments and scheduling grants, for a cell. DCI may be sent/transmitted via the cell corresponding to the scheduling assignments and/or scheduling grants, which may be referred to as a self-scheduling. DCI comprising control information for a cell may be sent/transmitted via another cell, which may be referred to as a cross-carrier scheduling. Uplink control information (UCI) may comprise control information, such as HARQ acknowledgments and channel state feedback (e.g., CQI, PMI, and/or RI) for aggregated cells. UCI may be sent/transmitted via an uplink control channel (e.g., a PUCCH) of the PCell or a certain SCell (e.g., an SCell configured with PUCCH). For a larger quantity/number of aggregated downlink CCs, the PUCCH of the PCell may become overloaded. Cells may be divided into multiple PUCCH groups.

FIG. 10B shows example group of cells. Aggregated cells may be configured into one or more PUCCH groups (e.g., as shown in FIG. 10B). One or more cell groups or one or more uplink control channel groups (e.g., a PUCCH group 1010 and a PUCCH group 1050) may comprise one or more downlink CCs, respectively. The PUCCH group 1010 may comprise one or more downlink CCs, for example, three downlink CCs: a PCell 1011 (e.g., a DL PCC), an SCell 1012 (e.g., a DL SCC), and an SCell 1013 (e.g., a DL SCC). The PUCCH group 1050 may comprise one or more downlink CCs, for example, three downlink CCs: a PUCCH SCell (or PSCell) 1051 (e.g., a DL SCC), an SCell 1052 (e.g., a DL SCC), and an SCell 1053 (e.g., a DL SCC). One or more uplink CCs of the PUCCH group 1010 may be configured as a PCell 1021 (e.g., a UL PCC), an SCell 1022 (e.g., a UL SCC), and an SCell 1023 (e.g., a UL SCC). One or more uplink CCs of the PUCCH group 1050 may be configured as a PUCCH SCell (or PSCell) 1061 (e.g., a UL SCC), an SCell 1062 (e.g., a UL SCC), and an SCell 1063 (e.g., a UL SCC). UCI related to the downlink CCs of the PUCCH group 1010, shown as UCI 1031, UCI 1032, and UCI 1033, may be sent/transmitted via the uplink of the PCell 1021 (e.g., via the PUCCH of the PCell 1021). UCI related to the downlink CCs of the PUCCH group 1050, shown as UCI 1071, UCI 1072, and UCI 1073, may be sent/transmitted via the uplink of the PUCCH SCell (or PSCell) 1061 (e.g., via the PUCCH of the PUCCH SCell 1061). A single uplink PCell may be configured to send/transmit UCI relating to the six downlink CCs, for example, if the aggregated cells shown in FIG. 10B are not divided into the PUCCH group 1010 and the PUCCH group 1050. The PCell 1021 may become overloaded, for example, if the UCIs 1031, 1032, 1033, 1071, 1072, and 1073 are sent/transmitted via the PCell 1021. By dividing transmissions of UCI between the PCell 1021 and the PUCCH SCell (or PSCell) 1061, overloading may be prevented and/or reduced.

A PCell may comprise a downlink carrier (e.g., the PCell 1011) and an uplink carrier (e.g., the PCell 1021). An SCell may comprise only a downlink carrier. A cell, comprising a downlink carrier and optionally an uplink carrier, may be assigned with a physical cell ID and a cell index. The physical cell ID or the cell index may indicate/identify a downlink carrier and/or an uplink carrier of the cell, for example, depending on the context in which the physical cell ID is used. A physical cell ID may be determined, for example, using a synchronization signal (e.g., PSS and/or SSS) sent/transmitted via a downlink component carrier. A cell index may be determined, for example, using one or more RRC messages. A physical cell ID may be referred to as a carrier ID, and a cell index may be referred to as a carrier index. A first physical cell ID for a first downlink carrier may refer to the first physical cell ID for a cell comprising the first downlink carrier. Substantially the same/similar concept may apply to, for example, a carrier activation. Activation of a first carrier may refer to activation of a cell comprising the first carrier.

A multi-carrier nature of a PHY layer may be exposed/indicated to a MAC layer (e.g., in a CA configuration). A HARQ entity may operate on a serving cell. A transport block may be generated per assignment/grant per serving cell. A transport block and potential HARQ retransmissions of the transport block may be mapped to a serving cell.

For the downlink, a base station may send/transmit (e.g., unicast, multicast, and/or broadcast), to one or more wireless devices, one or more reference signals (RSs) (e.g., PSS, SSS, CSI-RS, DM-RS, and/or PT-RS). For the uplink, the one or more wireless devices may send/transmit one or more RSs to the base station (e.g., DM-RS, PT-RS, and/or SRS). The PSS and the SSS may be sent/transmitted by the base station and used by the one or more wireless devices to synchronize the one or more wireless devices with the base station. A synchronization signal (SS)/physical broadcast channel (PBCH) block may comprise the PSS, the SSS, and the PBCH. The base station may periodically send/transmit a burst of SS/PBCH blocks, which may be referred to as SSBs.

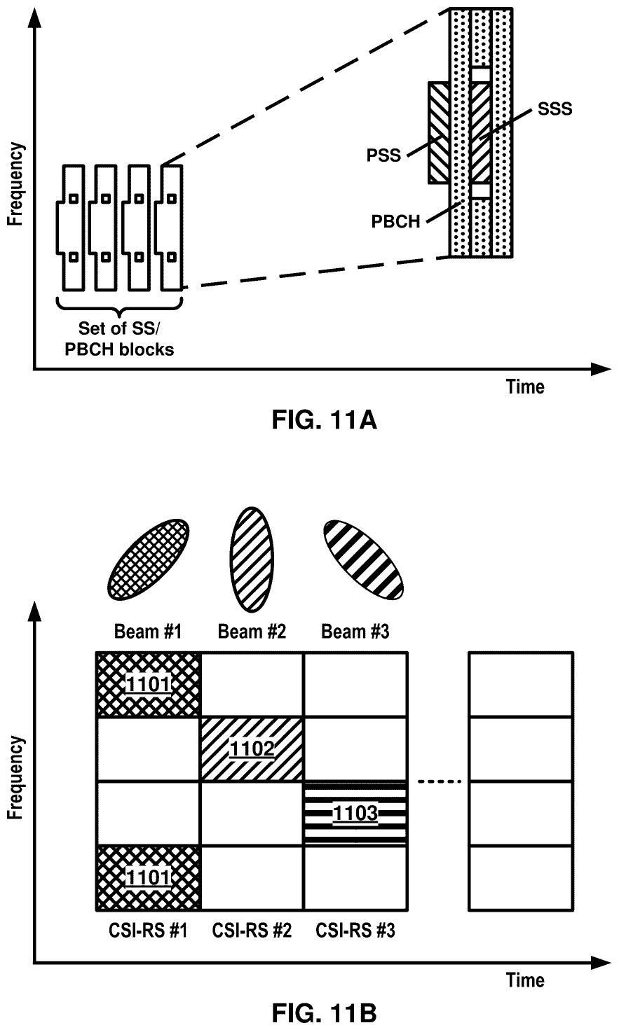

FIG. 11A shows an example mapping of one or more SS/PBCH blocks. A burst of SS/PBCH blocks may comprise one or more SS/PBCH blocks (e.g., 4 SS/PBCH blocks, as shown in FIG. 11A). Bursts may be sent/transmitted periodically (e.g., every 2 frames, 20 ms, or any other durations). A burst may be restricted to a half-frame (e.g., a first half-frame having a duration of 5 ms). Such parameters (e.g., the quantity/number of SS/PBCH blocks per burst, periodicity of bursts, position of the burst within the frame) may be configured, for example, based on at least one of: a carrier frequency of a cell in which the SS/PBCH block is sent/transmitted; a numerology or subcarrier spacing of the cell; a configuration by the network (e.g., using RRC signaling); and/or any other suitable factor(s). A wireless device may assume a subcarrier spacing for the SS/PBCH block based on the carrier frequency being monitored, for example, unless the radio network configured the wireless device to assume a different subcarrier spacing.

The SS/PBCH block may span one or more OFDM symbols in the time domain (e.g., 4 OFDM symbols, as shown in FIG. 11A or any other quantity/number of symbols) and may span one or more subcarriers in the frequency domain (e.g., 240 contiguous subcarriers or any other quantity/number of subcarriers). The PSS, the SSS, and the PBCH may have a common center frequency. The PSS may be sent/transmitted first and may span, for example, 1 OFDM symbol and 127 subcarriers. The SSS may be sent/transmitted after the PSS (e.g., two symbols later) and may span 1 OFDM symbol and 127 subcarriers. The PBCH may be sent/transmitted after the PSS (e.g., across the next 3 OFDM symbols) and may span 240 subcarriers (e.g., in the second and fourth OFDM symbols as shown in FIG. 11A) and/or may span fewer than 240 subcarriers (e.g., in the third OFDM symbols as shown in FIG. 11A).

The location of the SS/PBCH block in the time and frequency domains may not be known to the wireless device (e.g., if the wireless device is searching for the cell). The wireless device may monitor a carrier for the PSS, for example, to find and select the cell. The wireless device may monitor a frequency location within the carrier. The wireless device may search for the PSS at a different frequency location within the carrier, for example, if the PSS is not found after a certain duration (e.g., 20 ms). The wireless device may search for the PSS at a different frequency location within the carrier, for example, as indicated by a synchronization raster. The wireless device may determine the locations of the SSS and the PBCH, respectively, for example, based on a known structure of the SS/PBCH block if the PSS is found at a location in the time and frequency domains. The SS/PBCH block may be a cell-defining SS block (CD-SSB). A primary cell may be associated with a CD-SSB. The CD-SSB may be located on a synchronization raster. A cell selection/search and/or reselection may be based on the CD-SSB.

The SS/PBCH block may be used by the wireless device to determine one or more parameters of the cell. The wireless device may determine a physical cell identifier (PCI) of the cell, for example, based on the sequences of the PSS and the SSS, respectively. The wireless device may determine a location of a frame boundary of the cell, for example, based on the location of the SS/PBCH block. The SS/PBCH block may indicate that it has been sent/transmitted in accordance with a transmission pattern. An SS/PBCH block in the transmission pattern may be a known distance from the frame boundary (e.g., a predefined distance for a RAN configuration among one or more networks, one or more base stations, and one or more wireless devices).

The PBCH may use a QPSK modulation and/or forward error correction (FEC). The FEC may use polar coding. One or more symbols spanned by the PBCH may comprise/carry one or more DM-RSs for demodulation of the PBCH. The PBCH may comprise an indication of a current system frame quantity/number (SFN) of the cell and/or a SS/PBCH block timing index. These parameters may facilitate time synchronization of the wireless device to the base station. The PBCH may comprise a MIB used to send/transmit to the wireless device one or more parameters. The MIB may be used by the wireless device to locate remaining minimum system information (RMSI) associated with the cell. The RMSI may comprise a System Information Block Type 1 (SIB1). The SIB1 may comprise information for the wireless device to access the cell. The wireless device may use one or more parameters of the MIB to monitor a PDCCH, which may be used to schedule a PDSCH. The PDSCH may comprise the SIB1. The SIB1 may be decoded using parameters provided/comprised in the MIB. The PBCH may indicate an absence of SIB1. The wireless device may be pointed to a frequency, for example, based on the PBCH indicating the absence of SIB1. The wireless device may search for an SS/PBCH block at the frequency to which the wireless device is pointed.

The wireless device may assume that one or more SS/PBCH blocks sent/transmitted with a same SS/PBCH block index are quasi co-located (QCLed) (e.g., having substantially the same/similar Doppler spread, Doppler shift, average gain, average delay, and/or spatial Rx parameters). The wireless device may not assume QCL for SS/PBCH block transmissions having different SS/PBCH block indices. SS/PBCH blocks (e.g., those within a half-frame) may be sent/transmitted in spatial directions (e.g., using different beams that span a coverage area of the cell). A first SS/PBCH block may be sent/transmitted in a first spatial direction using a first beam, a second SS/PBCH block may be sent/transmitted in a second spatial direction using a second beam, a third SS/PBCH block may be sent/transmitted in a third spatial direction using a third beam, a fourth SS/PBCH block may be sent/transmitted in a fourth spatial direction using a fourth beam, etc.

A base station may send/transmit a plurality of SS/PBCH blocks, for example, within a frequency span of a carrier. A first PCI of a first SS/PBCH block of the plurality of SS/PBCH blocks may be different from a second PCI of a second SS/PBCH block of the plurality of SS/PBCH blocks. The PCIs of SS/PBCH blocks sent/transmitted in different frequency locations may be different or substantially the same.

The CSI-RS may be sent/transmitted by the base station and used by the wireless device to acquire/obtain/determine channel state information (CSI). The base station may configure the wireless device with one or more CSI-RSs for channel estimation or any other suitable purpose. The base station may configure a wireless device with one or more of the same/similar CSI-RSs. The wireless device may measure the one or more CSI-RSs. The wireless device may estimate a downlink channel state and/or generate a CSI report, for example, based on the measuring of the one or more downlink CSI-RSs. The wireless device may send/transmit the CSI report to the base station (e.g., based on periodic CSI reporting, semi-persistent CSI reporting, and/or aperiodic CSI reporting). The base station may use feedback provided by the wireless device (e.g., the estimated downlink channel state) to perform a link adaptation.

The base station may semi-statically configure the wireless device with one or more CSI-RS resource sets. A CSI-RS resource may be associated with a location in the time and frequency domains and a periodicity. The base station may selectively activate and/or deactivate a CSI-RS resource. The base station may indicate to the wireless device that a CSI-RS resource in the CSI-RS resource set is activated and/or deactivated.

The base station may configure the wireless device to report CSI measurements. The base station may configure the wireless device to provide CSI reports periodically, aperiodically, or semi-persistently. For periodic CSI reporting, the wireless device may be configured with a timing and/or periodicity of a plurality of CSI reports. For aperiodic CSI reporting, the base station may request a CSI report. The base station may command the wireless device to measure a configured CSI-RS resource and provide a CSI report relating to the measurement(s). For semi-persistent CSI reporting, the base station may configure the wireless device to send/transmit periodically, and selectively activate or deactivate the periodic reporting (e.g., via one or more activation/deactivation MAC CEs and/or one or more DCIs). The base station may configure the wireless device with a CSI-RS resource set and CSI reports, for example, using RRC signaling.

The CSI-RS configuration may comprise one or more parameters indicating, for example, up to 32 antenna ports (or any other quantity of antenna ports). The wireless device may be configured to use/employ the same OFDM symbols for a downlink CSI-RS and a CORESET, for example, if the downlink CSI-RS and CORESET are spatially QCLed and resource elements associated with the downlink CSI-RS are outside of the physical resource blocks (PRBs) configured for the CORESET. The wireless device may be configured to use/employ the same OFDM symbols for a downlink CSI-RS and SS/PBCH blocks, for example, if the downlink CSI-RS and SS/PBCH blocks are spatially QCLed and resource elements associated with the downlink CSI-RS are outside of PRBs configured for the SS/PBCH blocks.

Downlink DM-RSs may be sent/transmitted by a base station and received/used by a wireless device for a channel estimation. The downlink DM-RSs may be used for coherent demodulation of one or more downlink physical channels (e.g., PDSCH). A network (e.g., an NR network) may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., one or two adjacent OFDM symbols). A base station may semi-statically configure the wireless device with a quantity/number (e.g. a maximum quantity/number) of front-loaded DM-RS symbols for a PDSCH. A DM-RS configuration may support one or more DM-RS ports. A DM-RS configuration may support up to eight orthogonal downlink DM-RS ports per wireless device (e.g., for single user-MIMO). A DM-RS configuration may support up to 4 orthogonal downlink DM-RS ports per wireless device (e.g., for multiuser-MIMO). A radio network may support (e.g., at least for CP-OFDM) a common DM-RS structure for downlink and uplink. A DM-RS location, a DM-RS pattern, and/or a scrambling sequence may be the same or different. The base station may send/transmit a downlink DM-RS and a corresponding PDSCH, for example, using the same precoding matrix. The wireless device may use the one or more downlink DM-RSs for coherent demodulation/channel estimation of the PDSCH.

A transmitter (e.g., a transmitter of a base station) may use a precoder matrices for a part of a transmission bandwidth. The transmitter may use a first precoder matrix for a first bandwidth and a second precoder matrix for a second bandwidth. The first precoder matrix and the second precoder matrix may be different, for example, based on the first bandwidth being different from the second bandwidth. The wireless device may assume that a same precoding matrix is used across a set of PRBs. The set of PRBs may be determined/indicated/identified/denoted as a precoding resource block group (PRG).

A PDSCH may comprise one or more layers. The wireless device may assume that at least one symbol with DM-RS is present on a layer of the one or more layers of the PDSCH. A higher layer may configure one or more DM-RSs for a PDSCH (e.g., up to 3 DM-RSs for the PDSCH). Downlink PT-RS may be sent/transmitted by a base station and used by a wireless device, for example, for a phase-noise compensation. Whether a downlink PT-RS is present or not may depend on an RRC configuration. The presence and/or the pattern of the downlink PT-RS may be configured on a wireless device-specific basis, for example, using a combination of RRC signaling and/or an association with one or more parameters used/employed for other purposes (e.g., modulation and coding scheme (MCS)), which may be indicated by DCI. A dynamic presence of a downlink PT-RS, if configured, may be associated with one or more DCI parameters comprising at least MCS. A network (e.g., an NR network) may support a plurality of PT-RS densities defined in the time and/or frequency domains. A frequency domain density (if configured/present) may be associated with at least one configuration of a scheduled bandwidth. The wireless device may assume a same precoding for a DM-RS port and a PT-RS port. The quantity/number of PT-RS ports may be fewer than the quantity/number of DM-RS ports in a scheduled resource. Downlink PT-RS may be configured/allocated/confined in the scheduled time/frequency duration for the wireless device. Downlink PT-RS may be sent/transmitted via symbols, for example, to facilitate a phase tracking at the receiver.

The wireless device may send/transmit an uplink DM-RS to a base station, for example, for a channel estimation. The base station may use the uplink DM-RS for coherent demodulation of one or more uplink physical channels. The wireless device may send/transmit an uplink DM-RS with a PUSCH and/or a PUCCH. The uplink DM-RS may span a range of frequencies that is similar to a range of frequencies associated with the corresponding physical channel. The base station may configure the wireless device with one or more uplink DM-RS configurations. At least one DM-RS configuration may support a front-loaded DM-RS pattern. The front-loaded DM-RS may be mapped over one or more OFDM symbols (e.g., one or two adjacent OFDM symbols). One or more uplink DM-RSs may be configured to send/transmit at one or more symbols of a PUSCH and/or a PUCCH. The base station may semi-statically configure the wireless device with a quantity/number (e.g., the maximum quantity/number) of front-loaded DM-RS symbols for the PUSCH and/or the PUCCH, which the wireless device may use to schedule a single-symbol DM-RS and/or a double-symbol DM-RS. A network (e.g., an NR network) may support (e.g., for cyclic prefix orthogonal frequency division multiplexing (CP-OFDM)) a common DM-RS structure for downlink and uplink. A DM-RS location, a DM-RS pattern, and/or a scrambling sequence for the DM-RS may be substantially the same or different.

A PUSCH may comprise one or more layers. A wireless device may send/transmit at least one symbol with DM-RS present on a layer of the one or more layers of the PUSCH. A higher layer may configure one or more DM-RSs (e.g., up to three DM-RSs) for the PUSCH. Uplink PT-RS (which may be used by a base station for a phase tracking and/or a phase-noise compensation) may or may not be present, for example, depending on an RRC configuration of the wireless device. The presence and/or the pattern of an uplink PT-RS may be configured on a wireless device-specific basis (e.g., a UE-specific basis), for example, by a combination of RRC signaling and/or one or more parameters configured/employed for other purposes (e.g., MCS), which may be indicated by DCI. A dynamic presence of an uplink PT-RS, if configured, may be associated with one or more DCI parameters comprising at least MCS. A radio network may support a plurality of uplink PT-RS densities defined in time/frequency domain. A frequency domain density (if configured/present) may be associated with at least one configuration of a scheduled bandwidth. The wireless device may assume a same precoding for a DM-RS port and a PT-RS port. A quantity/number of PT-RS ports may be less than a quantity/number of DM-RS ports in a scheduled resource. An uplink PT-RS may be configured/allocated/confined in the scheduled time/frequency duration for the wireless device.

One or more SRSs may be sent/transmitted by a wireless device to a base station, for example, for a channel state estimation to support uplink channel dependent scheduling and/or a link adaptation. SRS sent/transmitted by the wireless device may enable/allow a base station to estimate an uplink channel state at one or more frequencies. A scheduler at the base station may use/employ the estimated uplink channel state to assign one or more resource blocks for an uplink PUSCH transmission for the wireless device. The base station may semi-statically configure the wireless device with one or more SRS resource sets. For an SRS resource set, the base station may configure the wireless device with one or more SRS resources. An SRS resource set applicability may be configured, for example, by a higher layer (e.g., RRC) parameter. An SRS resource in an SRS resource set of the one or more SRS resource sets (e.g., with the same/similar time domain behavior, periodic, aperiodic, and/or the like) may be sent/transmitted at a time instant (e.g., simultaneously), for example, if a higher layer parameter indicates beam management. The wireless device may send/transmit one or more SRS resources in SRS resource sets. A network (e.g., an NR network) may support aperiodic, periodic, and/or semi-persistent SRS transmissions. The wireless device may send/transmit SRS resources, for example, based on one or more trigger types. The one or more trigger types may comprise higher layer signaling (e.g., RRC) and/or one or more DCI formats. At least one DCI format may be used/employed for the wireless device to select at least one of one or more configured SRS resource sets. An SRS trigger type 0 may refer to an SRS triggered based on higher layer signaling. An SRS trigger type 1 may refer to an SRS triggered based on one or more DCI formats. The wireless device may be configured to send/transmit an SRS, for example, after a transmission of a PUSCH and a corresponding uplink DM-RS if a PUSCH and an SRS are sent/transmitted in a same slot. A base station may semi-statically configure a wireless device with one or more SRS configuration parameters indicating at least one of following: an SRS resource configuration identifier; a quantity/number of SRS ports; time domain behavior of an SRS resource configuration (e.g., an indication of periodic, semi-persistent, or aperiodic SRS); slot, mini-slot, and/or subframe level periodicity; an offset for a periodic and/or an aperiodic SRS resource; a quantity/number of OFDM symbols in an SRS resource; a starting OFDM symbol of an SRS resource; an SRS bandwidth; a frequency hopping bandwidth; a cyclic shift; and/or an SRS sequence ID.

An antenna port may be determined/defined such that the channel over which a symbol on the antenna port is conveyed can be inferred from the channel over which another symbol on the same antenna port is conveyed. The receiver may infer/determine the channel (e.g., fading gain, multipath delay, and/or the like) for conveying a second symbol on an antenna port, from the channel for conveying a first symbol on the antenna port, for example, if the first symbol and the second symbol are sent/transmitted on the same antenna port. A first antenna port and a second antenna port may be referred to as quasi co-located (QCLed), for example, if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming may require beam management. Beam management may comprise a beam measurement, a beam selection, and/or a beam indication. A beam may be associated with one or more reference signals. A beam may be identified by one or more beamformed reference signals. The wireless device may perform a downlink beam measurement, for example, based on one or more downlink reference signals (e.g., a CSI-RS) and generate a beam measurement report. The wireless device may perform the downlink beam measurement procedure, for example, after an RRC connection is set up with a base station.

FIG. 11B shows an example mapping of one or more CSI-RSs. The CSI-RSs may be mapped in the time and frequency domains. Each rectangular block shown in FIG. 11B may correspond to a resource block (RB) within a bandwidth of a cell. A base station may send/transmit one or more RRC messages comprising CSI-RS resource configuration parameters indicating one or more CSI-RSs. One or more of parameters may be configured by higher layer signaling (e.g., RRC and/or MAC signaling) for a CSI-RS resource configuration. The one or more of the parameters may comprise at least one of: a CSI-RS resource configuration identity, a quantity/number of CSI-RS ports, a CSI-RS configuration (e.g., symbol and resource element (RE) locations in a subframe), a CSI-RS subframe configuration (e.g., a subframe location, an offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

One or more beams may be configured for a wireless device in a wireless device-specific configuration. Three beams are shown in FIG. 11B (beam #1, beam #2, and beam #3), but more or fewer beams may be configured. Beam #1 may be allocated with CSI-RS 1101 that may be sent/transmitted in one or more subcarriers in an RB of a first symbol. Beam #2 may be allocated with CSI-RS 1102 that may be sent/transmitted in one or more subcarriers in an RB of a second symbol. Beam #3 may be allocated with CSI-RS 1103 that may be sent/transmitted in one or more subcarriers in an RB of a third symbol. A base station may use other subcarriers in the same RB (e.g., those that are not used to send/transmit CSI-RS 1101) to transmit another CSI-RS associated with a beam for another wireless device, for example, by using frequency division multiplexing (FDM). Beams used for a wireless device may be configured such that beams for the wireless device use symbols different from symbols used by beams of other wireless devices, for example, by using time domain multiplexing (TDM). A wireless device may be served with beams in orthogonal symbols (e.g., no overlapping symbols), for example, by using the TDM.

CSI-RSs (e.g., CSI-RSs 1101, 1102, 1103) may be sent/transmitted by the base station and used by the wireless device for one or more measurements. The wireless device may measure an RSRP of configured CSI-RS resources. The base station may configure the wireless device with a reporting configuration, and the wireless device may report the RSRP measurements to a network (e.g., via one or more base stations) based on the reporting configuration. The base station may determine, based on the reported measurement results, one or more transmission configuration indication/indicator (TCI) states comprising a quantity/number of reference signals. The base station may indicate one or more TCI states to the wireless device (e.g., via RRC signaling, a MAC CE, and/or DCI). The wireless device may receive a downlink transmission with an Rx beam determined based on the one or more TCI states. The wireless device may or may not have a capability of beam correspondence. The wireless device may determine a spatial domain filter of a transmit (Tx) beam, for example, based on a spatial domain filter of the corresponding Rx beam, if the wireless device has the capability of beam correspondence. The wireless device may perform an uplink beam selection procedure to determine the spatial domain filter of the Tx beam, for example, if the wireless device does not have the capability of beam correspondence. The wireless device may perform the uplink beam selection procedure, for example, based on one or more sounding reference signal (SRS) resources configured to the wireless device by the base station. The base station may select and indicate uplink beams for the wireless device, for example, based on measurements of the one or more SRS resources sent/transmitted by the wireless device.

A wireless device may determine/assess (e.g., measure) a channel quality of one or more beam pair links, for example, in a beam management procedure. A beam pair link may comprise a Tx beam of a base station and an Rx beam of the wireless device. The Tx beam of the base station may send/transmit a downlink signal, and the Rx beam of the wireless device may receive the downlink signal. The wireless device may send/transmit a beam measurement report, for example, based on the assessment/determination. The beam measurement report may indicate one or more beam pair quality parameters comprising at least one of: one or more beam identifications (e.g., a beam index, a reference signal index, or the like), an RSRP, a precoding matrix indicator (PMI), a channel quality indicator (CQI), and/or a rank indicator (RI).

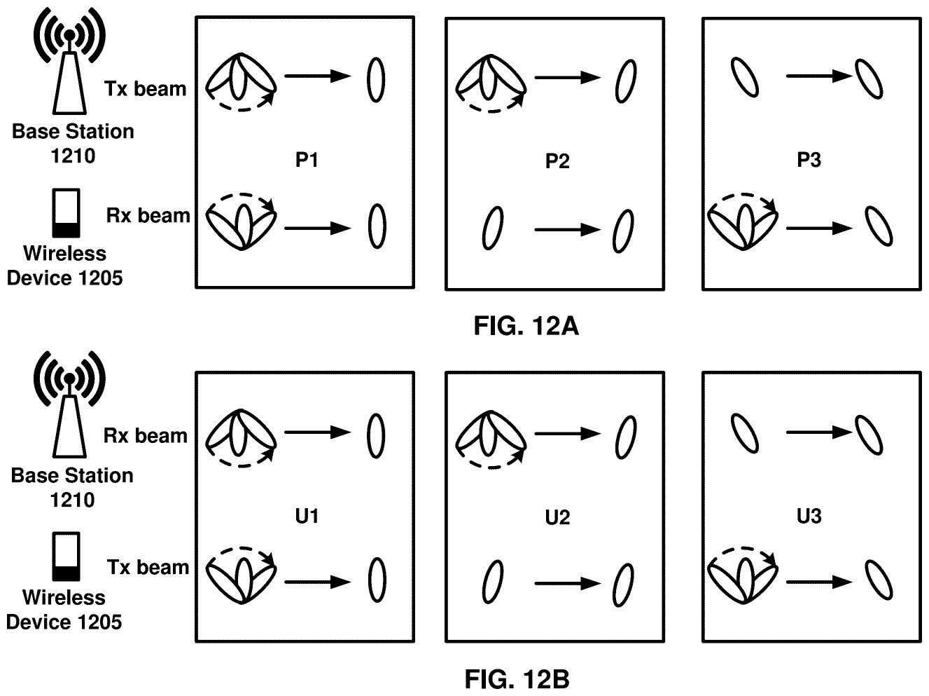

FIG. 12A shows examples of downlink beam management procedures. One or more downlink beam management procedures (e.g., downlink beam management procedures P1, P2, and P3) may be performed. Procedure P1 may enable a measurement (e.g., a wireless device measurement) on Tx beams of a TRP (or multiple TRPs) (e.g., to support a selection of one or more base station Tx beams and/or wireless device Rx beams). The Tx beams of a base station (e.g., base station 1210) and the Rx beams of a wireless device (e.g., wireless device 1205) are shown as ovals in the top row of P1 and bottom row of P1, respectively. Beamforming (e.g., at a TRP) may comprise a Tx beam sweep for a set of beams (e.g., the beam sweeps shown, in the top rows of P1 and P2, as ovals rotated in a counter-clockwise direction indicated by the dashed arrows). Beamforming (e.g., at a wireless device) may comprise an Rx beam sweep for a set of beams (e.g., the beam sweeps shown, in the bottom rows of P1 and P3, as ovals rotated in a clockwise direction indicated by the dashed arrows). Procedure P2 may be used to enable a measurement (e.g., a wireless device measurement) on Tx beams of a TRP (shown, in the top row of P2, as ovals rotated in a counter-clockwise direction indicated by the dashed arrow). The wireless device and/or the base station may perform procedure P2, for example, using a smaller set of beams than the set of beams used in procedure P1, or using narrower beams than the beams used in procedure P1. Procedure P2 may be referred to as a beam refinement. The wireless device may perform procedure P3 for an Rx beam determination, for example, by using the same Tx beam(s) of the base station and sweeping Rx beam(s) of the wireless device.

FIG. 12B shows examples of uplink beam management procedures. One or more uplink beam management procedures (e.g., uplink beam management procedures U1, U2, and U3) may be performed. Procedure U1 may be used to enable a base station (e.g., base station 1210) to perform a measurement on Tx beams of a wireless device (e.g., wireless device 1205) (e.g., to support a selection of one or more Tx beams of the wireless device and/or Rx beams of the base station). The Tx beams of the wireless device and the Rx beams of the base station are shown as ovals in the top row of U1 and bottom row of U1, respectively). Beamforming (e.g., at the wireless device) may comprise one or more beam sweeps, for example, a Tx beam sweep from a set of beams (shown, in the bottom rows of U1 and U3, as ovals rotated in a clockwise direction indicated by the dashed arrows). Beamforming (e.g., at the base station) may comprise one or more beam sweeps, for example, an Rx beam sweep from a set of beams (shown, in the top rows of U1 and U2, as ovals rotated in a counter-clockwise direction indicated by the dashed arrows). Procedure U2 may be used to enable the base station to adjust its Rx beam, for example, if the wireless device (e.g., UE) uses a fixed Tx beam. The wireless device and/or the base station may perform procedure U2, for example, using a smaller set of beams than the set of beams used in procedure P1, or using narrower beams than the beams used in procedure P1. Procedure U2 may be referred to as a beam refinement. The wireless device may perform procedure U3 to adjust its Tx beam, for example, if the base station uses a fixed Rx beam.

A wireless device may initiate/start/perform a beam failure recovery (BFR) procedure, for example, based on detecting a beam failure. The wireless device may send/transmit a BFR request (e.g., a preamble, UCI, an SR, a MAC CE, and/or the like), for example, based on the initiating the BFR procedure. The wireless device may detect the beam failure, for example, based on a determination that a quality of beam pair link(s) of an associated control channel is unsatisfactory (e.g., having an error rate higher than an error rate threshold, a received signal power lower than a received signal power threshold, an expiration of a timer, and/or the like).

The wireless device may measure a quality of a beam pair link, for example, using one or more reference signals (RSs) comprising one or more SS/PBCH blocks, one or more CSI-RS resources, and/or one or more DM-RSs. A quality of the beam pair link may be based on one or more of a block error rate (BLER), an RSRP value, a signal to interference plus noise ratio (SINR) value, an RSRQ value, and/or a CSI value measured on RS resources. The base station may indicate that an RS resource is QCLed with one or more DM-RSs of a channel (e.g., a control channel, a shared data channel, and/or the like). The RS resource and the one or more DM-RSs of the channel may be QCLed, for example, if the channel characteristics (e.g., Doppler shift, Doppler spread, an average delay, delay spread, a spatial Rx parameter, fading, and/or the like) from a transmission via the RS resource to the wireless device are similar or the same as the channel characteristics from a transmission via the channel to the wireless device.

A network (e.g., an NR network comprising a gNB and/or an ng-eNB) and/or the wireless device may initiate/start/perform a random access procedure. A wireless device in an RRC idle (e.g., an RRC_IDLE) state and/or an RRC inactive (e.g., an RRC_INACTIVE) state may initiate/perform the random access procedure to request a connection setup to a network. The wireless device may initiate/start/perform the random access procedure from an RRC connected (e.g., an RRC_CONNECTED) state. The wireless device may initiate/start/perform the random access procedure to request uplink resources (e.g., for uplink transmission of an SR if there is no PUCCH resource available) and/or acquire/obtain/determine an uplink timing (e.g., if an uplink synchronization status is non-synchronized). The wireless device may initiate/start/perform the random access procedure to request one or more system information blocks (SIBs) (e.g., other system information blocks, such as SIB2, SIB3, and/or the like). The wireless device may initiate/start/perform the random access procedure for a beam failure recovery request. A network may initiate/start/perform a random access procedure, for example, for a handover and/or for establishing time alignment for an SCell addition.

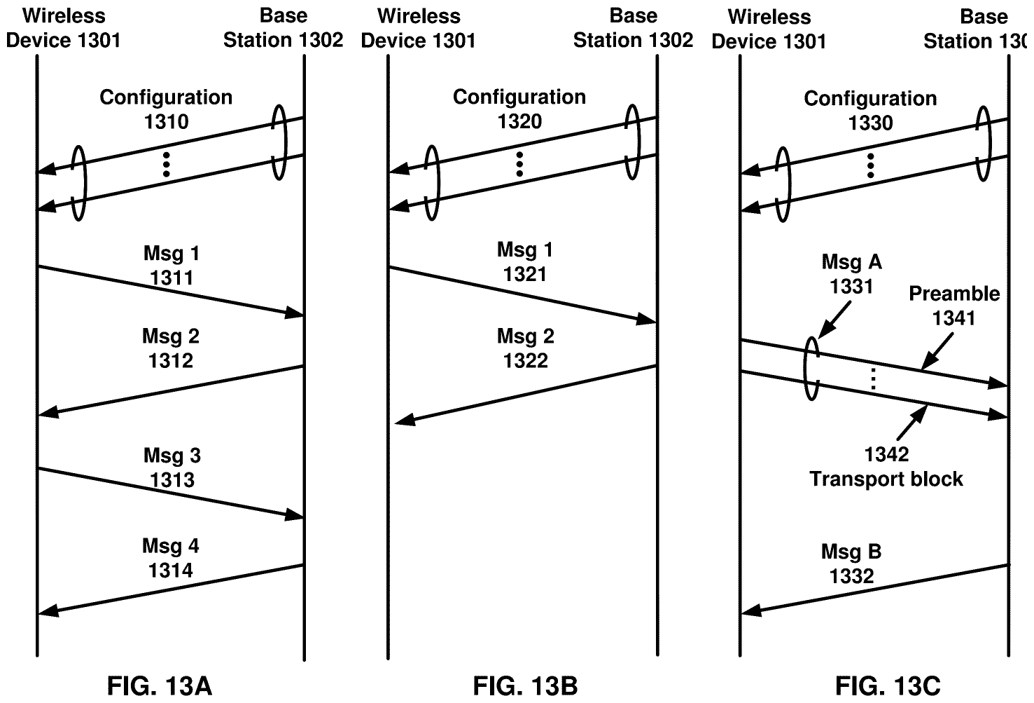

FIG. 13A shows an example four-step random access procedure. The four-step random access procedure may comprise a four-step contention-based random access procedure. A base station (e.g., base station 1302) may send/transmit a configuration message 1310 to a wireless device (e.g., wireless device 1301), for example, before initiating the random access procedure. The four-step random access procedure may comprise transmissions of four messages comprising: a first message (e.g., Msg 1 1311), a second message (e.g., Msg 2 1312), a third message (e.g., Msg 3 1313), and a fourth message (e.g., Msg 4 1314). The first message (e.g., Msg 1 1311) may comprise a preamble (or a random access preamble). The first message (e.g., Msg 1 1311) may be referred to as a preamble. The second message (e.g., Msg 2 1312) may comprise as a random access response (RAR). The second message (e.g., Msg 2 1312) may be referred to as an RAR.

The configuration message 1310 may be sent/transmitted, for example, using one or more RRC messages. The one or more RRC messages may indicate one or more random access channel (RACH) parameters to the wireless device. The one or more RACH parameters may comprise at least one of: general parameters for one or more random access procedures (e.g., RACH-configGeneral); cell-specific parameters (e.g., RACH-ConfigCommon); and/or dedicated parameters (e.g., RACH-configDedicated). The base station may send/transmit (e.g., broadcast or multicast) the one or more RRC messages to one or more wireless devices. The one or more RRC messages may be wireless device-specific. The one or more RRC messages that are wireless device-specific may be, for example, dedicated RRC messages sent/transmitted to a wireless device in an RRC connected (e.g., an RRC_CONNECTED) state and/or in an RRC inactive (e.g., an RRC_INACTIVE) state. The wireless devices may determine, based on the one or more RACH parameters, a time-frequency resource and/or an uplink transmit power for transmission of the first message (e.g., Msg 1 1311) and/or the third message (e.g., Msg 3 1313). The wireless device may determine a reception timing and a downlink channel for receiving the second message (e.g., Msg 2 1312) and the fourth message (e.g., Msg 4 1314), for example, based on the one or more RACH parameters.

The one or more RACH parameters provided/configured/comprised in the configuration message 1310 may indicate one or more Physical RACH (PRACH) occasions available for transmission of the first message (e.g., Msg 1 1311). The one or more PRACH occasions may be predefined (e.g., by a network comprising one or more base stations). The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. The one or more RACH parameters may indicate a quantity/number of SS/PBCH blocks mapped to a PRACH occasion and/or a quantity/number of preambles mapped to a SS/PBCH blocks.

The one or more RACH parameters provided/configured/comprised in the configuration message 1310 may be used to determine an uplink transmit power of first message (e.g., Msg 1 1311) and/or third message (e.g., Msg 3 1313). The one or more RACH parameters may indicate a reference power for a preamble transmission (e.g., a received target power and/or an initial power of the preamble transmission). There may be one or more power offsets indicated by the one or more RACH parameters. The one or more RACH parameters may indicate: a power ramping step; a power offset between SSB and CSI-RS; a power offset between transmissions of the first message (e.g., Msg 1 1311) and the third message (e.g., Msg 3 1313); and/or a power offset value between preamble groups. The one or more RACH parameters may indicate one or more thresholds, for example, based on which the wireless device may determine at least one reference signal (e.g., an SSB and/or CSI-RS) and/or an uplink carrier (e.g., a normal uplink (NUL) carrier and/or a supplemental uplink (SUL) carrier).

The first message (e.g., Msg 1 1311) may comprise one or more preamble transmissions (e.g., a preamble transmission and one or more preamble retransmissions). An RRC message may be used to configure one or more preamble groups (e.g., group A and/or group B). A preamble group may comprise one or more preambles. The wireless device may determine the preamble group, for example, based on a pathloss measurement and/or a size of the third message (e.g., Msg 3 1313). The wireless device may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The wireless device may select at least one preamble associated with the one or more reference signals and/or a selected preamble group, for example, if the association between the one or more preambles and the at least one reference signal is configured by an RRC message.

The wireless device may determine the preamble, for example, based on the one or more RACH parameters provided/configured/comprised in the configuration message 1310. The wireless device may determine the preamble, for example, based on a pathloss measurement, an RSRP measurement, and/or a size of the third message (e.g., Msg 3 1313). The one or more RACH parameters may indicate: a preamble format; a maximum quantity/number of preamble transmissions; and/or one or more thresholds for determining one or more preamble groups (e.g., group A and group B). A base station may use the one or more RACH parameters to configure the wireless device with an association between one or more preambles and one or more reference signals (e.g., SSBs and/or CSI-RSs). The wireless device may determine the preamble to be comprised in first message (e.g., Msg 1 1311), for example, based on the association if the association is configured. The first message (e.g., Msg 1 1311) may be sent/transmitted to the base station via one or more PRACH occasions. The wireless device may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The wireless device may perform a preamble retransmission, for example, if no response is received based on (e.g., after or in response to) a preamble transmission (e.g., for a period of time, such as a monitoring window for monitoring an RAR). The wireless device may increase an uplink transmit power for the preamble retransmission. The wireless device may select an initial preamble transmit power, for example, based on a pathloss measurement and/or a target received preamble power configured by the network. The wireless device may determine to resend/retransmit a preamble and may ramp up the uplink transmit power. The wireless device may receive one or more RACH parameters (e.g., PREAMBLE_POWER_RAMPING_STEP) indicating a ramping step for the preamble retransmission. The ramping step may be an amount of incremental increase in uplink transmit power for a retransmission. The wireless device may ramp up the uplink transmit power, for example, if the wireless device determines a reference signal (e.g., SSB and/or CSI-RS) that is the same as a previous preamble transmission. The wireless device may count the quantity/number of preamble transmissions and/or retransmissions, for example, using a counter parameter (e.g., PREAMBLE_TRANSMISSION_COUNTER). The wireless device may determine that a random access procedure has been completed unsuccessfully, for example, if the quantity/number of preamble transmissions exceeds a threshold configured by the one or more RACH parameters (e.g., preambleTransMax) without receiving a successful response (e.g., an RAR).

The second message (e.g., Msg 2 1312) (e.g., received by the wireless device) may comprise an RAR. The second message (e.g., Msg 2 1312) may comprise multiple RARs corresponding to multiple wireless devices. The second message (e.g., Msg 2 1312) may be received, for example, based on (e.g., after or in response to) the sending/transmitting of the first message (e.g., Msg 1 1311). The second message (e.g., Msg 2 1312) may be scheduled on the DL-SCH and may be indicated by a PDCCH, for example, using a random access radio network temporary identifier (RA RNTI). The second message (e.g., Msg 2 1312) may indicate that the first message (e.g., Msg 1 1311) was received by the base station. The second message (e.g., Msg 2 1312) may comprise a time-alignment command that may be used by the wireless device to adjust the transmission timing of the wireless device, a scheduling grant for transmission of the third message (e.g., Msg 3 1313), and/or a Temporary Cell RNTI (TC-RNTI). The wireless device may determine/start a time window (e.g., ra-ResponseWindow) to monitor a PDCCH for the second message (e.g., Msg 2 1312), for example, after sending/transmitting the first message (e.g., Msg 1 1311) (e.g., a preamble). The wireless device may determine the start time of the time window, for example, based on a PRACH occasion that the wireless device uses to send/transmit the first message (e.g., Msg 1 1311) (e.g., the preamble). The wireless device may start the time window one or more symbols after the last symbol of the first message (e.g., Msg 1 1311) comprising the preamble (e.g., the symbol in which the first message (e.g., Msg 1 1311) comprising the preamble transmission was completed or at a first PDCCH occasion from an end of a preamble transmission). The one or more symbols may be determined based on a numerology. The PDCCH may be mapped in a common search space (e.g., a Type1-PDCCH common search space) configured by an RRC message. The wireless device may identify/determine the RAR, for example, based on an RNTI. Radio network temporary identifiers (RNTIs) may be used depending on one or more events initiating/starting the random access procedure. The wireless device may use a RA-RNTI, for example, for one or more communications associated with random access or any other purpose. The RA-RNTI may be associated with PRACH occasions in which the wireless device sends/transmits a preamble. The wireless device may determine the RA-RNTI, for example, based on at least one of: an OFDM symbol index; a slot index; a frequency domain index; and/or a UL carrier indicator of the PRACH occasions. An example RA-RNTI may be determined as follows:

$$RA - RNTI = 1 + s\_id + 14 \times t\_id + 14 \times 80 \times f\_id + 14 \times 80 \times 8 \times ul\_carrier \_id$$

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The wireless device may send/transmit the third message (e.g., Msg 3 1313), for example, based on (e.g., after or in response to) a successful reception of the second message (e.g., Msg 2 1312) (e.g., using resources identified in the Msg 2 1312). The third message (e.g., Msg 3 1313) may be used, for example, for contention resolution in the contention-based random access procedure. A plurality of wireless devices may send/transmit the same preamble to a base station, and the base station may send/transmit an RAR that corresponds to a wireless device. Collisions may occur, for example, if the plurality of wireless device interpret the RAR as corresponding to themselves. Contention resolution (e.g., using the third message (e.g., Msg 3 1313) and the fourth message (e.g., Msg 4 1314)) may be used to increase the likelihood that the wireless device does not incorrectly use an identity of another the wireless device. The wireless device may comprise a device identifier in the third message (e.g., Msg 3 1313) (e.g., a C-RNTI if assigned, a TC RNTI comprised in the second message (e.g., Msg 2 1312), and/or any other suitable identifier), for example, to perform contention resolution.

The fourth message (e.g., Msg 4 1314) may be received, for example, based on (e.g., after or in response to) the sending/transmitting of the third message (e.g., Msg 3 1313). The base station may address the wireless on the PDCCH (e.g., the base station may send the PDCCH to the wireless device) using a C-RNTI, for example, If the C-RNTI was included in the third message (e.g., Msg 3 1313). The random access procedure may be determined to be successfully completed, for example, if the unique C RNTI of the wireless device is detected on the PDCCH (e.g., the PDCCH is scrambled by the C-RNTI). fourth message (e.g., Msg 4 1314) may be received using a DL-SCH associated with a TC RNTI, for example, if the TC RNTI is comprised in the third message (e.g., Msg 3 1313) (e.g., if the wireless device is in an RRC idle (e.g., an RRC_IDLE) state or not otherwise connected to the base station). The wireless device may determine that the contention resolution is successful and/or the wireless device may determine that the random access procedure is successfully completed, for example, if a MAC PDU is successfully decoded and a MAC PDU comprises the wireless device contention resolution identity MAC CE that matches or otherwise corresponds with the CCCH SDU sent/transmitted in third message (e.g., Msg 3 1313).

The wireless device may be configured with an SUL carrier and/or an NUL carrier. An initial access (e.g., random access) may be supported via an uplink carrier. A base station may configure the wireless device with multiple RACH configurations (e.g., two separate RACH configurations comprising: one for an SUL carrier and the other for an NUL carrier). For random access in a cell configured with an SUL carrier, the network may indicate which carrier to use (NUL or SUL). The wireless device may determine to use the SUL carrier, for example, if a measured quality of one or more reference signals (e.g., one or more reference signals associated with the NUL carrier) is lower than a broadcast threshold. Uplink transmissions of the random access procedure (e.g., the first message (e.g., Msg 1 1311) and/or the third message (e.g., Msg 3 1313)) may remain on, or may be performed via, the selected carrier. The wireless device may switch an uplink carrier during the random access procedure (e.g., between the Msg 1 1311 and the Msg 3 1313). The wireless device may determine and/or switch an uplink carrier for the first message (e.g., Msg 1 1311) and/or the third message (e.g., Msg 3 1313), for example, based on a channel clear assessment (e.g., a listen-before-talk).

FIG. 13B shows a two-step random access procedure. The two-step random access procedure may comprise a two-step contention-free random access procedure. Similar to the four-step contention-based random access procedure, a base station (e.g., base station 1302) may, prior to initiation of the procedure, send/transmit a configuration message 1320 to the wireless device (e.g., wireless device 1301). The configuration message 1320 may be analogous in some respects to the configuration message 1310. The procedure shown in FIG. 13B may comprise transmissions of two messages: a first message (e.g., Msg 1 1321) and a second message (e.g., Msg 2 1322). The first message (e.g., Msg 1 1321) and the second message (e.g., Msg 2 1322) may be analogous in some respects to the first message (e.g., Msg 1 1311) and a second message (e.g., Msg 2 1312), respectively. The two-step contention-free random access procedure may not comprise messages analogous to the third message (e.g., Msg 3 1313) and/or the fourth message (e.g., Msg 4 1314).

The two-step (e.g., contention-free) random access procedure may be configured/initiated for a beam failure recovery, other SI request, an SCell addition, and/or a handover. A base station may indicate, or assign to, the wireless device a preamble to be used for the first message (e.g., Msg 1 1321). The wireless device may receive, from the base station via a PDCCH and/or an RRC, an indication of the preamble (e.g., ra-PreambleIndex).

The wireless device may start a time window (e.g., ra-ResponseWindow) to monitor a PDCCH for the RAR, for example, based on (e.g., after or in response to) sending/transmitting the preamble. The base station may configure the wireless device with one or more beam failure recovery parameters, such as a separate time window and/or a separate PDCCH in a search space indicated by an RRC message (e.g., recoverySearchSpaceId). The base station may configure the one or more beam failure recovery parameters, for example, in association with a beam failure recovery request. The separate time window for monitoring the PDCCH and/or an RAR may be configured to start after sending/transmitting a beam failure recovery request (e.g., the window may start any quantity of symbols and/or slots after sending/transmitting the beam failure recovery request). The wireless device may monitor for a PDCCH transmission addressed to a Cell RNTI (C-RNTI) on the search space. During the two-step (e.g., contention-free) random access procedure, the wireless device may determine that a random access procedure is successful, for example, based on (e.g., after or in response to) sending/transmitting first message (e.g., Msg 1 1321) and receiving a corresponding second message (e.g., Msg 2 1322). The wireless device may determine that a random access procedure has successfully been completed, for example, if a PDCCH transmission is addressed to a corresponding C-RNTI. The wireless device may determine that a random access procedure has successfully been completed, for example, if the wireless device receives an RAR comprising a preamble identifier corresponding to a preamble sent/transmitted by the wireless device and/or the RAR comprises a MAC sub-PDU with the preamble identifier. The wireless device may determine the response as an indication of an acknowledgement for an SI request.

FIG. 13C shows an example two-step random access procedure. Similar to the random access procedures shown in FIGS. 13A and 13B, a base station (e.g., base station 1302) may, prior to initiation of the procedure, send/transmit a configuration message 1330 to the wireless device (e.g., wireless device 1301). The configuration message 1330 may be analogous in some respects to the configuration message 1310 and/or the configuration message 1320. The procedure shown in FIG. 13C may comprise transmissions of multiple messages (e.g., two messages comprising: a first message (e.g., Msg A 1331) and a second message (e.g., Msg B 1332)).

Msg A 1320 may be sent/transmitted in an uplink transmission by the wireless device. Msg A 1320 may comprise one or more transmissions of a preamble 1341 and/or one or more transmissions of a transport block 1342. The transport block 1342 may comprise contents that are similar and/or equivalent to the contents of the third message (e.g., Msg 3 1313) (e.g., shown in FIG. 13A). The transport block 1342 may comprise UCI (e.g., an SR, a HARQ ACK/NACK, and/or the like). The wireless device may receive the second message (e.g., Msg B 1332), for example, based on (e.g., after or in response to) sending/transmitting the first message (e.g., Msg A 1331). The second message (e.g., Msg B 1332) may comprise contents that are similar and/or equivalent to the contents of the second message (e.g., Msg 2 1312) (e.g., an RAR shown in FIGS. 13A), the contents of the second message (e.g., Msg 2 1322) (e.g., an RAR shown in FIG. 13B) and/or the fourth message (e.g., Msg 4 1314) (e.g., shown in FIG. 13A).

The wireless device may start/initiate the two-step random access procedure (e.g., the two-step random access procedure shown in FIG. 13C) for a licensed spectrum and/or an unlicensed spectrum. The wireless device may determine, based on one or more factors, whether to start/initiate the two-step random access procedure. The one or more factors may comprise at least one of: a radio access technology in use (e.g., LTE, NR, and/or the like); whether the wireless device has a valid TA or not; a cell size; the RRC state of the wireless device; a type of spectrum (e.g., licensed vs. unlicensed); and/or any other suitable factors.

The wireless device may determine, based on two-step RACH parameters comprised in the configuration message 1330, a radio resource and/or an uplink transmit power for the preamble 1341 and/or the transport block 1342 (e.g., comprised in the first message (e.g., Msg A 1331)). The RACH parameters may indicate an MCS, a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the wireless device to determine a reception timing and a downlink channel for monitoring for and/or receiving second message (e.g., Msg B 1332).

The transport block 1342 may comprise data (e.g., delay-sensitive data), an identifier of the wireless device, security information, and/or device information (e.g., an International Mobile Subscriber Identity (IMSI)). The base station may send/transmit the second message (e.g., Msg B 1332) as a response to the first message (e.g., Msg A 1331). The second message (e.g., Msg B 1332) may comprise at least one of: a preamble identifier; a timing advance command; a power control command; an uplink grant (e.g., a radio resource assignment and/or an MCS); a wireless device identifier (e.g., a UE identifier for contention resolution); and/or an RNTI (e.g., a C-RNTI or a TC-RNTI). The wireless device may determine that the two-step random access procedure is successfully completed, for example, if a preamble identifier in the second message (e.g., Msg B 1332) corresponds to, or is matched to, a preamble sent/transmitted by the wireless device and/or the identifier of the wireless device in second message (e.g., Msg B 1332) corresponds to, or is matched to, the identifier of the wireless device in the first message (e.g., Msg A 1331) (e.g., the transport block 1342).

A wireless device and a base station may exchange control signaling (e.g., control information). The control signaling may be referred to as L1/L2 control signaling and may originate from the PHY layer (e.g., layer 1) and/or the MAC layer (e.g., layer 2) of the wireless device or the base station. The control signaling may comprise downlink control signaling sent/transmitted from the base station to the wireless device and/or uplink control signaling sent/transmitted from the wireless device to the base station.

The downlink control signaling may comprise at least one of: a downlink scheduling assignment; an uplink scheduling grant indicating uplink radio resources and/or a transport format; slot format information; a preemption indication; a power control command; and/or any other suitable signaling. The wireless device may receive the downlink control signaling in a payload sent/transmitted by the base station via a PDCCH. The payload sent/transmitted via the PDCCH may be referred to as downlink control information (DCI). The PDCCH may be a group common PDCCH (GC-PDCCH) that is common to a group of wireless devices. The GC-PDCCH may be scrambled by a group common RNTI.

A base station may attach one or more cyclic redundancy check (CRC) parity bits to DCI, for example, in order to facilitate detection of transmission errors. The base station may scramble the CRC parity bits with an identifier of a wireless device (or an identifier of a group of wireless devices), for example, if the DCI is intended for the wireless device (or the group of the wireless devices). Scrambling the CRC parity bits with the identifier may comprise Modulo-2 addition (or an exclusive-OR operation) of the identifier value and the CRC parity bits. The identifier may comprise a 16-bit value of an RNTI.

DCIs may be used for different purposes. A purpose may be indicated by the type of an RNTI used to scramble the CRC parity bits. DCI having CRC parity bits scrambled with a paging RNTI (P-RNTI) may indicate paging information and/or a system information change notification. The P-RNTI may be predefined as “FFFE” in hexadecimal. DCI having CRC parity bits scrambled with a system information RNTI (SI-RNTI) may indicate a broadcast transmission of the system information. The SI-RNTI may be predefined as “FFFF” in hexadecimal. DCI having CRC parity bits scrambled with a random access RNTI (RA-RNTI) may indicate a random access response (RAR). DCI having CRC parity bits scrambled with a cell RNTI (C-RNTI) may indicate a dynamically scheduled unicast transmission and/or a triggering of PDCCH-ordered random access. DCI having CRC parity bits scrambled with a temporary cell RNTI (TC-RNTI) may indicate a contention resolution (e.g., a Msg 3 analogous to the Msg 3 1313 shown in FIG. 13A). Other RNTIs configured for a wireless device by a base station may comprise a Configured Scheduling RNTI (CS RNTI), a Transmit Power Control-PUCCH RNTI (TPC PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C RNTI), and/or the like.

A base station may send/transmit DCIs with one or more DCI formats, for example, depending on the purpose and/or content of the DCIs. DCI format 0_0 may be used for scheduling of a PUSCH in a cell. DCI format 0_0 may be a fallback DCI format (e.g., with compact DCI payloads). DCI format 0_1 may be used for scheduling of a PUSCH in a cell (e.g., with more DCI payloads than DCI format 0_0). DCI format 1_0 may be used for scheduling of a PDSCH in a cell. DCI format 1_0 may be a fallback DCI format (e.g., with compact DCI payloads). DCI format 1_1 may be used for scheduling of a PDSCH in a cell (e.g., with more DCI payloads than DCI format 1_0). DCI format 2_0 may be used for providing a slot format indication to a group of wireless devices. DCI format 2_1 may be used for informing/notifying a group of wireless devices of a physical resource block and/or an OFDM symbol where the group of wireless devices may assume no transmission is intended to the group of wireless devices. DCI format 2_2 may be used for transmission of a transmit power control (TPC) command for PUCCH or PUSCH. DCI format 2_3 may be used for transmission of a group of TPC commands for SRS transmissions by one or more wireless devices. DCI format(s) for new functions may be defined in future releases. DCI formats may have different DCI sizes, or may share the same DCI size.

The base station may process the DCI with channel coding (e.g., polar coding), rate matching, scrambling and/or QPSK modulation, for example, after scrambling the DCI with an RNTI. A base station may map the coded and modulated DCI on resource elements used and/or configured for a PDCCH. The base station may send/transmit the DCI via a PDCCH occupying a quantity/number of contiguous control channel elements (CCEs), for example, based on a payload size of the DCI and/or a coverage of the base station. The quantity/number of the contiguous CCEs (referred to as aggregation level) may be 1, 2, 4, 8, 16, and/or any other suitable quantity/number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

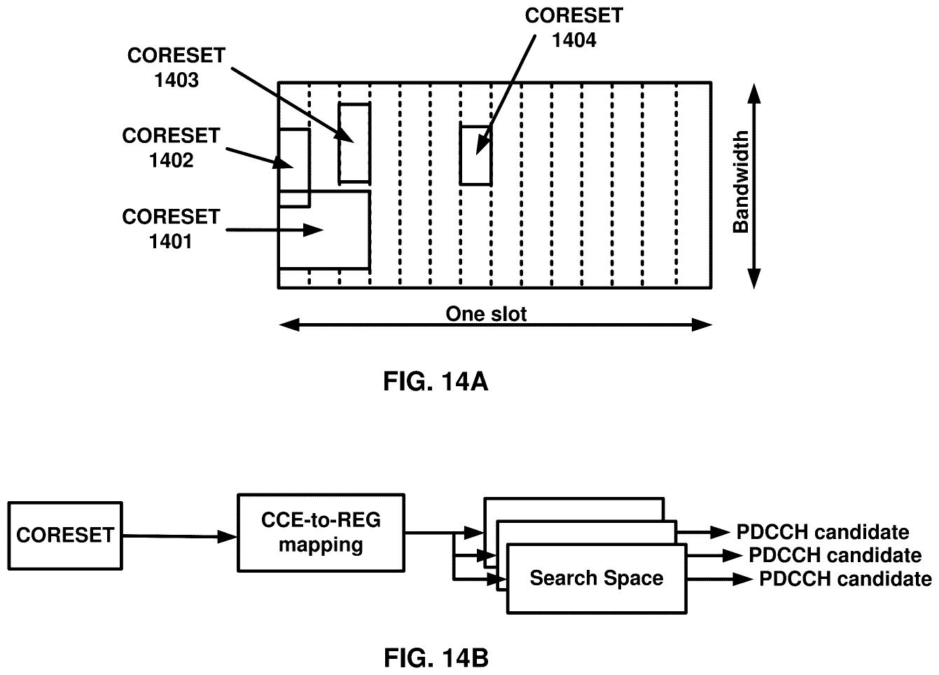

FIG. 14A shows an example of CORESET configurations. The CORESET configurations may be for a bandwidth part or any other frequency bands. The base station may send/transmit DCI via a PDCCH on one or more control resource sets (CORESETs). A CORESET may comprise a time-frequency resource in which the wireless device attempts/tries to decode DCI using one or more search spaces. The base station may configure a size and a location of the CORESET in the time-frequency domain. A first CORESET 1401 and a second CORESET 1402 may occur or may be set/configured at the first symbol in a slot. The first CORESET 1401 may overlap with the second CORESET 1402 in the frequency domain. A third CORESET 1403 may occur or may be set/configured at a third symbol in the slot. A fourth CORESET 1404 may occur or may be set/configured at the seventh symbol in the slot. CORESETs may have a different quantity/number of resource blocks in frequency domain.

FIG. 14B shows an example of a CCE-to-REG mapping. The CCE-to-REG mapping may be performed for DCI transmission via a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping (e.g., by an RRC configuration). A CORESET may be configured with an antenna port QCL parameter. The antenna port QCL parameter may indicate QCL information of a DM-RS for a PDCCH reception via the CORESET.

The base station may send/transmit, to the wireless device, one or more RRC messages comprising configuration parameters of one or more CORESETs and one or more search space sets. The configuration parameters may indicate an association between a search space set and a CORESET. A search space set may comprise a set of PDCCH candidates formed by CCEs (e.g., at a given aggregation level). The configuration parameters may indicate at least one of: a quantity/number of PDCCH candidates to be monitored per aggregation level; a PDCCH monitoring periodicity and a PDCCH monitoring pattern; one or more DCI formats to be monitored by the wireless device; and/or whether a search space set is a common search space set or a wireless device-specific search space set (e.g., a UE-specific search space set). A set of CCEs in the common search space set may be predefined and known to the wireless device. A set of CCEs in the wireless device-specific search space set (e.g., the UE-specific search space set) may be configured, for example, based on the identity of the wireless device (e.g., C-RNTI).

As shown in FIG. 14B, the wireless device may determine a time-frequency resource for a CORESET based on one or more RRC messages. The wireless device may determine a CCE-to-REG mapping (e.g., interleaved or non-interleaved, and/or mapping parameters) for the CORESET, for example, based on configuration parameters of the CORESET. The wireless device may determine a quantity/number (e.g., at most 10) of search space sets configured on/for the CORESET, for example, based on the one or more RRC messages. The wireless device may monitor a set of PDCCH candidates according to configuration parameters of a search space set. The wireless device may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding DCI content of one or more PDCCH candidates with possible (or configured) PDCCH locations, possible (or configured) PDCCH formats (e.g., the quantity/number of CCEs, the quantity/number of PDCCH candidates in common search spaces, and/or the quantity/number of PDCCH candidates in the wireless device-specific search spaces) and possible (or configured) DCI formats. The decoding may be referred to as blind decoding. The wireless device may determine DCI as valid for the wireless device, for example, based on (e.g., after or in response to) CRC checking (e.g., scrambled bits for CRC parity bits of the DCI matching an RNTI value). The wireless device may process information comprised in the DCI (e.g., a scheduling assignment, an uplink grant, power control, a slot format indication, a downlink preemption, and/or the like).

The may send/transmit uplink control signaling (e.g., UCI) to a base station. The uplink control signaling may comprise HARQ acknowledgements for received DL-SCH transport blocks. The wireless device may send/transmit the HARQ acknowledgements, for example, based on (e.g., after or in response to) receiving a DL-SCH transport block. Uplink control signaling may comprise CSI indicating a channel quality of a physical downlink channel. The wireless device may send/transmit the CSI to the base station. The base station, based on the received CSI, may determine transmission format parameters (e.g., comprising multi-antenna and beamforming schemes) for downlink transmission(s). Uplink control signaling may comprise scheduling requests (SR). The wireless device may send/transmit an SR indicating that uplink data is available for transmission to the base station. The wireless device may send/transmit UCI (e.g., HARQ acknowledgements (HARQ-ACK), CSI report, SR, and the like) via a PUCCH or a PUSCH. The wireless device may send/transmit the uplink control signaling via a PUCCH using one of several PUCCH formats.

There may be multiple PUCCH formats (e.g., five PUCCH formats). A wireless device may determine a PUCCH format, for example, based on a size of UCI (e.g., a quantity/number of uplink symbols of UCI transmission and a quantity/number of UCI bits). PUCCH format 0 may have a length of one or two OFDM symbols and may comprise two or fewer bits. The wireless device may send/transmit UCI via a PUCCH resource, for example, using PUCCH format 0 if the transmission is over/via one or two symbols and the quantity/number of HARQ-ACK information bits with positive or negative SR (HARQ-ACK/SR bits) is one or two. PUCCH format 1 may occupy a quantity/number of OFDM symbols (e.g., between four and fourteen OFDM symbols) and may comprise two or fewer bits. The wireless device may use PUCCH format 1, for example, if the transmission is over/via four or more symbols and the quantity/number of HARQ-ACK/SR bits is one or two. PUCCH format 2 may occupy one or two OFDM symbols and may comprise more than two bits. The wireless device may use PUCCH format 2, for example, if the transmission is over/via one or two symbols and the quantity/number of UCI bits is two or more. PUCCH format 3 may occupy a quantity/number of OFDM symbols (e.g., between four and fourteen OFDM symbols) and may comprise more than two bits. The wireless device may use PUCCH format 3, for example, if the transmission is four or more symbols, the quantity/number of UCI bits is two or more, and the PUCCH resource does not comprise an orthogonal cover code (OCC). PUCCH format 4 may occupy a quantity/number of OFDM symbols (e.g., between four and fourteen OFDM symbols) and may comprise more than two bits. The wireless device may use PUCCH format 4, for example, if the transmission is four or more symbols, the quantity/number of UCI bits is two or more, and the PUCCH resource comprises an OCC.

The base station may send/transmit configuration parameters to the wireless device for a plurality of PUCCH resource sets, for example, using an RRC message. The plurality of PUCCH resource sets (e.g., up to four sets in NR, or up to any other quantity of sets in other systems) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a quantity/number (e.g. a maximum quantity/number) of UCI information bits the wireless device may send/transmit using one of the plurality of PUCCH resources in the PUCCH resource set. The wireless device may select one of the plurality of PUCCH resource sets, for example, based on a total bit length of the UCI information bits (e.g., HARQ-ACK, SR, and/or CSI) if configured with a plurality of PUCCH resource sets. The wireless device may select a first PUCCH resource set having a PUCCH resource set index equal to “0,” for example, if the total bit length of UCI information bits is two or fewer. The wireless device may select a second PUCCH resource set having a PUCCH resource set index equal to “1,” for example, if the total bit length of UCI information bits is greater than two and less than or equal to a first configured value. The wireless device may select a third PUCCH resource set having a PUCCH resource set index equal to “2,” for example, if the total bit length of UCI information bits is greater than the first configured value and less than or equal to a second configured value. The wireless device may select a fourth PUCCH resource set having a PUCCH resource set index equal to “3,” for example, if the total bit length of UCI information bits is greater than the second configured value and less than or equal to a third value (e.g., 1406, 1706, or any other quantity of bits).

The wireless device may determine a PUCCH resource from the PUCCH resource set for UCI (HARQ-ACK, CSI, and/or SR) transmission, for example, after determining a PUCCH resource set from a plurality of PUCCH resource sets. The wireless device may determine the PUCCH resource, for example, based on a PUCCH resource indicator in DCI (e.g., with DCI format 1_0 or DCI for 1_1) received on/via a PDCCH. An n-bit (e.g., a three-bit) PUCCH resource indicator in the DCI may indicate one of multiple (e.g., eight) PUCCH resources in the PUCCH resource set. The wireless device may send/transmit the UCI (HARQ-ACK, CSI and/or SR) using a PUCCH resource indicated by the PUCCH resource indicator in the DCI, for example, based on the PUCCH resource indicator.

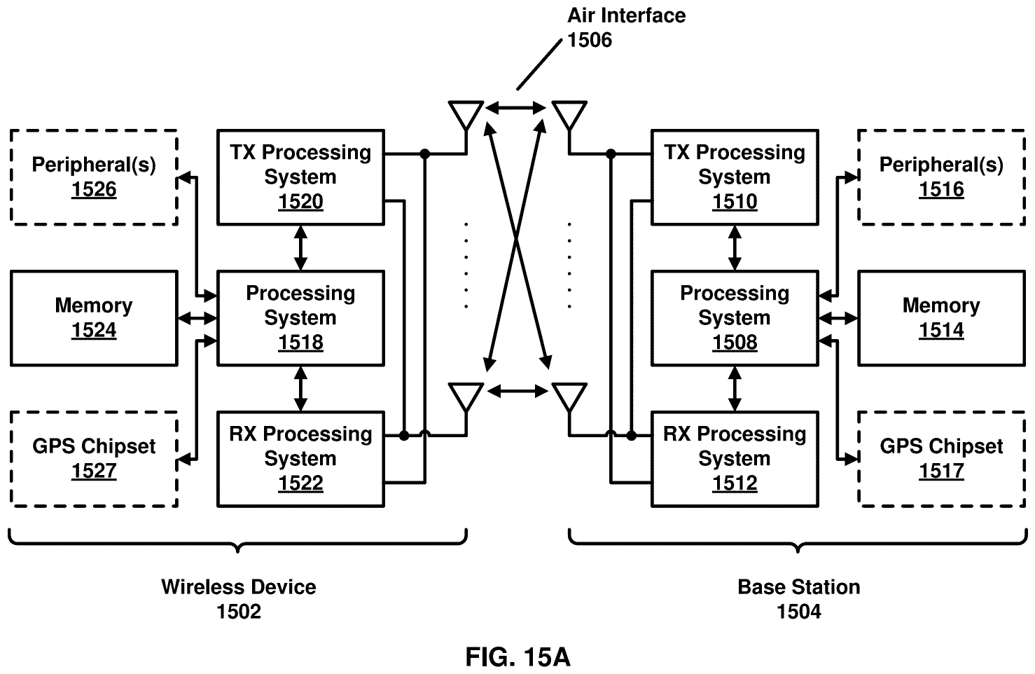

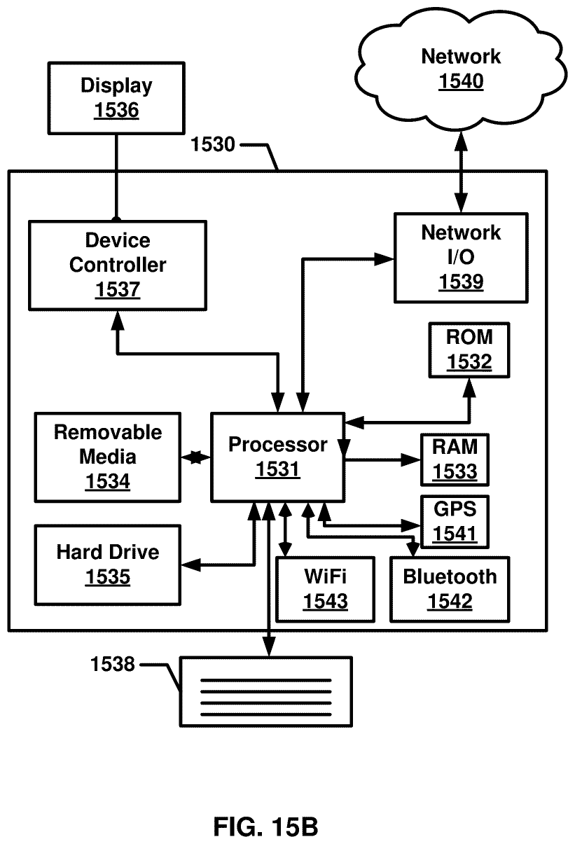

FIG. 15A shows example communications between a wireless device and a base station. A wireless device 1502 and a base station 1504 may be part of a communication network, such as the communication network 100 shown in FIG. 1A, the communication network 150 shown in FIG. 1B, or any other communication network. A communication network may comprise more than one wireless device and/or more than one base station, with substantially the same or similar configurations as those shown in FIG. 15A.

The base station 1504 may connect the wireless device 1502 to a core network (not shown) via radio communications over the air interface (or radio interface) 1506. The communication direction from the base station 1504 to the wireless device 1502 over the air interface 1506 may be referred to as the downlink. The communication direction from the wireless device 1502 to the base station 1504 over the air interface may be referred to as the uplink. Downlink transmissions may be separated from uplink transmissions, for example, using various duplex schemes (e.g., FDD, TDD, and/or some combination of the duplexing techniques).

For the downlink, data to be sent to the wireless device 1502 from the base station 1504 may be provided/transferred/sent to the processing system 1508 of the base station 1504. The data may be provided/transferred/sent to the processing system 1508 by, for example, a core network. For the uplink, data to be sent to the base station 1504 from the wireless device 1502 may be provided/transferred/sent to the processing system 1518 of the wireless device 1502. The processing system 1508 and the processing system 1518 may implement layer 3 and layer 2 OSI functionality to process the data for transmission. Layer 2 may comprise an SDAP layer, a PDCP layer, an RLC layer, and a MAC layer, for example, described with respect to FIG. 2A, FIG. 2B, FIG. 3, and FIG. 4A. Layer 3 may comprise an RRC layer, for example, described with respect to FIG. 2B.

The data to be sent to the wireless device 1502 may be provided/transferred/sent to a transmission processing system 1510 of base station 1504, for example, after being processed by the processing system 1508. The data to be sent to base station 1504 may be provided/transferred/sent to a transmission processing system 1520 of the wireless device 1502, for example, after being processed by the processing system 1518. The transmission processing system 1510 and the transmission processing system 1520 may implement layer 1 OSI functionality. Layer 1 may comprise a PHY layer, for example, described with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

A reception processing system 1512 of the base station 1504 may receive the uplink transmission from the wireless device 1502. The reception processing system 1512 of the base station 1504 may comprise one or more TRPs. A reception processing system 1522 of the wireless device 1502 may receive the downlink transmission from the base station 1504. The reception processing system 1522 of the wireless device 1502 may comprise one or more antenna panels. The reception processing system 1512 and the reception processing system 1522 may implement layer 1 OSI functionality. Layer 1 may include a PHY layer, for example, described with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

The base station 1504 may comprise multiple antennas (e.g., multiple antenna panels, multiple TRPs, etc.). The wireless device 1502 may comprise multiple antennas (e.g., multiple antenna panels, etc.). The multiple antennas may be used to perform one or more MIMO or multi-antenna techniques, such as spatial multiplexing (e.g., single-user MIMO or multi-user MIMO), transmit/receive diversity, and/or beamforming. The wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518, respectively, to carry out one or more of the functionalities (e.g., one or more functionalities described herein and other functionalities of general computers, processors, memories, and/or other peripherals). The transmission processing system 1510 and/or the reception processing system 1512 may be coupled to the memory 1514 and/or another memory (e.g., one or more non-transitory computer readable mediums) storing computer program instructions or code that may be executed to carry out one or more of their respective functionalities. The transmission processing system 1520 and/or the reception processing system 1522 may be coupled to the memory 1524 and/or another memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and/or the base station 1504 to operate in a wireless environment.

The processing system 1508 may be connected to one or more peripherals 1516. The processing system 1518 may be connected to one or more peripherals 1526. The one or more peripherals 1516 and the one or more peripherals 1526 may comprise software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive input data (e.g., user input data) from, and/or provide output data (e.g., user output data) to, the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 may be connected to a Global Positioning System (GPS) chipset 1517. The processing system 1518 may be connected to a Global Positioning System (GPS) chipset 1527. The GPS chipset 1517 and the GPS chipset 1527 may be configured to determine and provide geographic location information of the wireless device 1502 and the base station 1504, respectively.

FIG. 15B shows example elements of a computing device that may be used to implement any of the various devices described herein, including, for example, the base station 160A, 160B, 162A, 162B, 220, 1210, 1302, and/or 1710, the wireless device 106, 156A, 156B, 210, 1205, 1301, and/or 1705, 1805, or any other base station, wireless device, AMF, UPF, network device, or computing device described herein. The computing device 1530 may include one or more processors 1531, which may execute instructions stored in the random-access memory (RAM) 1533, the removable media 1534 (such as a Universal Serial Bus (USB) drive, compact disk (CD) or digital versatile disk (DVD), or floppy disk drive), or any other desired storage medium. Instructions may also be stored in an attached (or internal) hard drive 1535. The computing device 1530 may also include a security processor (not shown), which may execute instructions of one or more computer programs to monitor the processes executing on the processor 1531 and any process that requests access to any hardware and/or software components of the computing device 1530 (e.g., ROM 1532, RAM 1533, the removable media 1534, the hard drive 1535, the device controller 1537, a network interface 1539, a GPS 1541, a Bluetooth interface 1542, a WiFi interface 1543, etc.). The computing device 1530 may include one or more output devices, such as the display 1536 (e.g., a screen, a display device, a monitor, a television, etc.), and may include one or more output device controllers 1537, such as a video processor. There may also be one or more user input devices 1538, such as a remote control, keyboard, mouse, touch screen, microphone, etc. The computing device 1530 may also include one or more network interfaces, such as a network interface 1539, which may be a wired interface, a wireless interface, or a combination of the two. The network interface 1539 may provide an interface for the computing device 1530 to communicate with a network 1540 (e.g., a RAN, or any other network). The network interface 1539 may include a modem (e.g., a cable modem), and the external network 1540 may include communication links, an external network, an in-home network, a provider's wireless, coaxial, fiber, or hybrid fiber/coaxial distribution system (e.g., a DOCSIS network), or any other desired network. Additionally, the computing device 1530 may include a location-detecting device, such as a global positioning system (GPS) microprocessor 1541, which may be configured to receive and process global positioning signals and determine, with possible assistance from an external server and antenna, a geographic position of the computing device 1530.

The example in FIG. 15B may be a hardware configuration, although the components shown may be implemented as software as well. Modifications may be made to add, remove, combine, divide, etc. components of the computing device 1530 as desired. Additionally, the components may be implemented using basic computing devices and components, and the same components (e.g., processor 1531, ROM storage 1532, display 1536, etc.) may be used to implement any of the other computing devices and components described herein. For example, the various components described herein may be implemented using computing devices having components such as a processor executing computer-executable instructions stored on a computer-readable medium, as shown in FIG. 15B. Some or all of the entities described herein may be software based, and may co-exist in a common physical platform (e.g., a requesting entity may be a separate software process and program from a dependent entity, both of which may be executed as software on a common computing device).

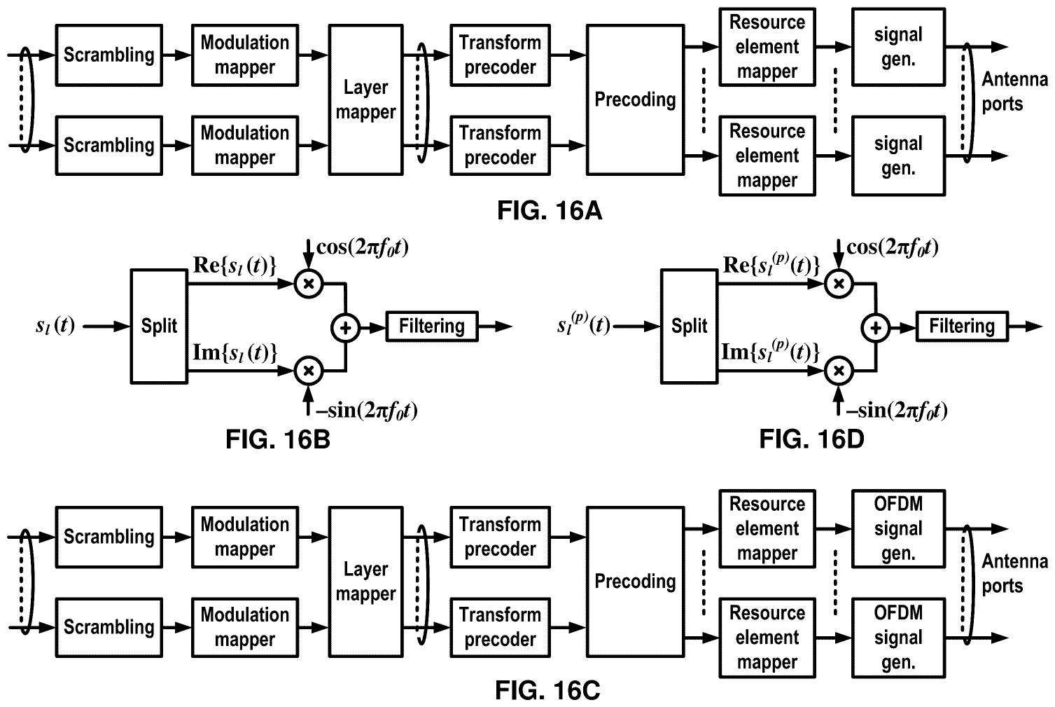

FIG. 16A shows an example structure for uplink transmission. Processing of a baseband signal representing a physical uplink shared channel may comprise/perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA), CP-OFDM signal for an antenna port, or any other signals; and/or the like. An SC-FDMA signal for uplink transmission may be generated, for example, if transform precoding is enabled. A CP-OFDM signal for uplink transmission may be generated, for example, if transform precoding is not enabled (e.g., as shown in FIG. 16A). These functions are examples and other mechanisms for uplink transmission may be implemented.

FIG. 16B shows an example structure for modulation and up-conversion of a baseband signal to a carrier frequency. The baseband signal may be a complex-valued SC-FDMA, CP-OFDM baseband signal (or any other baseband signals) for an antenna port and/or a complex-valued Physical Random Access Channel (PRACH) baseband signal. Filtering may be performed/employed, for example, prior to transmission.

FIG. 16C shows an example structure for downlink transmissions. Processing of a baseband signal representing a physical downlink channel may comprise/perform one or more functions. The one or more functions may comprise: scrambling of coded bits in a codeword to be sent/transmitted on/via a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are examples and other mechanisms for downlink transmission may be implemented.

FIG. 16D shows an example structure for modulation and up-conversion of a baseband signal to a carrier frequency. The baseband signal may be a complex-valued OFDM baseband signal for an antenna port or any other signal. Filtering may be performed/employed, for example, prior to transmission.

A wireless device may receive, from a base station, one or more messages (e.g. RRC messages) comprising configuration parameters of a plurality of cells (e.g., a primary cell, one or more secondary cells). The wireless device may communicate with at least one base station (e.g., two or more base stations in dual-connectivity) via the plurality of cells. The one or more messages (e.g. as a part of the configuration parameters) may comprise parameters of PHY, MAC, RLC, PCDP, SDAP, RRC layers for configuring the wireless device. The configuration parameters may comprise parameters for configuring PHY and MAC layer channels, bearers, etc. The configuration parameters may comprise parameters indicating values of timers for PHY, MAC, RLC, PCDP, SDAP, RRC layers, and/or communication channels.

A timer may begin running, for example, after (e.g., as soon as) it is started and continue running until it is stopped or until it expires. A timer may be started, for example, if it is not running or restarted if it is running. A timer may be associated with a value (e.g., the timer may be started or restarted from a value or may be started from zero and expire after (e.g., as soon as) it reaches the value). The duration of a timer may not be updated, for example, until the timer is stopped or expires (e.g., due to BWP switching). A timer may be used to measure a time period/window for a process. With respect to an implementation and/or procedure related to one or more timers or other parameters, it will be understood that there may be multiple ways to implement the one or more timers or other parameters. One or more of the multiple ways to implement a timer may be used to measure a time period/window for the procedure. A random access response window timer may be used for measuring a window of time for receiving a random access response. The time difference between two time stamps may be used, for example, instead of starting a random access response window timer and determine the expiration of the timer. A process for measuring a time window may be restarted, for example, if a timer is restarted. Other example implementations may be configured/provided to restart a measurement of a time window.

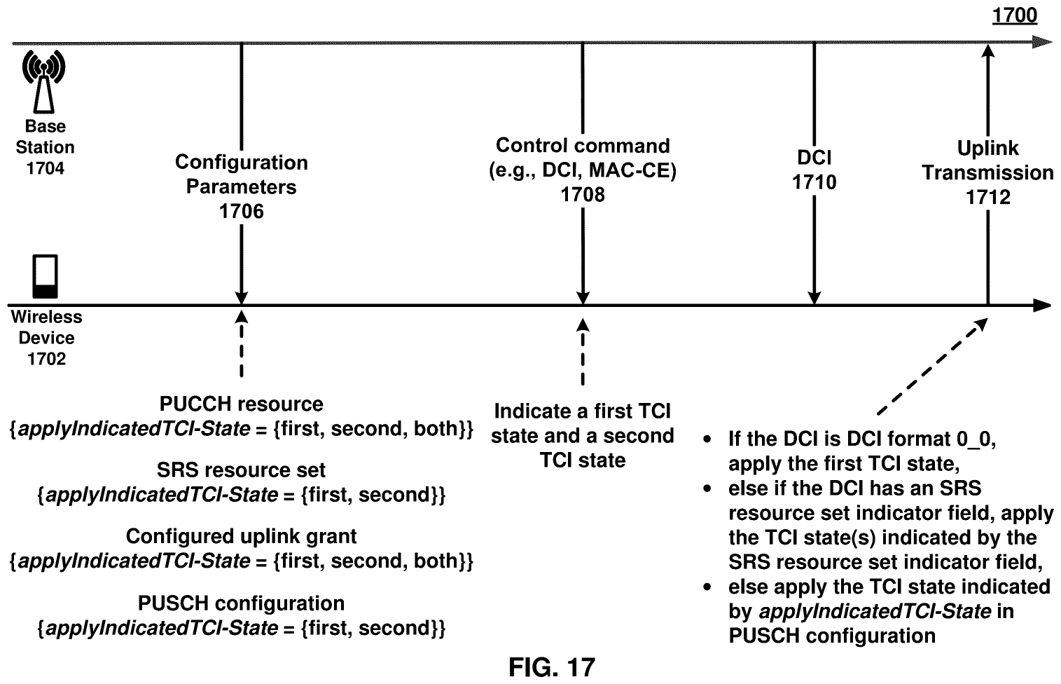

FIG. 17 shows an example of uplink transmission using a transmission configuration indicator (TCI) state. A procedure 1700 may be used to enable uplink transmission using a TCI state, for example, from/via a wireless device 1702 to a base station 1704. The procedure 1700 may comprise steps 1706, 1708, 1710, and 1712, as shown in FIG. 17.

The base station 1704 may send (e.g., transmit), to wireless device 1702, one or more configuration parameters, as shown at step 1706 in FIG. 17. The one or more configuration parameters may comprise/indicate a list of TCI states. The one or more configuration parameters may configure the wireless device 1702 with the list of TCI states.

The one or more configuration parameters may comprise a higher layer parameter (e.g., PDSCH-Config). The higher layer parameter (e.g., PDSCH-Config) may configure the wireless device 1702 with one or more TCI states, such as a list of TCI states. The wireless device 1702 may use the one or more TCI states, such as the list of TCI states, configured within/by the higher layer parameter (e.g., PDSCH-Config) to decode a PDSCH according to a detected PDCCH with DCI intended for the wireless device 1702 and a given cell (e.g., a given serving cell, a given non-serving/candidate/target cell). A number/quantity of TCI states in the list may depend on a wireless device capability parameter (e.g., maxNumberConfiguredTCIstatesPerCC). Each TCI state (e.g., TCI-State) may contain/comprise/include/indicate/have respective parameters for configuring a quasi co-location (QCL) relationship between one or more downlink reference signals and DM-RS port(s) of a PDSCH, a DM-RS port of a PDCCH, or CSI-RS port(s) of a CSI-RS resource. The QCL relationship may be configured by a higher layer parameter (e.g., qcl-Type1) for a first downlink reference signal of the one or more downlink reference signals. The QCL relationship may be configured by a higher layer parameter (e.g., qcl-Type2) for a second downlink reference signal of the one or more downlink reference signals. If/when at least two downlink reference signals comprising a first downlink reference signal and a second downlink reference signal are indicated by a TCI state, QCL types of the two downlink reference signals may not be the same, for example, regardless of whether the first downlink reference signal and the second downlink reference signal are the same or different. A QCL type corresponding to a downlink reference signal of the one or more downlink reference signals may be given by a higher layer parameter (e.g., qcl-Type) in a higher layer parameter (e.g., QCL-Info) and may correspond to one or more of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The one or more configuration parameters may comprise a higher layer parameter (e.g., dl-OrJointTCI-StateList). The higher layer parameter (e.g., dl-OrJointTCI-StateList) may be comprised in the higher layer parameter (e.g., PDSCH-Config). The higher layer parameter (e.g., dl-OrJointTCI-StateList) may comprise/indicate one or more TCI states, such as a list of TCI states (e.g., up to 128 TCI-State configurations). A TCI state in the list of TCI states may provide/indicate a reference signal for a QCL for: i) a DM-RS of a PDSCH, ii) a DM-RS of a PDCCH in a BWP/cell, and/or iii) a CSI-RS. A TCI state in the list of TCI states may provide/indicate a reference signal for determining an uplink transmission spatial filter for: i) a dynamic-grant PUSCH, ii) a configured-grant based PUSCH, iii) a PUCCH resource in a BWP/cell, and/or, iv) an SRS.

The one or more configuration parameters may comprise a higher layer parameter (e.g., ul-TCI-StateList). The higher layer parameter (e.g., ul-TCI-StateList) may be comprised in a higher layer parameter (e.g., BWP-UplinkDedicated). The higher layer parameter (e.g., ul-TCI-StateList) may comprise/indicate one or more uplink TCI (TCI-UL) states, such as a list of TCI-UL states (e.g., up to 64 TCI-UL state configurations). A TCI state (e.g., TCI-UL-State or a TCI state configuration) in the list of TCI states may provide/comprise a parameter for configuring a reference signal. The reference signal may be configured/indicated within/by the parameter for determining an uplink transmission spatial filter for: i) a dynamic-grant PUSCH, ii) a configured-grant based PUSCH, iii) a PUCCH resource in a BWP/cell, and/or, iv) an SRS.

The one or more configuration parameters sent (e.g., transmitted) at step 1706, by the base station 1704, may comprise configuration parameters for use by the wireless device 1702. The one or more configuration parameters may comprise configuration parameters for use, by the wireless device 1702, for one or more PUSCH transmissions to the base station 1704. The configuration parameters may comprise a higher layer parameter (e.g., applyIndicatedTCIState). The higher layer parameter (e.g., applyIndicatedTCIState) may be set to a value ‘first’ or a value ‘second’. The configuration parameters may be used by the wireless device 1702 for a PUSCH transmission, for example, at step 1712.

The one or more configuration parameters sent (e.g., transmitted) at step 1706, by the base station 1704, may comprise configuration parameters for use by the wireless device 1702. The one or more configuration parameters may comprise configuration parameters for use, by the wireless device 1702, for one or more configured uplink grants. The configuration parameters may comprise a higher layer parameter (e.g., applyIndicatedTCIState). The higher layer parameter (e.g., applyIndicatedTCIState) may be set to a value ‘first’, a value ‘second’, or a value ‘both’. The configuration parameters may be used by the wireless device 1702 for a configured uplink grant, for example, at step 1712.

The one or more configuration parameters sent (e.g., transmitted) at step 1706, by the base station 1704, may comprise configuration parameters for use/application by the wireless device 1702. The one or more configuration parameters may comprise configuration parameters for use/application, by the wireless device 1702, to one or more SRS resource sets. The configuration parameters may comprise a higher layer parameter (e.g., applyIndicatedTCIState). The higher layer parameter (e.g., applyIndicatedTCIState) may be set to a value ‘first’ or a value ‘second’. The configuration parameters may be used by the wireless device 1702 for an SRS resource, for example, at step 1712.

The one or more configuration parameters sent (e.g., transmitted) at step 1706, by the base station 1704, may comprise configuration parameters for use by the wireless device 1702. The one or more configuration parameters may comprise configuration parameters for use, by the wireless device 1702, for one or more PUCCH transmissions to the base station 1704. The configuration parameters may comprise a higher layer parameter (e.g., applyIndicatedTCIState). The higher layer parameter (e.g., applyIndicatedTCIState) may be set to a value ‘first’ or a value ‘second’. The configuration parameters may be used by the wireless device 1702 for a PUCCH transmission, for example, at step 1712.

The base station 1704 may send (e.g., transmit) a control/activation command (e.g., DCI, MAC-CE) to the wireless device 1702, as shown at step 1708 in FIG. 17. The control/activation command may indicate a first TCI state and a second TCI state of the list of TCI states. The first TCI state and/or the second TCI state may be a joint TCI state or an UL TCI state (e.g., a TCI-UL state), for example, depending on the list of TCI states (e.g., dl-OrJointTCI-StateList or ul-TCI-StateList) configured/indicated at step 1706. The control/activation command may comprise one or more TCI state(s) (e.g., TCI-State(s) or TCI-UL-State(s)), for example, indicating the first TCI state and the second TCI state.

The control/activation command may be used to map up to a number/quantity of TCI states and/or pairs of TCI states (e.g., up to 8 or any other quantity of TCI states and/or pairs of TCI states), with one TCI state for downlink channels/signals and/or one TCI state for uplink channels/signals, to codepoint(s) of a DCI field (e.g., ‘Transmission Configuration Indication’) for one cell or for a set of cells/downlink BWPs, and/or up to a number/quantity of sets of TCI states (e.g., up to 8 sets of TCI states or any other quantity of TCI states). Each set of the number/quantity of sets may be comprised of up to a number/quantity of TCI state(s) for downlink and uplink signals/channels (e.g., up to two TCI state(s)), or up to a number/quantity of TCI state(s) (e.g., up to two TCI state(s)) for downlink channels/signals and up to a number of TCI state(s) (e.g., up to two TCI state(s)) for uplink channels/signals to codepoint(s) of a DCI field (e.g., ‘Transmission Configuration Indication’) for one cell or for a set of cells/downlink BWPs, and if applicable, for one cell or for a set of cells/uplink BWPs. If/when a set of TCI state IDs are activated, by the activation command, for a set of cells/downlink BWPs and if applicable, for a set of cells/uplink BWPs, where the applicable list of cells may be determined, by the wireless device 1702, by an indicated cell in the activation command, the (same) set of TCI state IDs may be applied by the wireless device 1702 to/for all downlink and/or uplink BWPs in the indicated cells (or the applicable list of cells). If the activation command maps one or more parameters, such as TCI-State(s) and/or TCI-UL-State(s), to only one (or to a single) TCI codepoint, the wireless device 1702 may apply the (indicated) TCI-State(s) and/or TCI-UL-State(s) to one cell or to a set of cells/downlink BWPs, and if applicable, to one cell or to a set of cells/uplink BWPs after/if the indicated mapping for the one single TCI codepoint is applied by the wireless device 1702.

If/when the wireless device 1702 supports two TCI states in a codepoint of the DCI field ‘Transmission Configuration Indication’, the wireless device 1702 may receive an activation command (e.g., MAC-CE, DCI) that may be used to map up to 8 combinations (or any other quantity of combinations) of one or two TCI states to codepoint(s) of a DCI field (e.g., ‘Transmission Configuration Indication’). The wireless device 1702 may not expect to receive more than 8 TCI states in the activation command.

If/when a parameter (e.g., tci-PresentinDCI) of the one or more configuration parameters is set as ‘enabled’ or a parameter (e.g., tci-PresentDCI-1-2) of the one or more configuration parameters is configured for a CORESET, the DCI (e.g., DCI format 1_1/1_2) sent (e.g., transmitted) at step 1708 may provide/indicate one or more TCI state(s) (e.g., TCI-State(s) and/or TCI-UL-State(s)) for a cell or for all cells in a cell list configured by a simultaneous TCI update parameter (e.g., simultaneousU-TCI-UpdateList1, simultaneousU-TCI-UpdateList2, simultaneousU-TCI-UpdateList3, simultaneousU-TCI-UpdateList4). The DCI format may be with or without a downlink assignment. The simultaneous TCI update parameter may be a higher layer parameter (e.g., RRC parameter).

If/when the wireless device 1702 sends/transmits an uplink transmission (e.g., a PUCCH transmission, a PUSCH transmission) comprising a positive HARQ-ACK corresponding to the DCI providing/indicating the indicated TCI state(s) (e.g., TCI-State(s) and/or TCI-UL-State(s)), and if the indicated TCI State(s) is/are different from previously indicated TCI state(s), the indicated TCI-State(s) may be applied, by the wireless device 1702, starting from a first/starting/earliest slot that is at least a number/quantity of symbols after the last symbol of the uplink transmission. The first/starting/earliest slot and the number/quantity of symbols may be both determined, by the wireless device 1702, based on an active BWP with the smallest subcarrier spacing among BWP(s) of the cells applying the indicated TCI-State(s) that are active at the end of the uplink transmission carrying/with the positive HARQ-ACK. The number/quantity of symbols may be indicated/provided to the wireless device 1702 by RRC messages (e.g., one or more configuration parameters).

The base station 1704 may send (e.g., transmit) DCI to the wireless device 1702, as shown at step 1710 in FIG. 17. The DCI may indicate one or more TCI states of the one or more TCI states indicated by the control command (e.g., the first TCI state and the second TCI state).

The wireless device 1702 may send (e.g., transmit) an uplink transmission to the base station 1704, as shown at step 1712 in FIG. 17. The wireless device 1702 may send (e.g., transmit) the uplink transmission to the base station 1704, for example, based on (e.g., in response to) the DCI received at step 1710. The wireless device 1702 may send (e.g., transmit) the uplink transmission, for example, not based on (e.g., in response to) the DCI (i.e., the procedure 1700 may not comprise step 1710).

The DCI sent (e.g., transmitted) at step 1710 may be a DCI format 0_0. The DCI of DCI format 0_0 may schedule and/or activate a PUSCH transmission for the wireless device 1702. The wireless device 1702 may send (e.g., transmit) the PUSCH transmission for the uplink transmission at step 1712, for example, based on (e.g., in response to) the DCI format 0_0 scheduling and/or activating the PUSCH transmission for the wireless device 1702. The wireless device 1702 may use/apply the first TCI state indicated by the control/activation command for the PUSCH transmission.

The wireless device 1702 may be configured, by the base station 1704, with a configured grant Type 1 for a PUSCH transmission. The wireless device 1702 may be configured with a higher layer parameter (e.g., applyIndicatedTCIState) for one or more configured uplink grants. The wireless device 1702 may send (e.g., transmit) the PUSCH transmission for the uplink transmission, as shown at step 1712 in FIG. 17. The wireless device 1702 may use the higher layer parameter (e.g., applyIndicatedTCIState) for the PUSCH transmission as follows:
If the higher layer parameter applyIndicatedTCIState is set to ‘first’, the wireless device 1702 may apply the first TCI state to the PUSCH transmission. The wireless device 1702 may apply the first TCI state to each PUSCH transmission occasion of the PUSCH transmission.
If the higher layer parameter applyIndicatedTCIState is set to ‘second’, the wireless device 1702 may apply the second TCI state to the PUSCH transmission. The wireless device 1702 may apply the second TCI state to each PUSCH transmission occasion of the PUSCH transmission.
If the higher layer parameter applyIndicatedTCIState is set to ‘both’, the wireless device 1702 may apply both of the first TCI state and the second TCI state to the PUSCH transmission. The wireless device may apply:
   the first TCI state to PUSCH transmission occasion(s) or PUSCH antenna port(s), of the PUSCH transmission, associated with a first SRS resource set for codebook/non-codebook transmission, and
   the second TCI state to PUSCH transmission occasion(s) or PUSCH antenna port(s), of the PUSCH transmission, associated with a second SRS resource set for codebook/non-codebook transmission.
If the wireless device 1702 is configured/indicated, by the base station 1704, by a higher layer parameter PDCCH-Config that contains/comprises two different values of a higher layer parameter coresetPoolIndex in different ControlResourceSets, the first TCI state and the second TCI state may be specific to a higher layer parameter coresetPoolIndex with value 0 and a higher layer parameter coresetPoolIndex with value 1, respectively. If the wireless device 1702 is configured/indicated, by the base station 1704, by a higher layer parameter PDCCH-Config that contains/comprises two different values of a higher layer parameter coresetPoolIndex in different ControlResourceSets, the higher layer parameter applyIndicatedTCIState may not be set to ‘both’ indicating both of the two indicated TCI states to be applied for the PUSCH transmission.

The wireless device 1702 may be configured with two SRS resource sets. If/when two SRS resource sets are configured in a higher layer parameter srs-ResourceSetToAddModList or a higher layer parameter srs-ResourceSetToAddModListDCI-0-2 with a higher layer parameter usage in SRS-ResourceSet set to ‘codebook’ or ‘nonCodebook’ and a higher layer parameter enableSTx2PofmDCI is configured and a higher layer parameter PDCCH-Config contains/comprises two different values of coresetPoolIndex in a higher layer parameter ControlResourceSet for the active BWP of a serving cell,
two PUSCH transmissions that are fully/partially overlapping in time domain and are fully/partially/non-overlapping in frequency domain may be dynamically scheduled by UL grant(s) in DCI(s) and/or scheduled by configured grant(s) Type 1 or Type 2,
if dynamically scheduled by UL grant(s) in DCI(s) or activated by DCI(s) for configured grant Type 2, the DCI field SRS Resource Set Indicator may not be present in each PDCCH,
two PUSCH transmissions may be associated to different values of coresetPoolIndex where for configured grant Type 1, the association may be based on a higher layer parameter srs-ResourceSetId in a higher layer parameter rrc-ConfiguredUplinkG rant that indicates either the first SRS resource set or the second SRS resource set of the two SRS resource sets with usage ‘codebook’ or ‘nonCodeBook’ in the higher layer parameter srs-ResourceSetToAddModList or the higher layer parameter srs-ResourceSetToAddModListDCI-0-2,
the wireless device 1702 may not be expected to be configured with different number of SRS resources in the two SRS resource sets,
the wireless device 1702 may expect a higher layer parameter maxNrofPorts in PTRS-UplinkConfig to be configured as one if UL PT-RS is configured.

The one or more configuration parameters sent (e.g., transmitted) at step 1706, by the base station 1704, may comprise a higher layer parameter (e.g., rrc-ConfiguredUplinkGrant). The one or more configuration parameters may comprise a higher layer parameter (e.g., rrc-ConfiguredUplinkGrant), for example, that configures PUSCH transmission occasion(s) of a configured grant Type 1. If/when the wireless device 1702 is configured with a higher layer parameter (e.g., dl-OrJointTCI-StateList or TCI-UL-State), as described herein, and two SRS resource sets are configured (e.g., in a higher layer parameter srs-ResourceSetToAddModList or a higher layer parameter srs-ResourceSetToAddModListDCI-0-2 with a higher layer parameter usage in SRS-ResourceSet set to ‘codebook’ or ‘noncodebook’), and a higher layer parameter multipanelScheme is set to ‘SDMscheme’ or ‘SFNscheme’, and the higher layer parameter rrc-ConfiguredUplinkGrant of the configured grant Type 1 does not contain srs-ResourceIndicator2 or precodingAndNumberOfLayers2, PUSCH transmission occasion(s) of the configured grant Type 1 may be associated with the first SRS resource set of the two SRS resource sets if the first TCI state (indicated in the control/activation command) applies to the configured grant Type 1 (e.g., if/when the higher layer parameter applyIndicatedTCIState=‘first’) and may be associated with the second SRS resource set of the two SRS resource sets if the second TCI state (indicated in the control/activation command) applies to the configured grant Type 1 (e.g., if/when the higher layer parameter applylndicatedTCIState=‘second’).

The DCI sent (e.g., transmitted) at step 1710, by the base station 1704, may be a DCI format 0_1 or a DCI format 0_2. The DCI may be a DCI format format 0_1 or a DCI format 0_2, for example, that schedules or activates PUSCH transmission occasion(s). If/when the wireless device 1702 is configured with the higher layer parameter (e.g., dl-OrJointTCI-StateList or TCI-UL-State) and has the first TCI state (e.g., the first indicated/activated TCI state) and the second TCI state (e.g., the second indicated/activated TCI state), and only one SRS resource set is configured in a higher layer parameter srs-ResourceSetToAddModList or a higher layer parameter srs-ResourceSetToAddModListDCI-0-2 with a higher layer parameter usage in SRS-ResourceSet set to ‘codebook’ or ‘noncodebook’, the PUSCH transmission occasion(s) scheduled or activated by the DCI at step 1710 may be associated with the first TCI state or may be associated with the second TCI state, as indicated by a higher layer parameter applyIndicatedTCIState configured by a higher layer parameter PUSCH-Config. If/when the higher layer parameter applyIndicatedTCIState is set to ‘first’, the wireless device 1702 may send/transmit, in/via the scheduled/activated PUSCH transmission occasion(s), a PUSCH transmission (or repetitions of a PUSCH transmission) using the first TCI state. If/when the higher layer parameter applyIndicatedTCIState is set to ‘second’, the wireless device 1702 may send/transmit at step 1712 for the uplink transmission, in/via the PUSCH transmission occasion(s), a PUSCH transmission (or repetitions of a PUSCH transmission) using the second TCI state. The higher layer parameter applyIndicatedTCIState may indicate if the wireless device 1702 applies the first or the second “indicated” UL TCI state or joint TCI state for a PUSCH transmission, for example, scheduled or activated by DCI format 0_1 or 0_2. The higher layer parameter applyIndicatedTCIState may indicate if the wireless device 1702 applies the first or the second “indicated” UL TCI state or joint TCI state for a PUSCH transmission scheduled or activated by DCI format 0_1/0_2, for example, if/when an SRS resource set indicator field is not present (or is absent) in DCI format 0_1/0_2.

If/when the wireless device 1702 is configured with a higher layer parameter enableSTx2PofmDCI and a higher later parameter PDCCH-Config contains two different values of coresetPoolIndex in ControlResourceSet for the active BWP of a serving cell, the wireless device 1702 may be expected to be configured with two SRS resource sets with a higher layer parameter usage set to ‘codebook’ or ‘nonCodeBook’ in a higher layer parameter srs-ResourceSetToAddModList. If the wireless device 1702 is configured to monitor DCI format 0_2 and there is only one SRS resource set configured by a higher layer parameter srs-ResourceSetToAddModListDCI-0-2 and associated with a higher layer parameter usage set to ‘codebook’ or ‘nonCodeBook’, the wireless device 1702 may monitor only coresetPoolIndex configured with value 0 for detection of DCI format 0_2. The higher layer parameter enableSTx2PofmDCI may be (or may be interchangeably used with) a higher layer parameter stx2-Panel.

The higher layer parameter enableSTx2PofmDCI may enable PUSCH+PUSCH multiple panel simultaneous uplink transmission in multi-DCI based multi-transmission and reception point (mTRP) system (e.g., each TRP may send/transmit DCI scheduling a PDSCH/PUSCH/SRS transmission). If/when the higher layer parameter enableSTx2PofmDCI is configured, two coresetPoolIndex values are configured and two SRS resource sets for codebook or non-codebook are configured, the multi-DCI based STxMP PUSCH+PUSCH may be configured.

The one or more configuration parameters at step 1706 may comprise a higher layer parameter (e.g., multipanelScheme). If/when the higher layer parameter multipanelScheme is set to ‘SDMScheme’ and two SRS resource sets are configured/indicated by the base station 1704 (e.g., in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’), two SRS resource indicators (SRIs) and two sent (e.g., transmitted) precoding matrix indicators (TPMIs) may be given/provided/indicated by two SRS resource indicator fields and two Precoding-information-and-number-of-layers fields for/in a DCI format 0_1 and a DCI format 0_2 (e.g., in the DCI sent (e.g., transmitted) at step 1710):
If/when codepoint “10” of SRS Resource Set indicator is indicated in the DCI format 0_1/0_2:
   a first TPMI of the two TPMIs may indicate a transmission precoder for the uplink transmission to be applied over layers {0 . . . v₁-1}, where v₁ is a number of layers indicated by the first TPMI, that corresponds to an SRS resource selected by a first SRI of the two SRSs if/when multiple SRS resources are configured for a first SRS resource set or if single SRS resource is configured for the first SRS resource set, and
   a second TPMI of the two TPMIs may indicate a transmission precoder for the uplink transmission to be applied over layers {v₁ . . . v₂+v₁−1}, where v₂ is a number of layers indicated by the second TPMI, that corresponds to an SRS resource selected by a second SRI of the two SRIs if/when multiple SRS resources are configured for a second SRS resource set or if single SRS resource is configured for the second SRS resource set, v₁≤maxRankSdm and v₂≤maxRankSdm or maxRankSdmDCI-0-2 and maxRankSdm or maxRankSdmDCI-0-2 may define the maximum number of layers applied over the first SRS resource set and the second SRS resource sets, separately.
If/when codepoint “00” or “01” of SRS Resource Set indicator is indicated in the DCI format 0_1/0_2, the second SRI and second TPMI may be reserved, and the first TPMI may indicate a precoder to be applied over layers {0 . . . v−1}, where v≤maxRank, where maxRank may define the maximum number of layers.
Codepoint “11” of SRS Resource Set indicator in the DCI format 0_1/0_2 may be reserved.

For one or two TPMIs, the transmission precoder may be selected from an uplink codebook that has a number of antenna ports equal to a higher layer parameter nrofSRS-Ports in a higher layer parameter SRS-Config for the indicated SRI(s). If/when two TPMIs are indicated, the wireless device 1702 may expect/determine that the precoder indicated by the first TPMI and the precoder indicated by the second TPMI are mapped to different PUSCH antenna ports.

If/when two SRIs are indicated, the wireless device 1702 may expect/determine that the number of SRS antenna ports associated with two indicated SRIs is the same. If/when the wireless device 1702 is configured/indicated with a higher layer parameter txConfig set to ‘codebook’, the wireless device 1702 may be configured/indicated with at least one SRS resource. Each of the indicated one or two SRIs in slot n may be associated with the most recent transmission of an SRS resource, in associated SRS resource set, identified by an SRI of the two SRIs, where the SRS resource is prior to a PDCCH reception with the DCI format 0_1/0_2 carrying the SRI. If/When two SRS resource sets are configured/indicated in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’, the wireless device 1702 may not be expected to be configured with a different number of SRS resources in the two SRS resource sets.

If/when the higher layer parameter multipanelScheme is set to ‘SFNScheme’ and two SRS resource sets are configured/indicated, by the base station 1704, in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’, two SRIs and two TPMIs may be given/provided/indicated by two SRS resource indicator fields and two Precoding-information-and-number-of-layers fields for/in a DCI format 0_1 and a DCI format 0_2 (e.g., in the DCI sent (e.g., transmitted) at step 1710):
If/when codepoint “10” of SRS Resource Set indicator is indicated in the DCI format 0_1/0_2 (e.g., in the DCI sent (e.g., transmitted) at step 1710):
   a first TPMI of the two TPMIs may indicate a transmission precoder to be applied over layers {0 . . . v−1}, and a second TPMI of the two TPMIs may indicate a transmission precoder to be applied over layers {0 . . . v−1}, where v≤maxRankSfn or maxRankSfnDCI-0-2 and maxRankSfn or maxRankSfnDCI-0-2 may define the maximum number of layers applied over the first SRS resource set and the second SRS resource sets, separately.
If/when codepoint “00” or “01” of SRS Resource Set indicator is indicated in the DCI format 0_1/0_2, the second SRI and second TPMI may be reserved, and the first TPMI may indicate a precoder to be applied over layers {0 . . . v−1}, where v≤maxRank, where maxRank may define the maximum number of layers.
Codepoint “11” of SRS Resource Set indicator in the DCI format 0_1/0_2 may be reserved.
For one or two TPMIs, the transmission precoder may be selected from an uplink codebook that has a number of antenna ports equal to a higher layer parameter nrofSRS-Ports in a higher layer parameter SRS-Config for the indicated SRI(s). If/when two TPMIs are indicated, the wireless device may expect/determine that the precoder indicated by the first TPMI and the precoder indicated by the second TPMI are mapped to different PUSCH antenna ports.
If/when two SRIs are indicated, the wireless device 1702 may expect/determine that the number/quantity of SRS antenna ports associated with two indicated SRIs is the same. If/when the wireless device 1702 is configured/indicated with a higher layer parameter txConfig set to ‘codebook’, the wireless device 1702 may be configured/indicated with at least one SRS resource. Each of the indicated one or two SRIs in slot n may be associated with the most recent transmission of an SRS resource, in associated SRS resource set, identified by an SRI of the two SRIs, where the SRS resource is prior to a PDCCH reception with the DCI format 0_1/0_2 carrying the SRI. If/when two SRS resource sets are configured/indicated in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’, the wireless device 1702 may not be expected to be configured with a different number of SRS resources in the two SRS resource sets.

If/when the higher layer parameter multipanelScheme is set to ‘SDMScheme’ and two SRS resource sets are configured/indicated, by the base station 1704, in a higher layer parameter srs-ResourceSetToAddModList or a higher layer parameter srs-ResourceSetToAddModListDCI-0-2 with a higher layer parameter usage in a higher layer parameter SRS-ResourceSet set to ‘nonCodebook’, two SRIs may be given/provided/indicated by two SRS resource indicator fields for/in a DCI format 0_1 and a DCI format 0_2 (e.g., in the DCI sent (e.g., transmitted) at step 1710):
If/when codepoint “10” of SRS Resource Set indicator is indicated in the DCI format 0_1/0_2:
   a first SRI of the two SRIs may indicate resource(s) to be associated with layers {0 . . . v₁−1}, where v₁ is a number of layers indicated by the first SRI and a second SRI of the two SRIs may indicate resource(s) to be associated with layers {v₁ . . . v₂+v₁−1}, v₁≤Lₘₐₓ and v₂≤Lₘₐₓ. The wireless device may expect that SRS resource(s) indicated by the first SRI and SRS resource(s) indicated by the second SRI are corresponding to different PUSCH antenna ports.
If/when codepoint “00” or “01” of SRS Resource Set indicator is indicated in the DCI format 0_1/0_2, the second SRI may be reserved, and the first SRI may indicate resource(s) associated with layers {0 . . . v−1}, where v≤Lₘₐₓ.

If/when the higher layer parameter multipanelScheme is set to ‘SFNScheme’ and two SRS resource sets are configured/indicated, by the base station 1704, in a higher layer parameter srs-ResourceSetToAddModList or a higher layer parameter srs-ResourceSetToAddModListDCI-0-2 with a higher layer parameter usage in a higher layer parameter SRS-ResourceSet set to ‘nonCodebook’, two SRIs may be given/provided/indicated by two SRS resource indicator fields for/in a DCI format 0_1 and a DCI format 0_2 (e.g., in the DCI sent (e.g., transmitted) at step 1710):
If/when codepoint “10” of SRS Resource Set indicator is indicated in the DCI format 0_1/0_2:
   a first SRI of the two SRIs may indicate resource(s) to be associated with layers {0 . . . v−1} and a second SRI of the two SRIs may indicate resource(s) to be associated with layers {0 . . . v−1}, v≤Lₘₐₓ. The wireless device may expect that SRS resource(s) indicated by the first SRI and SRS resource(s) indicated by the second SRI are corresponding to different PUSCH antenna ports.
If/when codepoint “00” or “01” of SRS Resource Set indicator is indicated in the DCI format 0_1/0_2, the second SRI may be reserved, and the first SRI may indicate resource(s) associated with layers {0 . . . v−1}, where v≤Lₘₐₓ. If/when two SRIs are indicated, the wireless device 1702 may expect/determine that the number/quantity of SRS antenna ports associated with two indicated SRIs to be the same.
If/when the wireless device 1702 is configured/indicated with a higher layer parameter txConfig set to ‘nonCodebook’, the wireless device 1702 may be configured/indicated with at least one SRS resource. Each of the indicated one or two SRIs in slot n may be associated with the most recent transmission of an SRS resource, in associated SRS resource set, identified by an SRI of the two SRIs, where the SRS resource is prior to a PDCCH reception with the DCI format 0_1/0_2 carrying the SRI. If/when two SRS resource sets are configured/indicated in a higher layer parameter srs-ResourceSetToAddModList or a higher layer parameter srs-ResourceSetToAddModListDCI-0-2 with a higher layer parameter usage in a higher layer parameter SRS-ResourceSet set to ‘nonCodebook’, the wireless device 1702 may not be expected to be configured with a different number/quantity of SRS resources in the two SRS resource sets.

The DCI sent (e.g., transmitted) at step 1710 by the base station 1704 may be a DCI format 0_1 or a DCI format 0_2. The DCI may be a DCI format 0_1 or a DCI format 0_2, for example, that schedules/activates PUSCH transmission occasion(s). If/when the wireless device 1702 is configured/indicated, by the base station 1704, with the higher layer parameter (e.g., dl-OrJointTCI-StateList) or the higher layer parameter (e.g., TCI-UL-State) and has the first TCI state (e.g., the first indicated/activated TCI state) and the second TCI state (e.g., the second indicated/activated TCI state), and two SRS resource sets are configured/indicated, by the base station 1704, in a higher layer parameter srs-ResourceSetToAddModList or a higher layer parameter srs-ResourceSetToAddModListDCI-0-2 with a higher layer parameter usage in a higher layer parameter SRS-ResourceSet set to ‘codebook’ or ‘nonCodebook’, for a PUSCH repetition Type A or Type B, or for a PUSCH transmission when the higher layer parameter multipanelScheme is set to ‘SDMscheme’ or ‘SFNscheme’, the association of the first TCI state and the second TCI state to PUSCH transmission occasions or to corresponding PUSCH antenna ports may be determined as follows:
if the DCI format 0_1 or the DCI format 0_2 indicates codepoint “00” or “01” for an SRS resource set indicator, the first TCI state or the second TCI state may be applied, by the wireless device 1702, to all PUSCH transmission occasions, respectively.
if the DCI format 0_1 or the DCI format 0_2 indicates codepoint “10” or “11” for an SRS resource set indicator, and the higher layer parameter multipanelScheme is not configured,
   the first TCI state may be applied, by the wireless device 1702, to PUSCH transmission occasion(s) associated with a first SRS resource set of the two SRS resource sets and the second TCI state may be applied to PUSCH transmission occasion(s) associated with a second SRS resource set of the SRS resource sets, where the association of PUSCH transmission occasions to the two SRS resource sets may be determined based on whether a higher layer parameter cyclicMapping or a higher layer parameter sequentialMapping in a higher layer parameter PUSCH-Config is enabled.
if the DCI format 0_1 or the DCI format 0_2 indicates codepoint “10” for an SRS resource set indicator and the higher layer parameters multipanelScheme is configured and set to ‘SDMscheme’ or ‘SFNscheme’,
   the first TCI state may be applied, by the wireless device 1702, to first PUSCH antenna port(s), of a PUSCH transmission occasion, associated with the first SRS resource set, and the second TCI state may be applied, by the wireless device 1702, to second PUSCH antenna port(s), of the PUSCH transmission occasion, associated with the second SRS resource set. The first PUSCH antenna port(s) and the second PUSCH antenna port(s) may be the same or different.

The DCI sent (e.g., transmitted) at step 1710 may schedule a PUSCH transmission. The DCI sent (e.g., transmitted) at step 1710 may comprise an SRS Resource Set Indicator field. The wireless device 1702 may send (e.g., transmit) the PUSCH transmission for the uplink transmission at step 1712, for example, based on (e.g., in response to) the DCI sent (e.g., transmitted) at step 1710. The wireless device 1702 may use/apply a TCI state indicated by the SRS Resource Set Indicator field for the PUSCH transmission.

If/when the wireless device 1702 sends (e.g., transmits) repetitions of a PUSCH transmission over/across K slots (e.g., K consecutive slots) and K=2, the first SRS resource set and the second SRS resource set may be used/applied, by the wireless device 1702 and/or the base station 1704, to a first slot and a second slot of 2 slots, respectively.

If/when the wireless device 1702 sends (e.g., transmits) repetitions of a PUSCH transmission over/across K slots (e.g., K consecutive slots)>2 slots, and if/when the higher layer parameter mappingPattern=‘cyclicMapping’, the first SRS resource set and the second SRS resource set may be used/applied, by the wireless device 1702 and/or the base station 1704, to a first slot and a second slot of the K slots, respectively, and the same SRS resource set mapping pattern may continue to remaining slots of the K slots.

If/when the wireless device 1702 sends (e.g., transmits) repetitions of a PUSCH transmission over/across K slots (e.g., K consecutive slots)>2 slots, and if/when the higher layer parameter mappingPattern=‘sequentialMapping’, the first SRS resource set may be used/applied, by the wireless device 1702 and/or the base station 1704, to a first slot and a second slot of the K slots, and the second SRS resource set may be used/applied, by the wireless device 1702 and/or the base station 1704, to a third slot and a fourth slot of the K slots, and the same SRS resource set mapping pattern may continue to remaining slots of the K slots.

The one or more configuration parameters sent (e.g., transmitted) at step 1706 by the base station 1704 may comprise configuration parameters for use by the wireless device 1702. The one or more configuration parameters may comprise configuration parameters for use by the wireless device 1702, for example, to one or more SRS resource sets. The configuration parameters may comprise a higher layer parameter (e.g., applyIndicatedTCIState). If/when the wireless device 1702 is configured/indicated/provided with the higher layer parameter (e.g., dl-OrJointTCI-StateList) or the higher layer parameter (e.g., TCI-UL-State) and has the first TCI state and the second TCI state indicated/activated as described herein, the higher layer parameter (e.g., applyIndicatedTCIState) may indicate whether/if the wireless device 1702 uses/applies the first TCI state or the second TCI state to the one or more SRS resource sets. The one or more SRS resource sets may comprise a periodic, a semi-persistent or an aperiodic SRS resource set with a higher layer parameter usage in a higher layer parameter SRS-ResourceSet set to ‘codebook’, ‘nonCodebook’ or ‘antennaSwitching’ or an aperiodic SRS resource set with a higher layer parameter usage in a higher layer parameter SRS-ResourceSet set to ‘beamManagement’. If/when the wireless device 1702 is configured/indicated/provided by a higher layer parameter (e.g., PDCCH-Config) that comprises two different values of a higher layer parameter (e.g., coresetPoolIndex) in a higher layer parameter (e.g., ControlResourceSet), the first TCI state and the second TCI state correspond to the indicated TCI states (or uplink TCI states) specific to the higher layer parameter (e.g., coresetPoolIndex) with value 0 and the higher layer parameter (e.g., coresetPoolIndex) with value 1, respectively.

If/when two SRS resource sets comprising a first SRS resource set and a second SRS resource with a higher layer parameter usage in a higher layer parameter SRS-ResourceSet set to ‘codebook’ or ‘nonCodebook’ are configured/indicated/provided, the wireless device 1702 may not expect that the first TCI state be used/applied to the second SRS resource set and that the second TCI state be used/applied to the first SRS resource set.

The configuration parameters may not comprise the higher layer parameter (e.g., applyIndicatedTCIState) for the one or more SRS resource sets. If/when the wireless device 1702 is configured/indicated/provided by/with a higher layer parameter (e.g., PDCCH-Config) that contains/comprises two different values of a higher layer parameter (e.g., coresetPoolIndex) in n a higher layer parameter (e.g., ControlResourceSet), and is not configured/indicated/provided with the higher layer parameter (e.g., applyIndicatedTCIState) for an aperiodic SRS resource set, if the aperiodic SRS resource set is triggered by a PDCCH on a CORESET associated with a coresetPoolIndex value, the wireless device 1702 may use/apply, to the aperiodic SRS resource set, an indicated TCI state (or uplink TCI state) specific to the coresetPoolIndex value.

The one or more configuration parameters sent (e.g., transmitted) at step 1706 by the base station 1704 may comprise configuration parameters for use by the wireless device 1702. The one or more configuration parameters may comprise configuration parameters for use by the wireless device 1702, for example, for one or more PUCCH transmission(s) to the base station 1704. The configuration parameters may comprise a higher layer parameter (e.g., applyIndicatedTCIState). The higher layer parameter (e.g., applyIndicatedTCIState) may indicate whether/if the wireless device 1702 uses/applies the first TCI state, the second TCI state, or both to a PUCCH resource. If the higher layer parameter (e.g., applyIndicatedTCIState) is set to ‘first’, the wireless device 1702 may send (e.g., transmit) for the uplink transmission at step 1712, via the PUCCH resource, a PUCCH transmission with/using a spatial domain filter corresponding to the first TCI state. If the higher layer parameter (e.g., applyIndicatedTCIState) is set to ‘second’, the wireless device 1702 may send (e.g., transmit) for the uplink transmission at step 1712, via the PUCCH resource, a PUCCH transmission with/using a spatial domain filter corresponding to the second TCI state. If the higher layer parameter (e.g., applyIndicatedTCIState) is set to ‘both’, the wireless device 1702 may send (e.g., transmit) for the uplink transmission at step 1712, via the PUCCH resource, a PUCCH transmission with/using a spatial domain filter corresponding to the first TCI state and a spatial domain filter corresponding to the second TCI state.

If the wireless device 1702:
is not provided with a higher layer parameter coresetPoolIndex or is provided with a higher layer parameter coresetPoolIndex with a value of 0 for first CORESETs on an active downlink BWP of a cell, and
is provided with a higher layer parameter coresetPoolIndex with a value of 1 for second CORESETs on the active downlink BWP of the cell,
   the first TCI state and the second TCI state may be specific to the first CORESETs (or to the higher layer parameter coresetPoolIndex with a value of 0) and the second CORESETs (or to the higher layer parameter coresetPoolIndex with a value of 1), respectively.

The wireless device 1702 may be indicated/configured by the base station 1704. The wireless device 1702 may be indicated/configured by the base station 1704, for example, to send (e.g., transmit) a PUCCH transmission over a number of/quantity of slots

$$( e . g . , {N}_{PUCCH}^{repeat} slots )$$

using/via a PUCCH resource. If the PUCCH resource is indicated by a DCI format (e.g., via the DCI sent (e.g., transmitted) by the base station 1704 at step 1710) and the PUCCH resource comprises (or is configured with) a higher layer parameter (e.g., pucch-RepetitionNrofSlots), the number of/quantity of slots may be indicated/configured by the higher layer parameter (e.g., pucch-RepetitionNrofSlots). If the PUCCH resource is not indicated by a DCI format or the PUCCH resource does not comprise (or is not configured with) the higher layer parameter (e.g., pucch-RepetitionNrofSlots), the number of/quantity of slots may be indicated by a higher layer parameter (e.g., nrofSlots).

If/when a PUCCH resource used for repetitions of a PUCCH transmission by the wireless device 1702 comprises a first TCI state and a second TCI state (e.g., applyIndicatedTCIState=‘both’) and the wireless device 1702 is not provided a higher layer parameter (e.g., multipanelSfnScheme):
if/when the number of/quantity of slots

$$( e . g . , {N}_{PUCCH}^{repeat} slots )$$

is equal to two, the wireless device 1702 may use the first TCI state and the second TCI state for first and second repetitions of the PUCCH transmission, respectively,
if a higher layer parameter mappingPattern=‘cyclicMapping’, the wireless device 1702 may alternate between the first TCI state and the second TCI state per

$${N}_{PUCCH}^{switch}$$

repetitions of the PUCCH transmission, where

$${N}_{PUCCH}^{switch} = 1 ,$$

else, if a higher layer parameter mappingPattern=‘sequentialMapping’, the wireless device 1702 may alternate between the first TCI state and the second TCI state per

$${N}_{PUCCH}^{switch}$$

repetitions of the PUCCH transmission, where

$${N}_{PUCCH}^{switch} = 2.$$

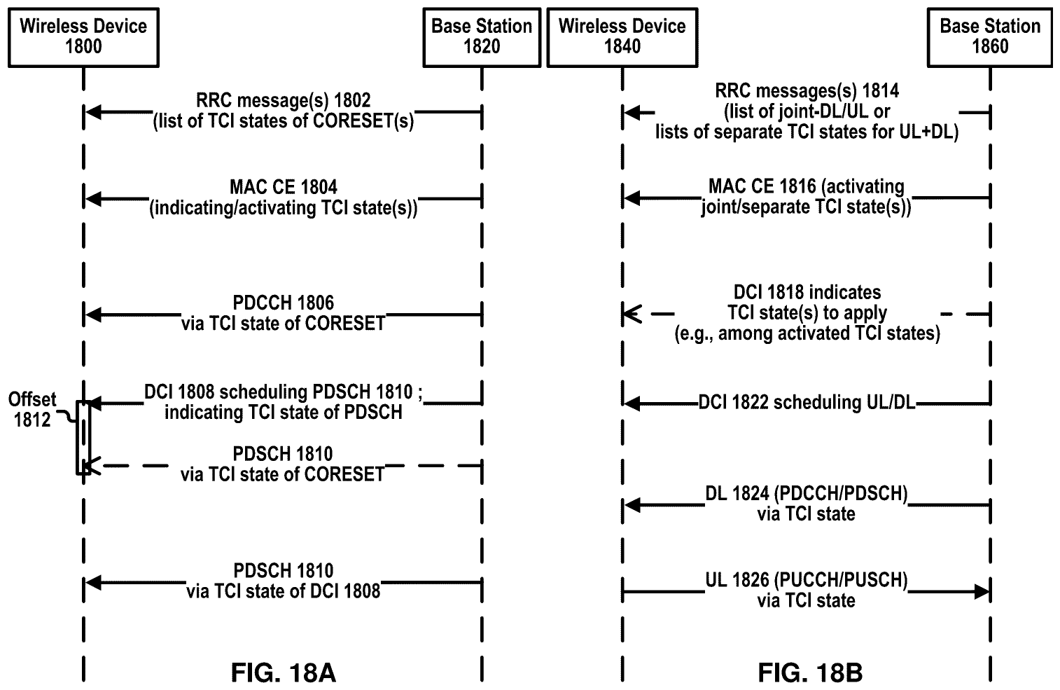

FIG. 18A and FIG. 18B show examples of TCI state indication. A wireless device 1800 may receive, from a base station 1820, channel-specific beam indications for separate downlink physical channels (e.g., a PDCCH and a PDSCH), as shown in FIG. 18A. A wireless device 1840 may receive, from a base station 1860, beam indications applicable (e.g., jointly applicable) to multiple physical channels (i.e., common among physical channels), for example, one or more TCI states for downlink receptions and/or uplink transmissions, as shown in FIG. 18B. Using a TCI state for multiple physical channels (e.g., as shown in FIG. 18B) may be referred to as a unified TCI framework.

The wireless device 1800 may receive one or more RRC messages 1802 from the base station 1820, as shown in FIG. 18A. The one or more RRC messages 1802 may indicate one or more TCI states for one or more CORESETs. The one or more RRC messages 1802 may, for example, comprise a list of TCI states (e.g., a list of IDs of TCI states) for CORESETs of the wireless device 1800.

Each TCI state of the one or more TCI states (or the list of TCI states) may indicate one or more reference signals. Each TCI state of the one or more TCI states (or the list of TCI states) may, for example, comprise one or more IDs of the one or more reference signals. The one or more reference signals of a TCI state may be used for channel estimation (e.g., comprising beam determination), for example, such that a signal that is quasi co-located (QCL'd) with a reference signal (e.g., of the one or more reference signals) of the TCI state may experience/comprise channel conditions (e.g., distortions) and properties that are the same as the reference signal of the TCI state, and, therefore, the effects of a channel on the signal may be inferred from the effects of the channel on the reference signal as the reference signal is a known sequence (e.g., a pilot signal).

A TCI state may indicate which large-scale channel properties may be inferred from a QCL association between a signal and a reference signal of the TCI state. Each reference signal of the one or more reference signals of a TCI state may be associated with a QCL type. The QCL type may correspond to one or more of the following values: QCL-Type A, QCL-Type B, QCL-Type C, and/or QCL-Type D. QCL-Type A may be used to estimate one or more of a Doppler shift, a Doppler spread, an average delay, and/or a delay spread. QCL-Type B may be used to estimate a Doppler shift and/or a Doppler spread. QCL-Type C may be used to estimate an average delay and/or a Doppler shift. QCL-Type D may be used for one or more spatial domain parameters (e.g., one or more parameters for spatial domain reception filters used to receive downlink signals).

A reference signal of a TCI state with a QCL type of QCL-Type D may be used for beam determination. If/when a signal is QCL'd with a reference signal of a TCI state with a QCL type of QCL-Type D, the wireless device 1800 may determine (e.g., assume and/or infer) that the base station 1820 uses/applies a same spatial (domain) filter to both the signal and the reference signal of the TCI state. The wireless device 1800 may use/apply a spatial domain (reception) filter suitable (e.g., able and/or capable) to receive the signal, for example, based on being able to determine (e.g., assume and/or infer), from the spatial (domain) filter applied to the QCL'd reference signal, the spatial domain (transmission) filter used/applied by the base station 1820 to the signal.

The wireless device 1800 may receive one or more RRC messages 1802, as shown in FIG. 18A. The one or more RRC messages 1802 may indicate one or more TCI states. The one or more RRC messages 1802 may, for example, comprise a list of TCI states of a CORESET (e.g., a list of IDs of TCI states). The wireless device 1800 may use the TCI states in the list of TCI states for receiving PDCCHs on the CORESETs. The TCI states indicated by the one or more RRC messages 1802 may be referred to as configured TCI states or RRC-configured TCI states.

The wireless device 1800 may receive a MAC CE 1804 from the base station 1820, as shown in FIG. 18A. The MAC CE 1804 may indicate (or activate) one or more TCI states configured by the one or more RRC messages 1802. The MAC CE 1804 may, for example, indicate a TCI state (e.g., a single TCI state) for the one or more CORESETs (e.g., for PDCCH receptions via the one or more CORESETs). The MAC CE 1804 may, for example, activate a plurality of TCI states that may be used/applied for PDCCH receptions via CORESETs. The TCI states indicated by the MAC CE 1804 may be referred to as activated TCI states or MAC-CE activated TCI states.

The wireless device 1800 may determine one or more spatial (domain) filter parameters. The wireless device 1800 may determine one or more spatial (domain) filter parameters, for example, based on a reference signal of the TCI state. The wireless device 1800 may receive the PDCCH 1806, of a CORESET, via a TCI state of the CORESET, as shown in FIG. 18A.

DCI may be used to indicate a TCI state for PDSCH reception. The DCI may be used to indicate which TCI state, among the (MAC-CE) activated TCI states (e.g., for the CORESETs), the wireless device 1800 is to use/apply for receiving PDSCH receptions (e.g., data, transport blocks, code block groups of a transport block). The wireless device 1800 may receive DCI 1808, as shown in FIG. 18A. The DCI 1808 may schedule a PDSCH transmission (e.g., PDSCH 1810). The DCI 1808 may indicate which TCI state, among the activated TCI states, the wireless device 1800 is to use/apply for receiving the PDSCH transmission (e.g., the PDSCH 1810). A TCI state indicated by the DCI 1808 may be referred to as an indicated TCI state. A TCI state indicated by the MAC CE 1804 that indicates a single TCI state may be referred to as an indicated TCI state.

The DCI 1808 may indicate a TCI state for receiving the scheduled PDSCH reception. The wireless device 1800 may use/apply a different TCI state, for example, depending on an offset (e.g., in scheduling) between receiving the DCI 1808 and a PDSCH reception 1810. The DCI 1808 may schedule the PDSCH reception 1810, for example, within an offset 1812. The offset 1812 may be referred to as a scheduling offset. The offset 1812 may be a duration or a number of/quantity of symbols. The offset 1812 may be based on a wireless device-capability (e.g., UE-capability) of the wireless device 1800.

The wireless device 1800 may use/apply the TCI state of the CORESET. The wireless device 1800 may use/apply the TCI state of the CORESET, for example, based on the base station 1820 scheduling, via the DCI 1808, the PDSCH reception 1810 within the offset 1812. The wireless device 1800 may use/apply the TCI state used to receive the PDCCH 1806 (e.g., and may not use/apply the TCI state indicated by the DCI 1808 for receiving the PDSCH reception 1810).

The wireless device 1800 may be unable to (successfully) decode the DCI 1808, update the spatial filtering, and/or retune RF chains in time for receiving the PDSCH reception 1810. The wireless device 1800 may be unable to (successfully) decode the DCI 1808, update the spatial filtering, and/or retune RF chains in time for receiving the PDSCH reception 1810, for example, within the offset 1812. The wireless device 1800 may receive the PDSCH reception 1810 within the offset 1812, for example, based on using the TCI state of the CORESET used to receive the PDCCH 1806 (e.g., instead of the TCI state indicated in the DCI 1808 for receiving the PDSCH reception 1810).

The wireless device 1800 may apply the TCI state indicated by the DCI 1808 for receiving the PDSCH reception 1810. The wireless device 1800 may apply the TCI state indicated by the DCI 1808 for receiving the PDSCH reception 1810, for example, if/when the PDSCH 1810 is scheduled after or in response to the offset 1812. The wireless device 1800 may receive, from the base station 1820, the PDSCH reception 1810 via the TCI state indicated by the DCI 1808, as shown in FIG. 18A. The wireless device 1800 may apply the TCI state of the CORESET for the PDSCH reception 1810, for example, based on (e.g., in response to) the DCI 1808 not comprising a field indicating a TCI state (e.g., any TCI state) for the PDSCH reception 1810. The DCI 1808 may not comprise a field indicating a TCI state (e.g., any TCI state), for example, based on a DCI format of the DCI 1808 (e.g., a DCI format DCI 1_0).

A base station may send (e.g., transmit) beam indications to physical channels (e.g., the PDCCH and the PDSCH). The base station 1820 may send (e.g., transmit) separate beam indications for the PDCCH, the PDSCH, and/or for each PDSCH transmission, as shown in FIG. 18A. The base station 1860 may send (e.g., transmit) beam indications applicable (e.g., jointly applicable) to multiple physical channels (i.e., common among physical channels) for one or more TCI states, as shown in FIG. 18B. A TCI state used for multiple physical channels (e.g., as shown in FIG. 18B) may be referred to as a unified TCI state framework. A single TCI state (or a set of TCI states) may be indicated for each downlink physical channel (e.g., a single TCI state for both PDCCH transmissions and PDSCH transmission), for example, under the unified TCI state framework. A TCI state that is applied to both the PDCCH and the PDSCH may be referred to as a downlink TCI state or a joint-downlink TCI state. A joint TCI state may refer to a TCI state being jointly applied to different physical channels. The network may indicate a TCI state (or a set of TCI states) for each of the uplink physical channels (e.g., a single TCI state for both PUCCH transmissions and PUSCH transmissions), for example, for uplink beam indications under the unified TCI state framework. A TCI state that is applied to both the PUCCH and the PUSCH may be referred to as an uplink TCI state or a joint-uplink TCI state.

The unified TCI state framework may be used to indicate a single TCI state (or a set of TCI states) for both downlink and uplink. The unified TCI state framework may be used to indicate a single TCI state (or a set of TCI states) for both downlink and uplink, for example, in addition to providing TCI states that are jointly used/applied to each of the physical channels in the downlink or the uplink. The TCI state may be used for each of the physical channels of the downlink and the uplink, for example, the PDCCH, the PDSCH, the PUCCH, and/or the PUSCH. A TCI state applicable to both downlink and uplink may be referred to as a joint TCI state, a joint DL/UL TCI state, and/or a common TCI state. A TCI state applicable to the unified TCI state framework may be referred to as a unified TCI state.

The wireless device 1840 may receive, from the base station 1860, one or more RRC messages 1814, as shown in FIG. 18B. The one or more RRC messages 1814 may indicate a plurality of TCI states. The plurality of TCI states may be a plurality of unified TCI states. The one or more RRC messages 1814 may, for example, comprise a list of the plurality of TCI states. The list of the plurality of TCI states may be a list of joint TCI states (e.g., joint downlink-and-uplink TCI states). The list of joint TCI states may be applied to both the downlink and the uplink (e.g., each of the downlink physical channels and the uplink physical channels). The list of joint TCI states may be a list of downlink TCI states (or joint-downlink TCI states). The absence of a list of uplink TCI states (e.g., a separate list of uplink TCI states) may imply that the list of downlink TCI states is applicable to both the downlink and the uplink (e.g., the downlink physical channels and the uplink physical channels). The one or more RRC messages 1814 may comprise separate lists of TCI states for downlink and uplink. The list of the plurality of TCI states may comprise a list of downlink TCI states and a list of uplink TCI states. The one or more RRC messages 1814 may comprise a parameter indicating that the TCI states are joint (e.g., the TCI states are applicable for both downlink and uplink) or separate (e.g., the TCI states are applicable to downlink or uplink). The plurality of TCI states indicated by the one or more RRC messages 1814 may be referred to as configured TCI states or RRC-configured TCI states.

The one or more RRC messages 1814 may indicate one TCI state (e.g., a single TCI state). The one or more RRC messages 1814 may indicate one TCI state, for example, instead of a plurality of TCI states. The wireless device 1840 may (e.g., start to) use/apply one TCI state without additional signaling via a MAC CE and/or DCI, for example, based on (e.g., in response to) the one or more RRC messages 1814 indicating the one TCI state.

There may be two mechanisms for indicating which TCI state, among the plurality of TCI states configured by the one or more RRC messages 1814, to use/apply to transmissions between the wireless device 1840 and the base station 1860. The wireless device 1840 may receive a MAC CE 1816, for example, in/via a first mechanism. The MAC CE 1816 may indicate a TCI state (e.g., a single TCI state), or multiple TCI states, among the plurality of TCI states indicated by the one or more RRC messages 1814 (i.e., among the (RRC-)configured TCI states). A field of the MAC CE 1816 may indicate a value (e.g., a single value or a single codepoint) that is associated with one TCI state or more (e.g., multiple) TCI states (e.g., one codepoint associated with two TCI states) among the plurality of TCI states indicated by the one or more RRC messages 1814.

The MAC CE 1816 may indicate a TCI state to be used/applied to downlink and uplink. The MAC CE 1816 may indicate/comprise an ID of a TCI state among TCI states in a list of downlink TCI states (e.g., joint-downlink TCI states). The MAC CE 1816 may indicate separate TCI states for the downlink and the uplink. The MAC CE 1816 may indicate an ID of a TCI state from the TCI states in the list of downlink TCI states (e.g., joint-downlink TCI states) and an ID of a TCI state from TCI states in a list (e.g., a separate list) of uplink TCI states. The MAC CE 1816 may comprise a field and a value of the field may correspond to an ID of the TCI state, for example, to indicate the one or more TCI states. The MAC CE 1816 may have an indicator associated with the field (e.g., in the same octet), for example, that indicates whether/if the indicated TCI state is an uplink TCI state or a downlink TCI state (e.g., the ID of the TCI state is from the list of downlink TCI states or from the list of uplink TCI states configured by the one or more RRC messages 1814).

A second mechanism for indicating which TCI state to use/apply may comprise both MAC CE and DCI signaling. The wireless device 1840 may receive the MAC CE 1816, as shown in FIG. 18B. The MAC CE 1816 may indicate activation of a plurality of TCI states. Fields of the MAC CE 1816 may indicate a plurality of values (e.g., codepoints) that are associated with the plurality of TCI states (e.g., each codepoint being associated with one or more TCI states) among the plurality of TCI states indicated by the one or more RRC messages 1814. The TCI states activated by the MAC CE 1816 may be referred to as activated TCI states. The wireless device 1840 may receive DCI 1818. The DCI 1818 may indicate a TCI state among the TCI states activated by the MAC CE 1816. The wireless device 1840 may use/apply the (DCI-)indicated TCI state for receiving transmissions on physical channels, for example, based on the DCI 1818 indicating the TCI state among the (MAC-CE) activated TCI states.

The DCI 1818 may indicate one or more TCI states. The DCI 1818 may indicate a TCI state for downlink receptions, for example, from among the plurality of TCI states activated by the MAC CE 1816. The DCI 1818 may indicate a TCI state for uplink transmissions, for example, from among the plurality of TCI states activated by the MAC CE 1816. The DCI 1818 may comprise a field to indicate the one or more TCI states. The field may be referred to as a TCI state field. A value (e.g., a codepoint) of the TCI state field of the DCI 1818 may be associated with the one or more TCI states. A value of the TCI state field may indicate a TCI state to be used/applied to downlink transmission, a value of the TCI state field may indicate a TCI state to be used/applied to uplink transmissions, and/or a value of the TCI state field may indicate both a TCI to be used/applied to downlink transmissions and a TCI state to be used/applied to uplink transmissions. The one or more RRC messages 1814 may indicate an association between the values (e.g., codepoints) of the TCI state field of the DCI 1818 and the IDs of the plurality of TCI states configured by the one or more RRC messages 1814 and activated by the MAC CE 1816.

A TCI state indicated by the MAC CE 1816 and/or the DCI 1818 may be referred to as an updated TCI state. The indicating by the MAC CE 1816 and/or the DCI 1818 may be referred to as updating the TCI state (e.g., the current TCI state). The MAC CE 1816 indicating a TCI state for downlink and/or uplink (e.g., in the first mechanism) may comprise (e.g., be referred to as) updating the TCI state (e.g., the indicated TCI state). The DCI 1818 may comprise (e.g., be referred to as) updating the TCI state (e.g., the indicated TCI state), for example, if/when the MAC CE 1816 indicates activation of TCI states and the DCI 1818 indicates the TCI state for downlink and/or uplink.

The wireless device 1840 may use/apply the TCI state to receive downlink receptions and/or send (e.g., transmit) uplink transmissions. The wireless device 1840 may use/apply the TCI state to receive downlink receptions and/or send (e.g., transmit) uplink transmissions, for example, after or in response to the TCI state indicated by the MAC CE 1816 and/or the DCI 1818. The TCI state (e.g., the indicated TCI state) may remain as the TCI state that the wireless device 1840 uses/applies to downlink receptions (e.g., subsequent downlink receptions) and uplink receptions (e.g., subsequent uplink receptions), for example, until the TCI state is indicated or updated by a subsequent MAC CE and/or subsequent DCI.

The wireless device 1840 may receive DCI 1822 from the base station 1860, as shown in FIG. 18B. The DCI 1822 may schedule one or more downlink transmissions and/or schedule (or trigger) one or more uplink transmissions. The wireless device 1840 may receive a downlink transmission 1824 via the TCI state, for example, indicated by the MAC CE 1816 and/or the DCI 1818. The wireless device 1840 may send (e.g., transmit) an uplink transmission 1826 via the TCI state, for example, indicated by the MAC CE 1816 and/or the DCI 1818.

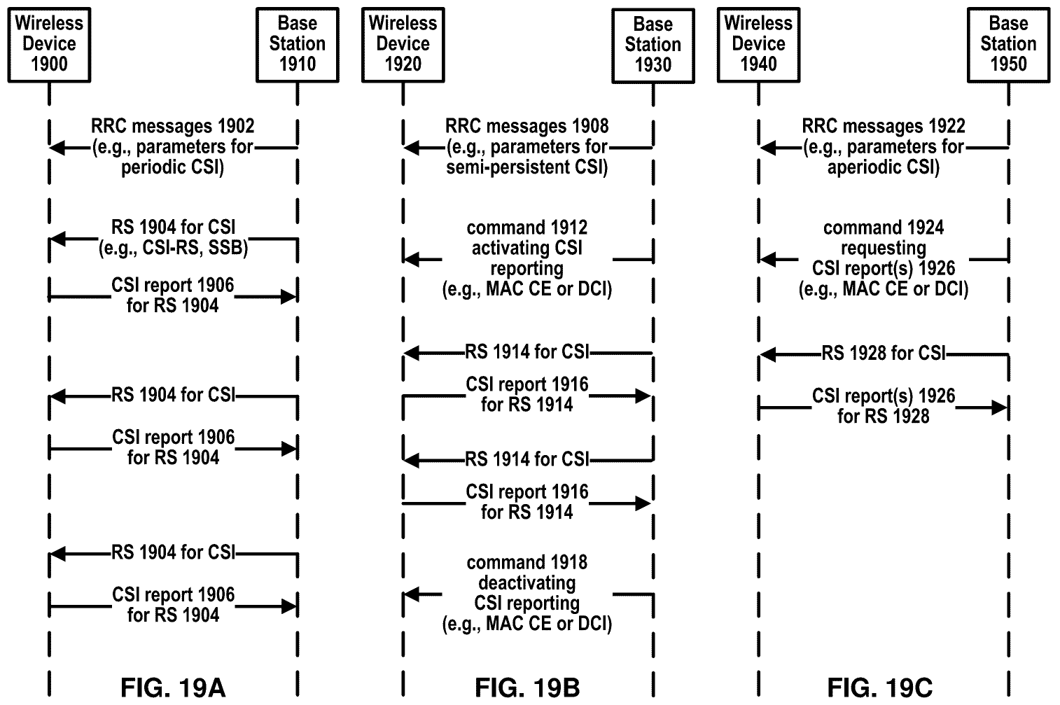

FIG. 19A, FIG. 19B, and FIG. 19C show examples of channel state information (CSI) reporting, triggered by a network (e.g., a base station). A wireless device 1900 may periodically send (e.g., transmit) CSI reports to a base station 1910, for example, according to periodic CSI reporting shown in FIG. 19A. A wireless device 1920 may periodically send (e.g., transmit) CSI reports to base station 1930, for example, according to semi-persistent CSI reporting shown in FIG. 19B. The wireless device 1920 may periodically send (e.g., transmit) the CSI reports to the base station 1930, for example, after or in response to receiving an activation command from the base station 1930. The wireless device 1920 may periodically send (e.g., transmit) the CSI reports to the base station 1930, for example, until the wireless device 1920 receives a deactivation command from the base station 1930. A wireless device 1940 may receive, from a base station 1950, a request to send (e.g., transmit) one or more aperiodic CSI reports to the base station 1950 (e.g., a plurality of aperiodic CSI reports may be requested, which are not periodically sent (e.g., transmitted)), for example, according to aperiodic CSI reporting shown in FIG. 19C.

FIG. 19A shows an example of periodic CSI reporting, triggered by a network. The wireless device 1900 may receive, from the base station 1910, one or more RRC messages 1902, as shown in FIG. 19A. The one or more RRC messages 1902 may indicate/comprise parameters for periodic CSI reporting. The parameters for periodic CSI reporting may comprise one or more CSI reporting configuration parameters, for example, a CSI report configuration and/or a resource configuration of reference signals (e.g., resources of reference signals).

The one or more RRC messages 1902 may indicate a periodicity for CSI reporting. The periodicity for CSI reporting may be referred to as a report periodicity type. The periodicity may indicate that the report periodicity type is periodic or semi-persistent. The one or more parameters for periodic CSI reporting, in the one or more RRC messages 1902 (e.g., shown in FIG. 19A), may indicate that the periodicity for CSI reporting is periodic (e.g., the periodicity is set to periodic).

The one or more RRC messages 1902 may comprise the one or more parameters for periodic CSI reporting. The one or more parameters for periodic CSI reporting (e.g., in the CSI report configuration), of the one or more RRC messages 1902, may indicate one or more quantities to measure and report. A quantity to measure and report may be referred to as one or more of a report quantity, a quantity, and/or a radio link quality. The report quantity of the one or more configuration parameters for periodic CSI reporting may indicate to report one or more of (e.g., a combination of any one of) the following report quantities: a channel quality indicator (CQI), a rank indicator (RI), a precoder-matrix indicator (PMI), a layer indicator (LI) (e.g., a strongest layer indicator (SLI)), and/or a layer-1 RSRP (L1-RSRP).

The one or more RRC messages 1902 may comprise the one or more parameters for periodic CSI reporting. The one or more parameters for periodic CSI reporting, of the one or more RRC messages 1902, may indicate the reference signals (e.g., downlink reference signals) that the wireless device 1900 measures to report the report quantity. The one or more parameters may indicate a reference signal from reference signals in a reference signal configuration. The reference signals and configurations of reference signals may be referred to as resource sets (e.g., of reference signals) and configurations of resource sets (e.g., for reference signals). The reference signals indicated by the one or more parameters may comprise CSI-RSs and/or SSBs. The reference signal configuration may be a CSI-RS (e.g., a non-zero power CSI-RS) resource set, for example, that configures a set of CSI-RSs or a set of SSBs for CSI. The set of CSI-RSs may comprise one or more CSI-RSs (e.g., one CSI-RS may be configured in the set) and the set of SSBs may comprise one or more SSBs (e.g., one SSB may be configured in the set).

The reference signals (e.g., the downlink reference signals) may comprise different types of periodicities (e.g., three types of periodicities) that may be measured and reported. A reference signal may be a periodic reference signal, a semi-persistent reference signal, or an aperiodic reference signal. A semi-persistent reference signal may be a reference signal with a periodicity that is (e.g., dynamically) stopped and/or skipped, for example, based on signaling.

The CSI reporting periodicity and the periodicity of the reference signal may be different from each other. Periodic CSI reporting may be reported for periodic reference signals. Semi-persistent CSI reporting may be reported for periodic reference signals and/or semi-persistent reference signals. A periodic CSI reporting may be reported for one or more of periodic reference signals, semi-persistent reference signals, and/or aperiodic reference signals.

The wireless device 1900 may (e.g., periodically) report CSI (e.g., in periodic CSI reporting). The wireless device 1900 may not receive any signaling to begin/initiate reporting CSI (e.g., other than the one or more RRC messages 1902) from the base station 1910 (i.e., there is no condition (e.g., trigger condition) for periodic CSI reporting). The wireless device 1900 may receive (e.g., start receiving) a reference signal 1904 from the base station 1910, for example, after or in response to the wireless device 1900 receiving the one or more RRC messages 1902, as shown in FIG. 19A. The reference signal 1904 may be a periodic reference signal (e.g., a periodic CSI-RS or a periodic SSB), as described herein. One or more RRC messages 1908 may indicate the reference signal 1904 to be used for the periodic CSI reporting (e.g., from a reference signal configuration). The wireless device 1900 may send (e.g., transmit) a CSI report 1906 to the base station 1910, for example, based on the reference signal 1904. The CSI report 1906 may comprise the report quantity indicated by the one or more parameters for periodic CSI reporting in the one or more RRC messages 1902. The wireless device 1900 may measure the reference signal 1904 (e.g., a radio link quality of the reference signal 1904), for example, based on the report quantity indicated by the one or more RRC messages 1902.

The wireless device 1900 may periodically send (e.g., transmit) the CSI report 1906 to the base station 1910, as shown in FIG. 19A. The CSI report 1906 may be the same, for example, comprising the same type of the report quantity, as shown in FIG. 19A. A value of the report quantity of the CSI report 1906 may change with each transmission of the CSI report 1906, for example, based on the reference signal 1904.

FIG. 19B shows an example of semi-persistent CSI reporting, triggered by a network. The wireless device 1920 may receive one or more RRC messages 1908 from the base station 1930, as shown in FIG. 19B. The one or more RRC messages 1908 may comprise parameters for semi-persistent CSI reporting. The one or more RRC messages 1908 may indicate/comprise, for example, the parameters (e.g., the same parameters) in the one or more RRC messages 1902 shown in FIG. 19A (e.g., for periodic CSI reporting). The one or more RRC messages 1908 may indicate a periodicity for CSI reporting (e.g., a report periodicity type). The report periodicity type in the one or more RRC messages 1908 may be semi-persistent (e.g., instead of periodic as in the one or more RRC messages 1902 shown in FIG. 19A). The report periodicity type may indicate one of two types of semi-persistent CSI reporting, for example, semi-persistent CSI reporting on PUCCH or semi-persistent CSI reporting on PUSCH. The report periodicity type may indicate/be semi-persistent on PUSCH, for example, as shown in FIG. 19B.

The one or more RRC messages 1908 may indicate a report quantity and reference signals (e.g., downlink reference signals) for the semi-persistent CSI reporting (e.g., on PUCCH or PUSCH). The one or more RRC messages 1908 may indicate a report quantity and reference signals (e.g., downlink reference signals) for the semi-persistent CSI reporting (e.g., on PUCCH or PUSCH), for example, like the one or more RRC messages 1902 shown in FIG. 19A. The parameters for semi-persistent CSI reporting may indicate a periodic reference signal or a semi-persistent reference signal for the wireless device 1920, for example, to measure and report to the base station 1930.

Semi-persistent CSI reporting may be similar to periodic CSI reporting. Semi-persistent CSI reporting may be similar to periodic CSI reporting, for example, except that the semi-persistent CSI reporting comprises/involves signaling to activate and deactivate the CSI reporting (e.g., the semi-persistent CSI reporting). The wireless device 1920 may receive a command 1912 (e.g., shown in FIG. 19B), for example, indicating activation of the semi-persistent CSI reporting. The command 1912 may be an activation command. The command 1912 may be a MAC CE indicating activation of the semi-persistent CSI reporting (e.g., on PUCCH) or DCI indicating activation of the semi-persistent CSI reporting (e.g., on PUSCH). The wireless device 1920 may receive (e.g., start receiving) a reference signal 1914 for CSI reporting (e.g., CSI-RS or SSB), for example, after or in response to receiving the command 1912 (e.g., as shown in FIG. 19B). The wireless device 1920 may not receive (e.g., not measure) the reference signal 1914, for example, until/after/in response to the wireless device 1920 receiving the command 1912 from the base station 1930.

The wireless device 1920 may send (e.g., transmit) (e.g., periodically send) a CSI report 1916 for the reference signal 1914, as shown in FIG. 19B. The wireless device 1920 may send (e.g., transmit) (e.g., periodically send) a CSI report 1916 for the reference signal 1914, for example, after or in response to the base station 1930 indicating activation of the semi-persistent CSI reporting via the command 1912. The CSI report 1916 may indicate a reporting quantity of the reference signal 1914. The reporting quantity in the CSI report 1916 may change over time based on measurements on the reference signal 1914, for example, similar to the CSI report 1906 (e.g., the periodic CSI report) shown in FIG. 18A.

The wireless device 1920 may periodically send (e.g., transmit) (e.g., continue to periodically send) the CSI report 1916. The wireless device 1920 may continue to periodically send (e.g., transmit) the CSI report 1916, for example, until a deactivation command is received in the semi-persistent CSI reporting. The wireless device 1920 may receive a command 1918 from the base station 1930, as shown in FIG. 19B. The command 1918 may indicate deactivation of the semi-persistent CSI reporting. The command 1918 may be a deactivation command, for example, deactivating the semi-persistent CSI reporting. The command 1918 may be, for example, a MAC CE indicating deactivation of the semi-persistent CSI reporting (e.g., on PUCCH) or DCI indicating deactivation of semi-persistent CSI reporting (e.g., on PUSCH). The wireless device 1920 may stop sending (e.g., transmitting) (and stop measuring) the CSI report 1916 of the reference signal 1914, for example, after or in response to receiving the command 1918 indicating to deactivate the semi-persistent CSI reporting.

FIG. 19C shows an example of aperiodic CSI reporting, triggered by a network. The wireless device 1940 may receive one or more RRC messages 1922 from the base station 1950, as shown in FIG. 19C. The one or more RRC messages 1922 may comprise parameters for aperiodic CSI reporting. The one or more RRC messages 1922 may indicate/comprise, for example, the parameters (e.g., the same parameters) in the one or more RRC messages 1902 shown in FIG. 19A (e.g., for periodic CSI reporting) and/or in the one or more RRC messages 1908 shown in FIG. 19B (e.g., for semi-persistent CSI reporting). The one or more RRC messages 1922 may indicate a periodicity for CSI reporting (e.g., a report periodicity type). The report periodicity type in the one or more RRC messages 1922 may be aperiodic (e.g., instead of periodic and/or semi-persistent).

The one or more RRC messages 1922 may indicate a report quantity and reference signals (e.g., downlink reference signals) for the aperiodic CSI reporting (e.g., on PUSCH). The one or more RRC messages 1922 may indicate a report quantity and reference signals (e.g., downlink reference signals) for the aperiodic CSI reporting (e.g., on PUSCH), for example, like the one or more RRC messages 1902 shown in FIG. 19A (e.g., for periodic CSI reporting) and/or the one or more RRC messages 1908 shown in FIG. 19B (e.g., for semi-persistent CSI reporting). The parameters for aperiodic CSI reporting may indicate one or more reference signals for aperiodic CSI reporting. The one or more reference signals for aperiodic CSI reporting may be/comprise one or more types of reference signals: periodic reference signals, semi-persistent reference signals, and/or aperiodic reference signals. The one or more reference signals for aperiodic CSI reporting may be/comprise CSI-RSs and/or SSBs.

The base station 1950 may send (e.g., transmit) DCI indicating a request for one or more aperiodic CSI reports (e.g., for aperiodic CSI reporting). The request may be a CSI request field of the DCI. The one or more RRC messages 1922 may indicate an association between reference signals or reference signal resource sets and one or more bits of the CSI request field of the DCI. The base station 1950 may request/trigger (e.g., dynamically request or trigger) the wireless device 1940 to send (e.g., transmit) a CSI report for one or more of the reference signals (or the reference signal resource sets), for example, based on the association between the reference signals (or the reference signal resource sets) and the one or more bits of the CSI request field of the DCI. The one or more RRC messages 1922 may indicate a size of the CSI request field of the DCI for requesting aperiodic CSI reports (e.g., a trigger size). The size of the CSI request field may be/comprise a number of/quantity of bits (e.g., 0, 1, 2, 3, 4, 5 or 6 bits), for example, depending on the size indicated by a parameter in the one or more RRC messages 1922 (e.g., the parameters for aperiodic CSI reporting of the one or more RRC messages 1922).

The wireless device 1940 may receive a command 1924 from the base station 1950, as shown in FIG. 19C. The wireless device 1940 may receive a command 1924 from the base station 1950, for example, after or in response to receiving the one or more RRC messages 1922. The command 1924 may request the wireless device 1940 to send (e.g., transmit) one or more CSI reports 1926 (e.g., aperiodic CSI reports) of one or more reference signals 1928. The command 1924 may be DCI. The one or more CSI reports 1926 (e.g., aperiodic CSI reports) may be a plurality of aperiodic CSI reports.

The parameters for aperiodic CSI reporting in the one or more RRC messages 1922 may not comprise uplink resources for sending (e.g., transmitting) the one or more CSI reports 1926 (e.g., aperiodic CSI reports). The command 1924 may indicate the uplink resources (e.g., comprise an uplink grant) for the one or more CSI reports 1926. The wireless device 1940 may send (e.g., transmit) the one or more CSI reports 1926 for the one or more reference signals 1928. The wireless device 1940 may send (e.g., transmit) the one or more CSI reports 1926 on the PUSCH.

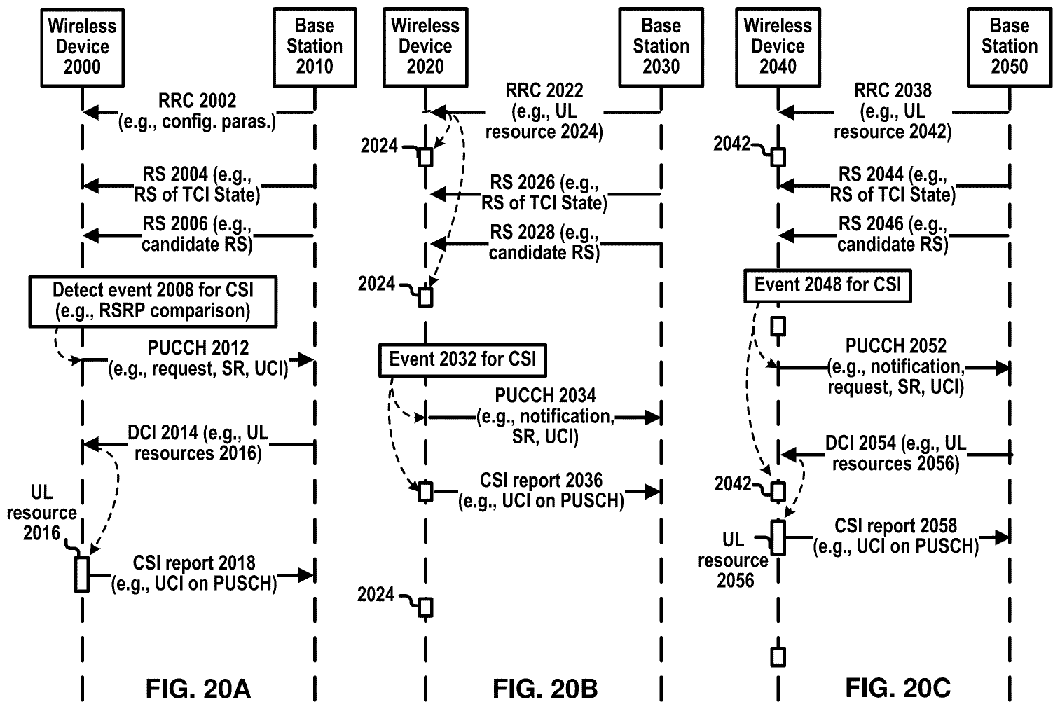

FIG. 20A, FIG. 20B, and FIG. 20C show examples of CSI reporting, triggered (e.g., initiated) by a wireless device (e.g., independent of the network). The network may act as a scheduler of CSI reporting and trigger the wireless device to send (e.g., transmit) CSI reports, for example, in periodic CSI reporting (e.g., shown in FIG. 19A), semi-persistent CSI reporting (e.g., shown in FIG. 19B), and aperiodic CSI reporting (e.g., shown in FIG. 19C). The wireless device may initiate/trigger CSI reporting (e.g., shown in FIG. 20A, FIG. 20B, and FIG. 20C), for example, to provide the network with CSI for use in updating a TCI state (e.g., a current TCI state). The TCI state may be/comprise a TCI state used in the unified TCI framework (e.g., for downlink, uplink, and/or both downlink and uplink), as shown in FIG. 18B.

CSI reporting triggered by a wireless device may be referred to as event-driven CSI reporting, event-based CSI reporting, wireless device-initiated CSI reporting, UE-initiated CSI reporting, wireless device-initiated beam reporting, UE-initiated beam reporting, wireless device-initiated beam management, or UE-initiated beam management. A procedure for the CSI reporting triggered by the wireless device may be referred to as an event-driven CSI reporting procedure, an event-based CSI reporting procedure, a wireless device-initiated CSI reporting procedure, a UE-initiated CSI reporting procedure, a wireless device-initiated beam reporting procedure, a UE-initiated beam reporting procedure, a wireless device-initiated beam management procedure, or a UE-initiated beam management procedure. A CSI report, based on the CSI reporting triggered by the wireless device, may be referred to as an event-driven CSI report, an event-based CSI report, a wireless device-initiated CSI report, a UE-initiated CSI report, a wireless device-initiated beam report, a UE-initiated beam report, a wireless device-initiated beam management report, or a UE-initiated beam management report. Terms “event-driven,” “event-based,” “event-triggered,” “wireless device-initiated,” “UE-initiated,” “wireless device-triggered,” “UE-triggered,” “terminal-initiated,” and “terminal-triggered” may be used to refer to the CSI reporting triggered by the wireless device and the CSI report, based on the CSI reporting triggered by the wireless device.

FIG. 20A, FIG. 20B, and FIG. 20C show examples of CSI reporting, triggered by a wireless device. A wireless device 2000 may use uplink grants (e.g., dynamic uplink grants) to send (e.g., transmit) UE-initiated CSI reports, to a base station 2010, for example, according to a first mode of UE-initiated CSI reporting shown in FIG. 20A. A wireless device 2020 may use preconfigured uplink resources for reporting UE-initiated CSI reports to a base station 2030, for example, according to a second mode of UE-initiated CSI reporting shown in FIG. 20B. A wireless device 2040 and a base station 2050 may use a combination of the first mode of FIG. 20A (e.g., using dynamic uplink grants) and the second mode of FIG. 20B (e.g., using preconfigured uplink resources) for sending (e.g., transmitting) UE-initiated CSI reporting, as shown in FIG. 20C.

FIG. 20A shows an example of a first mode of CSI reporting, triggered by a wireless device. The wireless device 2000 may receive one or more RRC messages 2002 from the base station 2010, as shown in FIG. 20A. The one or more RRC messages 2002 may indicate/comprise one or more CSI reporting configuration parameters for CSI reporting (e.g., wireless device-initiated CSI reporting, such as UE-initiated CSI reporting). The one or more CSI reporting configuration parameters may comprise a report configuration type parameter. The report configuration type parameter may indicate that the CSI reporting, of the one or more CSI reporting configuration parameters, is based on the wireless device 2000 detecting an event. The report configuration type parameter may be set to event-triggered or wireless device-initiated (e.g., UE-initiated).

The event may be/result from a comparison of a radio link quality of a reference signal to a reference signal of a TCI state. The reference signal of the TCI state may be referred to as a current reference signal or a reference signal of a current TCI state (e.g., a TCI state that has been indicated by a MAC CE for downlink and/or uplink or a TCI state that has been activated by a MAC CE and indicated by DCI, as described herein with reference to FIG. 18B). A QCL type of the reference signal of the TCI, used for the comparison, may be QCL-Type D. The reference signal that the wireless device 2000 compares to the current reference signal of the TCI state, for detecting the event, may be referred to as a candidate reference signal.

The event may be that the radio link quality of the candidate reference signal is a threshold value better than a radio link quality of a reference signal of a TCI state. The event may be that the radio link quality of the candidate reference signal is better (e.g., higher) than a radio link quality of a current reference signal of a TCI state by a threshold value. The amount that the radio link quality of the candidate reference signal is better (e.g., higher or greater than) the radio link quality of the current reference signal of the TCI state may be greater than or equal to a threshold value.

The one or more RRC messages 2002 may indicate the threshold value for detecting the event. The threshold value may be preconfigured (e.g., predetermined without being signaled). The threshold value may be an RSRP value, an RSRP offset, an SINR value, or an SINR offset. The radio link quality may be a RSRP, a layer-1 RSRP, or a signal to interference-and-noise ratio (SINR). The radio link quality may be referred to as a report quantity. The one or more RRC messages 2002 may indicate, in the radio link quality, to report (e.g., a report quantity).

The one or more CSI reporting configuration parameters may comprise a CSI resource parameter indicating a list of candidate reference signals. The list of candidate reference signals may be for CSI reporting triggered by the wireless device, for example, based on detecting the event. The list of candidate reference signals may be referred to as a list of candidate reference signals for wireless device-initiated CSI reporting, such as UE-initiated CSI reporting, or a reference signal resource set for wireless device initiated CSI reporting, such as UE-initiated CSI reporting.

The list of candidate reference signals may be a list (e.g., wireless device-specific list or a wireless device-dedicated list) of reference signals for CSI reporting triggered by the wireless device 2000. The list of candidate reference signals may be for a cell (e.g., common among wireless devices in the cell). The list of reference signals for CSI reporting may be reference signals of TCI states indicated (e.g., configured) by the one or more RRC messages 2002. The list of reference signals for CSI reporting may be reference signals of TCI states activated by a MAC CE.

The one or more CSI reporting configuration parameters, indicated by the one or more RRC messages 2002, may comprise an ID of a reference signal configuration (e.g., resource configuration). The reference signal configuration may be a CSI resource configuration ID. The reference signal configuration may indicate a list of one or more CSI-RS resource sets. The reference signals of the one or more CSI-RS resource sets may be CSI-RSs or SSBs.

The one or more CSI reporting configuration parameters may indicate PUCCH resources. The one or more CSI reporting configuration parameters may indicate a PUCCH resource among PUCCH resources of an uplink BWP. The one or more CSI reporting configuration parameters, of the one or more RRC messages 2002, may comprise an ID of a PUCCH resource among PUCCH resources (e.g., IDs of PUCCH resources) of an uplink BWP.

The one or more CSI reporting configuration parameters may not indicate uplink resources for the CSI reporting in the first mode. The one or more CSI reporting configuration parameters may not indicate uplink resources for sending (e.g., transmitting) the CSI reporting in the first mode. The one or more CSI reporting configuration parameters may not indicate the uplink resources (e.g., PUSCH resources) for sending (e.g., transmitting) CSI reports, for example, triggered by the wireless device 2000 based on detecting an event. The absence of an indication of the uplink resources to be used for sending (e.g., transmitting) CSI reports triggered by wireless device 2000 may indicate (e.g., implicitly indicate) that the CSI reporting configuration parameters are for the first mode of CSI reporting, for example, in which the uplink resources must be requested from the base station 2010 (e.g., a request for a dynamic grant).

The one or more CSI reporting configuration parameters may comprise a parameter indicating that CSI reporting is enabled or activated. The one or more CSI reporting configuration parameters may comprise a parameter indicating that CSI reporting, triggered by the wireless device 2000 based on detecting the event (e.g., wireless device-initiated, UE-initiated, or event-driven CSI reporting), is enabled or activated. The parameter may indicate that CSI reporting is enabled/activated for a cell. The parameter may indicate that CSI reporting is enabled/activated for an uplink BWP. The parameter (e.g., another parameter) may indicate (e.g., explicitly indicate) a mode that is being configured among the first mode and the second mode.

The one or more CSI reporting configuration parameters may comprise one or more timer values. The one or more CSI reporting configuration parameters may comprise one or more timer values, for example, of one or more timers for detecting the event. Each of the one or more timers may be associated with at least one candidate reference signal among the one or more candidate reference signals.

The one or more CSI reporting configuration parameters may comprise one or more maximum count values of one or more counters of a number of/quantity of times the event is detected. The one or more CSI reporting configuration parameters may comprise one or more maximum count values of one or more counters of a number of/quantity of times the event is detected, for example, for one or more candidate reference signals. Each of the one or more counters may be incremented (e.g., up to an associated maximum count value among the one or more maximum count values), for example, based on (e.g., in response to) receiving an indication (e.g., from a PHY layer of the wireless device 2000) that the one or more candidate reference signals satisfy the event. Each of the one or more counters may be associated with a candidate reference signal (e.g., a respective candidate reference signal).

The one or more CSI reporting configuration parameters may comprise/indicate one or more configuration parameters of an SR (e.g., an SR configuration for the SR). The one or more configuration parameters of the SR may indicate a PUCCH resource, from among PUCCH resources in an uplink BWP, configured for the SR. The one or more configuration parameters of the SR may indicate a periodicity and offset of the SR.

The wireless device 2000 may receive a reference signal 2004, of a TCI state, from the base station 2010, as shown in FIG. 20A. The wireless device 2000 may receive a reference signal 2004, of a TCI state, from the base station 2010, for example, after or in response to receiving the one or more RRC messages 2002. The reference signal 2004 may be a current reference signal of a TCI (e.g., an indicated TCI state by a MAC CE and/or DCI for downlink and/or uplink). The wireless device 2000 may receive a reference signal 2006. The reference signal 2006 may be a candidate reference signal for CSI reporting triggered by the wireless device 2000. The reference signal 2006 may be from a list of candidate reference signals in the one or more RRC messages 2002. The reference signal 2006 may be a reference signal of a TCI state among the activated TCI states (e.g., the MAC CE activated TCI states), for example, other than the reference signal 2004. The reference signal 2006 may be a reference signal of a TCI state among the configured TCI states (e.g., the RRC configured TCI states).

The wireless device 2000 may detect an event 2008 for CSI reporting (e.g., that triggers CSI reporting), as shown in FIG. 20A. The wireless device 2000 may detect that a radio link quality (e.g., L1-RSRP, L1-SINR) of the reference signal 2006 is a threshold value better than (e.g., greater than by at least a threshold value) a radio link quality of the reference signal 2004 of the TCI state, for example, in the event 2008.

The wireless device 2000 may send (e.g., transmit) a PUCCH transmission 2012, as shown in FIG. 20A. The wireless device 2000 may send (e.g., transmit) a PUCCH transmission 2012, for example, based on detecting the event 2008 for CSI reporting. The wireless device 2000 may send (e.g., transmit) the PUCCH transmission 2012, for example, via one or more PUCCH resources indicated by the one or more RRC messages 2002. The PUCCH transmission 2012 may be sent (e.g., transmitted) via the PUCCH resource indicated by the one or more RRC messages 2002.

The PUCCH transmission 2012 may request uplink resources for sending (e.g., transmitting) a CSI report. The uplink resources may be PUSCH resources. The PUCCH transmission 2012 may be SR. The PUCCH transmission 2012 may comprise a SR. A PUCCH format of the PUCCH transmission 2012 may be a PUCCH format 0 or a PUCCH format 1. The PUCCH transmission 2012 may be a UCI.

The wireless device 2000 may receive DCI 2014 from the base station 2010, as shown in FIG. 20A. The wireless device 2000 may receive DCI 2014 from the base station 2010, for example, after or in response to sending (e.g., transmitting) the PUCCH transmission 2012. The DCI 2014 may indicate uplink resources 2016 for sending (e.g., transmitting) CSI reporting, for example, based on the wireless device 2000 detecting the event 2008. The DCI 2014 may comprise an uplink grant indicating the uplink resources 2016. The uplink resources 2016 may be PUSCH resources.

The wireless device 2000 may send (e.g., transmit) a CSI report 2018 via the uplink resources 2016, as shown in FIG. 20A. The wireless device 2000 may send (e.g., transmit) a CSI report 2018 via the uplink resources 2016, for example, after or in response to receiving the DCI 2014. The CSI report 2018 may be a UCI (e.g., the CSI report 2018 may be a type of UCI). The wireless device 2000 may send (e.g., transmit) the UCI on the uplink resources 2016. The UCI (e.g., CSI report 2018) may be multiplexed on the uplink resources 2016 (e.g., indicated by the DCI 2014).

The CSI report 2018 may comprise one or more radio link qualities and/or IDs of reference signals. The CSI report 2018 may comprise a radio link quality of the reference signal 2006 (e.g., the candidate reference signal). The CSI report 2018 may comprise an ID of the reference signal 2006. The CSI report 2018 may comprise a radio link quality of the reference signal 2004 (e.g., the current reference signal) of the TCI state (e.g., the indicated TCI state or the current TCI state). The CSI report 2018 may comprise a plurality of radio link qualities of a plurality of candidate reference signals.

The CSI report 2018 may indicate a number of/quantity of radio link qualities and/or reference signals. The number of/quantity of radio link qualities and/or reference signals indicated in the CSI report 2018 may be one, greater than one, or less than or equal to a maximum number of radio link qualities for CSI reporting. The one or more RRC messages 2002 may comprise, for example, a parameter indicating the maximum number of radio link qualities for CSI reporting triggered by the wireless device 2000. The one or more (e.g., the number of/quantity of) radio link qualities indicated by the CSI report 2018 may be absolute values, or differential values, for example, of one or more radio link qualities of reference signals. The radio link qualities may be one or more of RSRP values, L1-RSRP values, and/or SINR values.

The wireless device 2000 may monitor, detect, and/or report one or more events among a plurality of events for reporting CSI. A first event may be that a radio link quality of a candidate reference signal is a threshold value better than a radio link quality of a current reference signal of a TCI state. A second event may be that a radio link quality of a candidate reference signal is worse than a threshold. A third event may be that a radio link quality of a candidate reference signal is better than a threshold. A fourth event may be that a radio link quality of a reference signal, of a TCI state indicated by a control command (e.g., DCI or MAC CE), is worse than a first threshold and a radio link quality of at least one candidate reference signal is better than a second threshold. A fifth event may be that a difference between a radio link quality of a reference signal, of a TCI state indicated by a control command (e.g., DCI or MAC CE), and a radio link quality of at least one candidate reference signal is lower than a threshold. A sixth event may be that a radio link quality of the reference signal, of the TCI state indicated by the control command (e.g., DCI or MAC CE), is not among a number of/quantity of candidate reference signals with a highest radio link qualities. A seventh event may be that a radio link quality of at least one candidate reference signal is a threshold value better than a reference signal of a TCI state, indicated by a control command (e.g., DCI or MAC CE), with a worst radio link quality among reference signals of TCI states indicated by the control command. An eighth event may be that a radio link quality of at least one candidate reference signal is a threshold value better than a reference signal of a TCI state, indicated by a control command (e.g., DCI or MAC CE), with a highest radio link quality among reference signals of TCI states indicated by the control command. A ninth event may be that a radio link quality of a number of/quantity of candidate reference signals become a threshold value better than the reference signal of the TCI state indicated by the control command (e.g., DCI or MAC CE). A tenth event may be that a radio link quality of at least one candidate reference signal becomes a threshold value better than a reference signal configured by one or more RRC messages. The one or more events may comprise any one or any combination of the first, second, third, fourth, fifth, sixth, seventh, eighth, ninth, and tenth events. The wireless device 2000 may monitor, detect, and/or report events other than those noted herein.

The CSI report 2018 may comprise an ID of the event. The ID of the event may be referred to as an event ID. Each of the events among a plurality of events may be associated with an event ID. A first value of the event ID may indicate that the first event is detected (or satisfied). A second value of the event ID may indicate that the second event is detected. A third value of the event ID may indicate that the third event is detected. A fourth value of the event ID may indicate that the fourth event is detected. A fifth value of the event ID may indicate that the fifth event is detected. A sixth value of the event ID may indicate that the sixth event is detected. A seventh value of the event ID may indicate that the seventh event is detected. An eighth value of the event ID may indicate that the eighth event is detected. A ninth value of the event ID may indicate that the ninth event is detected. A tenth value of the event ID may indicate that the tenth event is detected.

The PUCCH transmission 2012 may comprise/indicate an event ID. A set of PUCCH resources for the PUCCH transmission 2012 may be associated with an event ID among the plurality of event IDs (e.g., implicitly indicating an event ID). The base station 2010 may determine (e.g., infer) that the PUCCH transmission 2012 is for the associated event ID, for example, based on receiving the PUCCH transmission 2012 via the set of PUCCH resources.

The one or more RRC messages 2002 may comprise a list of the plurality of events and/or event IDs of the plurality of events. Each of the event IDs in the CSI report 2018 and/or the PUCCH transmission 2012 may be associated with a respective reference signal (e.g., of a candidate reference signal or a reference signal of a TCI state) in the CSI report 2018 and/or the PUCCH transmission 2012.

FIG. 20B shows an example of a second mode of CSI reporting, triggered by a wireless device. The wireless device 2020 may use preconfigured uplink resources for reporting CSI to the base station 2030, as shown in FIG. 20B. The wireless device 2020 may use preconfigured uplink resources for reporting CSI to the base station 2030, for example, based on the wireless device 2020 detecting an event based on a radio link quality of a reference signal. The procedure, the messages, and the parameters in the second mode (e.g., shown in FIG. 20B) may be the same as the procedure, the messages, and the parameters in the first mode (e.g., shown in FIG. 20A), for example, where the differences between the procedure, the messages, and the parameters in the second mode for CSI reporting based on preconfigured uplink resources are described herein.

The wireless device 2020 may receive one or more RRC messages 2022, as shown in FIG. 20B. The one or more RRC messages 2022 may comprise/indicate the (e.g., the same) one or more CSI reporting configuration parameters (e.g., and other parameters) of the one or more RRC messages 2002 (e.g., shown in FIG. 20A).

The one or more CSI reporting configuration parameters of the one or more RRC messages 2022 may indicate uplink resources 2024 for CSI reporting triggered by the wireless device 2020. The one or more CSI reporting configuration parameters of the one or more RRC messages 2022 may indicate uplink resources 2024 for sending (e.g., transmitting) the CSI reporting triggered by the wireless device 2020. The uplink resources 2024 may be PUSCH resources or PUCCH resources for sending (e.g., transmitting) the CSI reporting triggered by the wireless device 2020. The base station 2030 may send (e.g., transmit) the one or more CSI reporting configuration parameters of the one or more RRC messages 2022 to the wireless device 2020, for example, based on receiving a wireless device capability message (e.g., a UE-capability message) from the wireless device 2020 indicating that the wireless device 2020 supports the second mode.

The presence of an indication of the uplink resources 2024 may indicate to the wireless device 2020 that the one or more CSI reporting configuration parameters, of the one or more RRC messages 2022, are for the second mode of CSI reporting. The one or more CSI reporting configuration parameters of the one or more RRC messages 2022 may comprise a parameter, for example, indicating that the one or more CSI reporting configuration parameters are for reporting CSI (e.g., wireless device-initiated CSI, such as a UE-initiated CSI) on preconfigured uplink resources (e.g., the second mode). The parameter may indicate that the CSI reporting (e.g., the wireless device-initiated CSI reporting, such as UE-initiated CSI reporting) on preconfigured uplink resources is enabled or activated. The parameter (or another parameter) may indicate (e.g., explicitly indicate) a mode that is being configured among the first mode and the second mode.

The one or more RRC messages 2022 may indicate a periodicity of the uplink resources 2024 (e.g., a configured uplink grant). The periodicity of the uplink resources 2024 may be shown in FIG. 20B. The wireless device 2020 may send (e.g., transmit) a notification to the base station 2030, for example, before sending (e.g., transmitting) CSI reporting. The wireless device 2020 may receive a reference signal 2026, as shown in FIG. 20B. The reference signal 2026 may be a reference signal (e.g., current reference signal) of a TCI state, for example, similar to the reference signal 2004 (e.g., shown in FIG. 20A). The wireless device 2020 may receive a reference signal 2028, as shown in FIG. 20B. The reference signal 2028 may be a candidate reference signal, for example, similar to the reference signal 2006 (e.g., shown in FIG. 20A).

The wireless device 2020 may detect an event 2032 for CSI reporting (e.g., that triggers CSI reporting), as shown in FIG. 20B. The wireless device 2020 may detect an event 2032 for CSI reporting (e.g., that triggers CSI reporting), for example, after or in response to receiving the reference signal 2026 and the reference signal 2028. The event 2032 may be the same as the event 2008 of (e.g., shown in FIG. 20A). The wireless device 2020 may detect that a radio link quality (e.g., L1-RSRP, L1-SINR) of the reference signal 2028 is a threshold value better than (e.g., greater than by at least a threshold value) than a radio link quality (e.g., L1-RSRP) of the reference signal 2026 of the TCI state, for example, in the event 2032.

The wireless device 2020 may send (e.g., transmit) a PUCCH transmission 2034 to the base station 2030, as shown in FIG. 20B. The wireless device 2020 may send (e.g., transmit) a PUCCH transmission 2034 to the base station 2030, for example, based on detecting the event 2032 for CSI reporting (e.g., wireless device-initiated CSI reporting, such as UE-initiated CSI reporting). The wireless device 2020 may send (e.g., transmit) the PUCCH transmission 2034 via one or more PUCCH resources indicated by the one or more RRC messages 2022, for example, similar to the wireless device 2000 sending (e.g., transmitting) the PUCCH transmission 2012 via the one or more PUCCH resources indicated by the one or more RRC messages 2002 (e.g., shown in FIG. 20A). As described herein, the one or more RRC messages 2022 may indicate the uplink resources 2024 for sending (e.g., transmitting) CSI reporting triggered by the wireless device 2020. The PUCCH transmission 2034 may notify that the CSI reporting is to be sent (e.g., transmitted) on the uplink resources 2024, for example, in the second mode.

The PUCCH transmission 2034 may be SR. The PUCCH transmission 2034 may be SR, for example, similar to the PUCCH transmission 2012 (e.g., shown in FIG. 20A). The PUCCH transmission 2034 may comprise a SR. A PUCCH format of the PUCCH transmission 2034 may be a PUCCH format 0 or a PUCCH format 1. The PUCCH transmission 2034 may be a UCI.

The wireless device 2020 may send (e.g., transmit) a CSI report 2036 via the uplink resources 2024, as shown in FIG. 20B. The wireless device 2020 may send (e.g., transmit) a CSI report 2036 via the uplink resources 2024, for example, after or in response to sending (e.g., transmitting) the PUCCH transmission 2034. The CSI report 2036 may be a UCI. The wireless device 2020 may send (e.g., transmit) the UCI on the uplink resources 2024. The UCI (e.g., the CSI report 2036) may be multiplexed on the uplink resources 2024 (e.g., on a PUSCH). The CSI report 2036 (e.g., shown in FIG. 20B) may indicate/comprise the same information as the CSI report 2018 (e.g., shown in FIG. 20A).

The PUCCH transmission 2034 may provide a notification (e.g., advance notification). The advance notification, provided by the PUCCH transmission 2034, may enable the network (e.g., the base station 2030) to indicate (e.g., allocate) the uplink resources 2024 to multiple wireless devices and reassign the uplink resources 2024, for example, before (e.g., prior to) the CSI reporting (e.g., notified CSI reporting) is sent (e.g., transmitted). The base station 2030 may send (e.g., transmit) a reconfiguration (e.g., via an RRC message with modified values for the parameters of the one or more RRC messages 2022), for example, to reassign the uplink resources 2024 or otherwise prevent a collision (interference) from occurring on the uplink resources 2024 if/when the uplink resources 2024 are configured to multiple wireless devices. The network may use a combination of the first mode and the second mode, as described for FIG. 20C.

FIG. 20C shows an example of a combination of modes for CSI reporting, triggered by a wireless device. The wireless device 2040 and the base station 2050 may use a combination of the first mode of FIG. 20A (e.g., using dynamic uplink grants) and the second mode of FIG. 20B (e.g., using preconfigured uplink resources) for reporting CSI triggered by the wireless device 2040, as shown in FIG. 20C. The wireless device 2040 may receive one or more RRC messages 2038. The one or more RRC messages 2038 may indicate uplink resources 2042 for sending (e.g., transmitting) CSI reporting triggered by the wireless device 2040 (e.g., similar to the one or more RRC messages 2022 and the uplink resources 2024 shown in FIG. 20B). The wireless device 2040 may receive a reference signal 2044, for example, after or in response to receiving the one or more RRC messages 2038. The reference signal 2044 may be a current reference signal of an indicated TCI state (e.g., similar to the reference signal 2004 shown in FIG. 20A and the reference signal 2026 shown in FIG. 20B). The wireless device 2040 may receive a reference signal 2046. The reference signal 2046 may be a candidate reference signal (e.g., similar to the reference signal 2006 shown in FIG. 20A and the reference signal 2028 shown in FIG. 20B).

The wireless device 2040 may detect an event 2048 for CSI reporting (e.g., that triggers wireless device-initiated CSI reporting, such as UE-initiated CSI reporting). The wireless device 2040 may detect an event 2048 for CSI reporting (e.g., that triggers wireless device-initiated CSI reporting, such as UE-initiated CSI reporting), for example, based on measurements of radio link qualities of the reference signal 2044 and the reference signal 2046. The event 2048 (e.g., shown in FIG. 20C) may be the same as the event 2008 (e.g., shown in FIG. 20A) and/or the event 2032 (e.g., shown in FIG. 20B).

The wireless device 2040 may send (e.g., transmit) a PUCCH transmission 2052 to the base station 2050, as shown in FIG. 20C. The wireless device 2040 may send (e.g., transmit) a PUCCH transmission 2052 to the base station 2050, for example, based on detecting the event 2048. The PUCCH transmission 2052 may notify the base station 2050 that CSI reporting is to be sent (e.g., transmitted) on the uplink resources 2042, for example, like the PUCCH transmission 2034 (e.g., shown in FIG. 20B).

The base station 2050 may determine that another wireless device is to send (e.g., transmit) on the uplink resources 2042. The base station 2050 may determine that another wireless device is to send (e.g., transmit) on the uplink resources 2042, for example, after or in response to receiving a PUCCH transmission 2052 (e.g., as shown in FIG. 20C). The base station 2050 may determine that another wireless device is to perform a transmission on other radio resources (e.g., uplink or downlink resources) that may interfere (e.g., or collide) with the CSI reporting that the wireless device 2040 intends to send (e.g., transmit) using the uplink resources 2042.

The base station 2050 may send (e.g., transmit) DCI 2054, as shown in FIG. 20C. The base station 2050 may send (e.g., transmit) DCI 2054, for example, after or in response to receiving the PUCCH transmission 2052. The DCI 2054 may indicate uplink resources (e.g., alternative uplink resources), for example, to avoid interference. The DCI 2054 may indicate uplink resources 2056 (e.g., shown in FIG. 20C). The uplink resources 2056 may be the same as the uplink resources 2016 (e.g., shown in FIG. 20A). The DCI 2054 may comprise an uplink grant indicating the uplink resources 2056. The uplink resources 2056 may be PUSCH resources.

The wireless device 2040 may send (e.g., transmit) a CSI report 2058 via the uplink resource 2056, as shown in FIG. 20C. The wireless device 2040 may send (e.g., transmit) a CSI report 2058 via the uplink resource 2056, for example, based on receiving the DCI 2054. The wireless device 2040 may send (e.g., transmit) the CSI report 2058 on the uplink resources 2056, for example, instead of sending (e.g., transmitting) the CSI report 2058 on the preconfigured uplink resources (e.g., the uplink resources 2042). The wireless device 2040 may cancel/skip sending (e.g., transmitting) the CSI report 2058 on the preconfigured resources, for example, based on receiving the DCI 2054.

Beam reporting triggered by a wireless device may be referred to as wireless device-initiated beam reporting, such as UE-initiated beam reporting (UEIBR). The beam reporting triggered by a wireless device (e.g., UEIBR) may be referred (e.g., interchangeably referred to) as event-driven CSI/beam reporting, wireless device-initiated CSI reporting, UE-initiated CSI reporting, wireless device-triggered CSI/beam reporting, or UE-triggered CSI/beam reporting. A wireless device may be configured with a list/set of candidate reference signals for use by the wireless device to detect an event that triggers a beam report by the wireless device, for example in UEIBR. The beam report may be referred to (e.g., interchangeably referred to) as a channel state information (CSI) report. The wireless device may receive the list/set of candidate reference signals via one or more configuration messages (e.g., RRC). If/when a radio link quality of at least one candidate reference signal of the list/set of candidate reference signals becomes better than a radio link quality of a current reference signal by a threshold value (e.g., a layer 1 received signal received power (L1-RSRP) (or a layer 1 signal-to-interference-plus-noise ratio (L1-SINR)) of at least one candidate reference signal>threshold+L1-RSRP (or an L1-SINR) of the current reference signal), the wireless device may trigger UEIBR. The current reference signal may correspond to a current beam used by the wireless device. The current beam may be a beam corresponding to a TCI state indicated to the wireless device (e.g., the indicated TCI state). The current reference signal may be implicitly derived from a quasi-co-location reference signal (QCL RS) of the indicated TCI state. The wireless device may be configured with a value of the threshold, for example, via RRC.

The wireless device may implement a first mode/option and/or a second mode/option for wireless device-initiated beam reporting, such as UEIBR. The wireless device may implement the first mode/option (e.g., as shown in FIG. 20A), the second mode/option (e.g., as shown in FIG. 20B), or a combination of the first mode/option and the second mode/option (e.g., as shown in FIG. 20C) for UEIBR. The first mode/option (e.g., referred to as mode A) may comprise the wireless device requesting an uplink resource to send (e.g., transmit) a wireless device-initiated beam report, such as a UE-initiated beam report, and sending (e.g., transmitting) the wireless device-initiated beam report, such as the UE-initiated beam report, via a dynamically indicated uplink resource. The second mode/option (e.g., referred to as mode B) may comprise the wireless device using a pre-configured uplink resource to send (e.g., transmit) a wireless device-initiated beam report, such as a UE-initiated beam report. A beam report triggered by a wireless device (e.g., a wireless device-initiated beam report, such as a UE-initiated beam report) may be referred to (e.g., interchangeably referred to) as a wireless device-initiated CSI report, a UE-initiated CSI report, an event-driven CSI/beam report, a wireless device-triggered CSI/beam report, or a UE-triggered CSI/beam report.

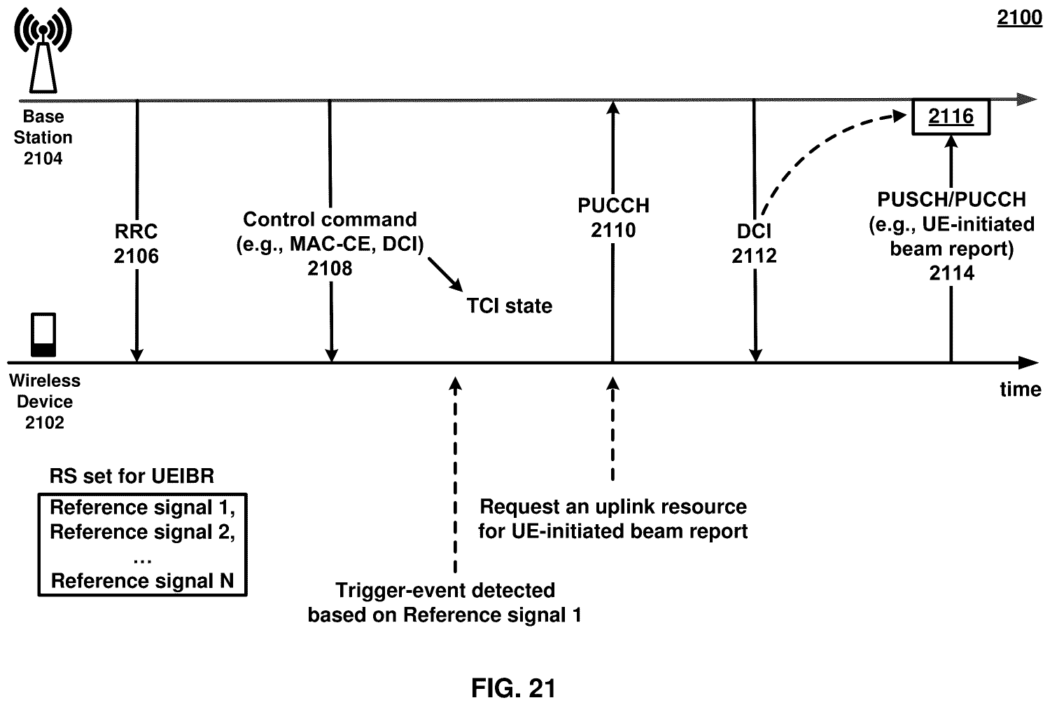

FIG. 21 shows an example of a first mode/option for wireless device-initiated beam reporting, such as user equipment (UE)-initiated beam reporting (UEIBR). A procedure 2100 may be used for a first mode/option for UEIBR, for example, comprising steps 2106, 2108, 2110, 2112, and 2114, as shown in FIG. 21. A wireless device 2102 may receive one or more configuration parameters (e.g., RRC) from a base station 2104, as shown at step 2106 in FIG. 21. The one or more configuration parameters may comprise/indicate a candidate reference signal (RS) set for UEIBR. The candidate RS set may comprise/indicate one or more candidate reference signals (e.g., 1, 2, . . . , N reference signals). The one or more configuration parameters may comprise/indicate one or more parameters (e.g., a threshold value, a maximum count value, etc.) for use by the wireless device 2102, for example, to detect a trigger-event (e.g., an event that triggers a CSI report according to UEIBR).

The wireless device 2102 may receive, from the base station 2104, a control command (e.g., MAC CE or DCI), as shown at step 2108 in FIG. 21. The control command may indicate a TCI state. The TCI state may be a unified TCI state (or a joint/downlink/uplink TCI state) or a joint/downlink TCI state. The indicated TCI state may be for use by wireless device 2102 for both downlink (e.g., PDSCH, PDCCH) and/or uplink transmissions (e.g., PUSCH, PUCCH). The wireless device 2102 may determine a current beam for receiving downlink transmissions and/or for sending (e.g., transmitting) uplink transmissions, for example, based on the indicated TCI state. The indicated TCI state may be one of a list/set of TCI states configured (e.g., configured as shown at step 2106 in FIG. 21) to the wireless device 2102. The control command may indicate a TCI state of the set of configured TCI states, for example, where/if the control command is a MAC CE. The control command may indicate an activated TCI state, of the set of configured TCI states, for example, where/if the control command is DCI. The activated TCI state may be a TCI state of a set of TCI states, among the list/set of configured TCI states, for example, activated by another command (e.g., a MAC CE) that follows (e.g., is subsequent to) step 2106.

The wireless device 2102 may monitor a radio link quality (e.g., L1-RSRP) of each candidate reference signal of the candidate RS set. The wireless device 2102 may monitor a radio link quality (e.g., L1-RSRP) of each candidate reference signal of the candidate RS set, for example, after or in response to step 2108 (e.g., shown in FIG. 21). The wireless device 2102 may compare the monitored radio link quality of each candidate reference signal to a radio link quality of a current reference signal. The current reference signal may correspond to the current beam used by the wireless device 2102.

The wireless device 2102 may be configured to detect a trigger-event (e.g., an event that triggers a CSI report according to UEIBR). The wireless device 2102 may be configured to detect a trigger-event, for example, if/when the radio link quality of at least one candidate reference signal of the candidate RS set becomes better than the radio link quality of the current reference signal by a threshold value (e.g., L1-RSRP of at least one candidate reference signal>threshold+L1-RSRP of the current reference signal). The wireless device 2102 may be configured to trigger a wireless device-initiated beam report, such as a UE-initiated beam report or an event driven beam report, for example, after or in response to detecting a trigger-event. The UE-initiated beam report may comprise a wireless device-initiated CSI report, such as a UE-initiated CSI report or an event driven CSI report. The wireless device 2102 may detect a trigger-event, for example, based on the radio link quality of a first candidate reference signal (e.g., reference signal 1) of the candidate RS set becoming better than the radio link quality of the current reference signal by the threshold value. The wireless device 2102 may trigger a UE-initiated beam report that indicates the first candidate reference signal, for example, based on detecting the trigger-event.

The wireless device 2102 may be configured to send (e.g., transmit) a first uplink transmission to the base station 2104 to request a resource for a second uplink transmission to carry the UE-initiated beam report. The wireless device 2102 may be configured to send (e.g., transmit) a first uplink transmission to the base station 2104 to request a resource for a second uplink transmission to carry the UE-initiated beam report, for example, after or in response to triggering a UE-initiated beam report. The first uplink transmission may comprise a PUCCH transmission, as shown at step 2110 in FIG. 21. The first uplink transmission may comprise a request, for example, that requests the resource for the second uplink transmission. The request may have a format similar to a scheduling request (SR). The request may be based on a new uplink control information (UCI) type. The requested resource may be a PUSCH resource and/or a PUCCH resource.

The wireless device 2102 may receive DCI indicating an uplink resource 2116 for the second uplink transmission, as shown at step 2112 in FIG. 21. The wireless device 2102 may receive DCI indicating an uplink resource 2116 for the second uplink transmission, for example, based on (e.g., in response to) the first uplink transmission at step 2110. The uplink resource 2116 may comprise a PUSCH resource and/or a PUCCH resource. The wireless device 2102 may send (e.g., transmit) the second uplink transmission via the uplink resource 2116, as shown at step 2114 in FIG. 21. The wireless device 2102 may send (e.g., transmit) the second uplink transmission via the uplink resource 2116, for example, after or in response to receiving the DCI at step 2112. The second uplink transmission may comprise the UE-initiated beam report indicating the first candidate reference signal.

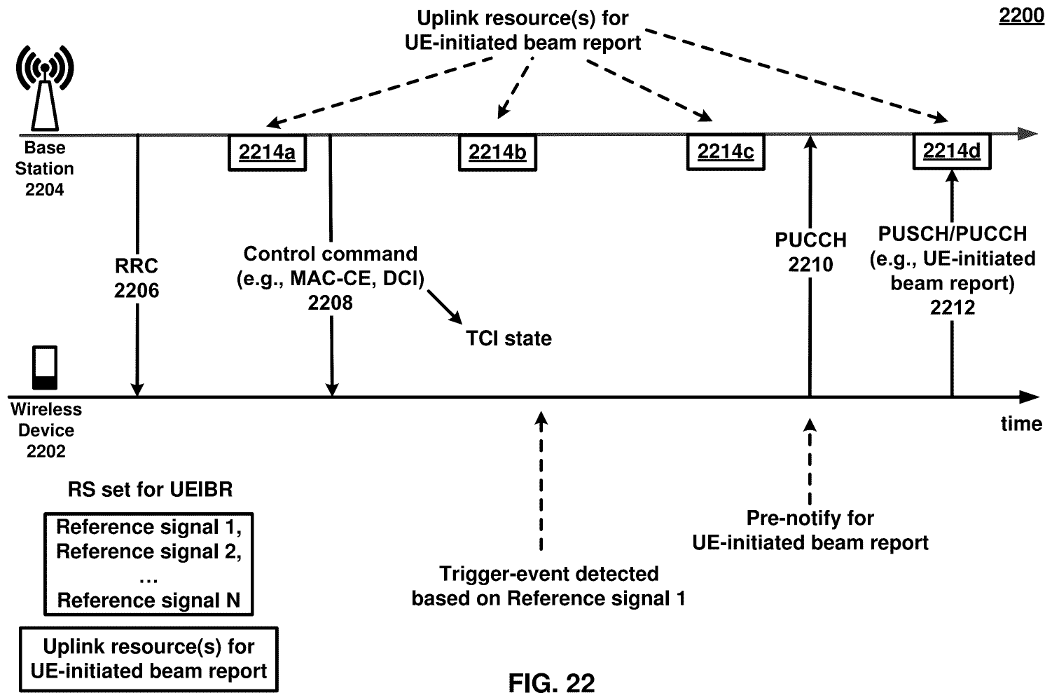

FIG. 22 shows an example of a second mode/option for wireless device-initiated beam reporting, such as UEIBR. A procedure 2200 may be used for a second mode/option for UEIBR, for example, comprising steps 2206, 2208, 2210, and 2212, as shown in FIG. 22. A wireless device 2202 may receive one or more configuration parameters (e.g., RRC) from a base station 2204, as shown at step 2206 in FIG. 22. The one or more configuration parameters may comprise/indicate a candidate reference signal (RS) set for UEIBR. The candidate RS set may comprise/indicate one or more candidate reference signals (e.g., 1, 2, . . . , N reference signals). The one or more configuration parameters may comprise/indicate one or more parameters (e.g., a threshold value, a maximum count value, etc.) for use by the wireless device 2202, for example, to detect a trigger-event (e.g., an event that triggers a CSI report according to UEIBR). The one or more configuration parameters may comprise/indicate one or more pre-configured uplink resource(s) for use by the wireless device 2202, for example, to send (e.g., transmit) wireless device-initiated beam reports, such as UE-initiated beam reports, to the base station 2204. The one or more configuration parameters may comprise/indicate uplink resources 2214a-2214d as pre-configured uplink resources for the wireless device 2202, for example, to send (e.g., transmit) UE-initiated beam reports. The uplink resources 2214a-2214d may comprise PUSCH resources and/or PUCCH resources. The uplink resources 2214a-2214d may comprise PUSCH resources of a Type 1 configured uplink grant.

The wireless device 2202 may receive a control command (e.g., a MAC CE or DCI), as shown at step 2208 in FIG. 22. The wireless device 2202 may receive a control command (e.g., a MAC CE or DCI), for example, from the base station 2204. The control command may indicate a TCI state. The TCI state may be a unified TCI state or a joint downlink/uplink TCI state. The indicated TCI state may be for use by the wireless device 2202 for both downlink (e.g., PDSCH, PDCCH) and uplink transmissions (e.g., PUSCH, PUCCH). The wireless device 2202 may determine a current beam for receiving downlink transmissions and/or for sending (e.g., transmitting) uplink transmissions, for example, based on the indicated TCI state. The indicated TCI state may be one of a set of TCI states configured (e.g., at step 2206) to the wireless device 2202. The control command may indicate a TCI state of the set of configured TCI states, for example, where/if the control command is a MAC CE. The control command may indicate an activated TCI state, of the set of configured TCI states, for example, where/if the control command is DCI. The activated TCI state may a TCI state of a set of TCI states, for example, activated by another command (e.g., MAC CE) that follows (e.g., is subsequent to) step 2206.

The wireless device 2202 may monitor a radio link quality (e.g., L1-RSRP) of each candidate reference signal of the candidate RS set. The wireless device 2202 may monitor a radio link quality (e.g., L1-RSRP) of each candidate reference signal of the candidate RS set, for example, after or in response to step 2208 (e.g., as shown in FIG. 22). The wireless device 2202 may compare the monitored radio link quality of each candidate reference signal to a radio link quality of a current reference signal. The current reference signal may correspond to the current beam used by the wireless device 2202.

The wireless device 2202 may be configured to detect a trigger-event (e.g., an event that triggers a CSI report according to UEIBR). The wireless device 2202 may be configured to detect a trigger-event (e.g., an event that triggers a CSI report according to UEIBR), for example, if/when the radio link quality of at least one candidate reference signal of the candidate RS set becomes better than the radio link quality of the current reference signal by a threshold value (e.g., L1-RSRP of at least one candidate reference signal>threshold+L1-RSRP of the current reference signal). The wireless device 2202 may be configured to trigger a UE-initiated (or event driven) beam report, for example, after or in response to detecting a trigger-event. The UE-initiated beam report may comprise a wireless device-initiated CSI report, such as a UE-initiated CSI report or an event driven CSI report. The wireless device 2202 may detect a trigger-event, for example, based on the radio link quality of a first candidate reference signal (e.g., reference signal 1) of the candidate RS set becoming better than the radio link quality of the current reference signal by the threshold value. The wireless device 2202 may trigger a UE-initiated beam report that indicates the first candidate reference signal, for example, based on detecting the trigger-event.

The wireless device 2202 may be configured to send (e.g., transmit) a first uplink transmission to the base station 2204. The wireless device 2202 may be configured to send (e.g., transmit) a first uplink transmission to the base station 2204, for example, after or in response to triggering a UE-initiated beam report. The wireless device 2202 may be configured to send (e.g., transmit) a first uplink transmission to the base station 2204, for example, to notify of a second uplink transmission that will carry the UE-initiated beam report. The first uplink transmission may comprise a PUCCH transmission, as shown at step 2210 in FIG. 22. The first uplink transmission may comprise a notification that indicates an uplink resource, of the pre-configured uplink resources. The indicated uplink resource may be used by the wireless device 2202 for the second uplink transmission. The notification may have a format similar to an SR. The notification may be based on a new uplink control information (UCI) type. The notification may indicate uplink resource 2214d, of the uplink resources 2214a-2214d, for the second uplink transmission.

The wireless device 2202 may send (e.g., transmit) the second uplink transmission via the uplink resource 2214d, as shown at step 2212 in FIG. 22. The wireless device 2202 may send (e.g., transmit) the second uplink transmission via the uplink resource 2214d, for example, after notifying the second uplink transmission. The second uplink transmission may comprise the UE-initiated beam report indicating the first candidate reference signal. The uplink resource 2214d may be a starting/earliest/first uplink resource, among the pre-configured uplink resources, for example, that occurs after the first uplink transmission. The uplink resource 2214d may be a starting/earliest/first uplink resource, among the pre-configured uplink resources, for example, that occurs after a last/final repetition of the first uplink transmission. The uplink resource 2214d may be a starting/earliest/first uplink resource, among the pre-configured uplink resources, for example, that occurs a time offset after the first uplink transmission. The uplink resource 2214d may be a starting/earliest/first uplink resource, among the pre-configured uplink resources, for example, that occurs a time offset after a last/final repetition of the first uplink transmission. The time offset may be configured by an RRC message.

A wireless device (e.g., the wireless device 2102 and/or the wireless device 2202) may be configured to detect a trigger-event and/or to trigger a wireless device-initiated beam report, such as a UE-initiated beam report (e.g., in both a first mode/option and a second mode/option for wireless device-initiated beam reporting, such as UEIBR). The wireless device may be configured to detect a trigger-event and/or to trigger a UE-initiated beam report, for example, if/when the radio link quality of at least one candidate reference signal of the candidate RS set becomes better than the radio link quality of the current reference signal by a threshold value (e.g., L1-RSRP of at least one candidate reference signal>threshold+L1-RSRP of the current reference signal). Measurements obtained from layer-1 (e.g., L1-RSRP) may be highly volatile (e.g., due to fast fading caused by multipath interference and other factors). The trigger condition (e.g., the trigger-event) described herein may result in the network reacting directly to short-term variations, for example, without filtering the measurements obtained from layer-1. The network reacting directly to short term variations may lead to an undesirable ping-pong effect (e.g., with frequent TCI state updates, TCI state activations, and/or beam updates).

Examples described herein may improve wireless device initiated beam reporting, such as UEIBR. UEIBR may comprise a similar triggering mechanism used in at least some beam failure recovery (BFR) procedures, for example, to reduce the ping-pong effect. A trigger-event may be detected (and a wireless device-initiated beam report, such as a UE-initiated beam report, may be triggered), for example, if/when a number of/quantity of consecutive layer-1 measurements exceeds (e.g., is greater than) a network-configured maximum value. Detecting the trigger-event if/when a number of/quantity of consecutive layer-1 measurements exceeds (e.g., is greater than) a network-configured maximum value may smooth out rapid fluctuations, for example, reducing unnecessary/frequent beam reporting and/or ensuring that the beam report provides a more stable view of beam quality.

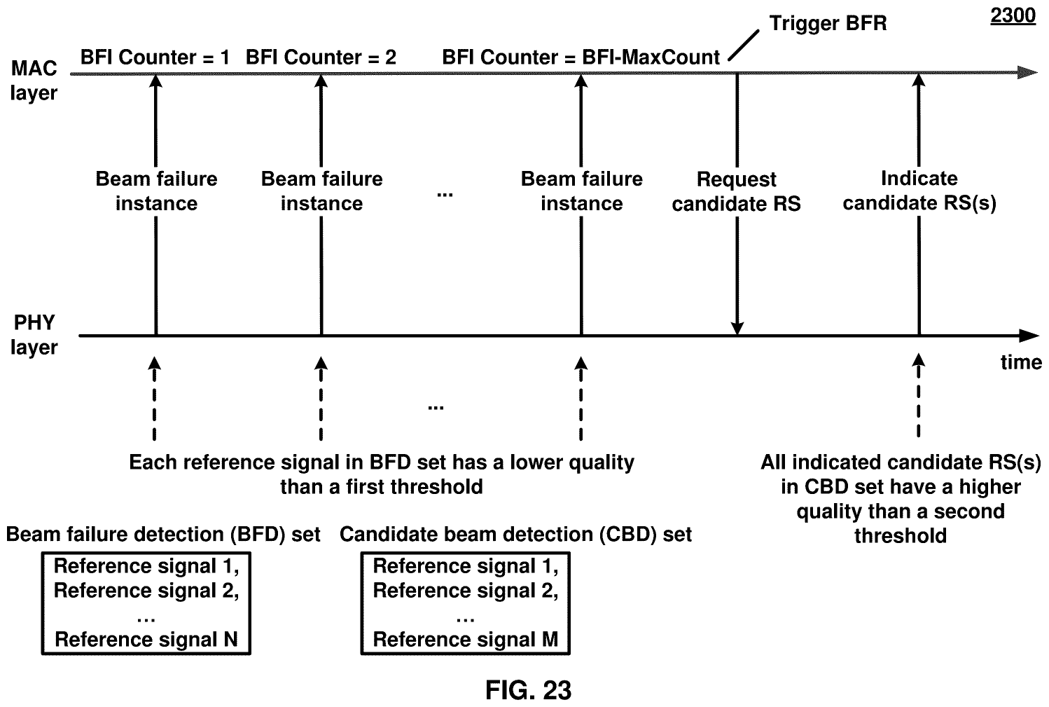

FIG. 23 shows an example for beam failure recovery. A procedure 2300 may be used by a wireless device to trigger BFR. The wireless device may receive, from a base station, one or more configuration parameters for use by the wireless device, for example, to detect an event that triggers a BFR by the wireless device (e.g., before the procedure 2300).

The one or more configuration parameters may comprise/indicate, for a BWP of a cell (e.g., a serving cell), a first parameter (e.g., failureDetectionResourcesToAddModList). The first parameter (e.g., failureDetectionResourcesToAddModList) may indicate a beam failure detection (BFD) set (e.g., q̅₀). The BFD set may indicate/comprise periodic CSI-RS resource configuration index(es) for radio link quality measurements on the BWP of the serving cell. A BFD set may be (or may be interchangeably used with) a BFD-RS set.

The one or more configuration parameters may comprise/indicate, for the BWP of the cell (e.g., the serving cell), a second parameter (e.g., candidateBeamRSList or candidateBeamRSListExt or candidateBeamRSSCellList). The second parameter (e.g., candidateBeamRSList or candidateBeamRSListExt or candidateBeamRSSCellList) may indicate a candidate beam detection (CBD) set (e.g., q̅₁). The CBD set may indicate/comprise respective periodic CSI-RS resource configuration index(es) and/or SS/PBCH block index(es) for radio link quality measurements on the BWP of the serving cell.

The one or more configuration parameters may comprise/indicate a third parameter (e.g., beamFailureInstanceMaxCount). The third parameter (e.g., beamFailureInstanceMaxCount) may indicate, for the cell, a beam failure instance maximum counter value. The beam failure instance maximum counter value may indicate/determine a minimum number of beam failure instances that the wireless device should detect, for example, before triggering BFR for the cell.

The one or more configuration parameters may comprise/indicate a fourth parameter (e.g., beamFailureDetectionTimer). The fourth parameter (e.g., beamFailureDetectionTimer) may indicate, for the cell, a beam failure detection timer value. The wireless device may start/restart a timer for each beam failure instance, for example, based on the beam failure detection timer value. The wireless device may reset a counter of beam failure instances, for example, if/when the timer expires.

The wireless device may implement the BFR procedure (e.g., the procedure 2300). The wireless device may implement the BFR procedure (e.g., the procedure 2300), for example, after or in response to receiving the one or more configuration parameters. A lower layer (e.g., PHY layer) of the wireless device may assess a radio link quality of each reference signal of the BFD set against a first threshold (e.g., Q_{out,LR}). The lower layer may assess the radio link quality, for example, (e.g., only or exclusively) according to SS/PBCH blocks on the PCell or the PSCell or periodic CSI-RS resource configurations that are QCL'd with the DM-RS of PDCCH receptions by the wireless device. The wireless device may use/apply a second threshold (e.g., Q_{in,LR}) to an L1-RSRP measurement obtained from a SS/PBCH block. The wireless device may use/apply the second threshold (e.g., Q_{in,LR}) to the L1-RSRP measurement obtained for a CSI-RS resource, for example, after or in response to scaling a respective CSI-RS reception power with a value provided by a higher layer parameter (e.g., powerControlOffsetSS). The first threshold (e.g., Q out, LR) and the second threshold (e.g., Q_{in,LR}) may correspond to a default value of a higher layer parameter (e.g., rImInSyncOutOfSyncThreshold for Qₒᵤₜ) and to a value provided by a higher layer parameter (e.g., rsrp-ThresholdSSB) or a higher layer parameter (e.g., rsrp-ThresholdBFR), respectively.

The lower layer of the wireless device may send (e.g., transmit), to an upper layer (e.g., a MAC layer or an RRC layer) of the wireless device, a beam failure instance (BFI) indication, as shown in FIG. 23. The lower layer of the wireless device may send (e.g., transmit), to an upper layer (e.g., a MAC layer or an RRC layer) of the wireless device, a beam failure instance (BFI) indication, for example, if/when the radio link quality of each reference signal of the BFD set is worse/lower than the first threshold. The lower layer may send (e.g., transmit) BFI indications to the upper layer, for example, according to a periodicity. The lower layer may send (e.g., transmit) BFI indications to the higher layer (e.g., in a non-DRX mode operation) with a periodicity determined by the maximum between: a shortest periodicity among the SS/PBCH blocks on the PCell or the PSCell and/or the periodic CSI-RS configurations in the BFD set and a predefined duration (e.g., 2 milliseconds).

The upper layer may start a timer and increment (e.g., to 1) a BFI counter used for counting BFI indications (e.g., by 1). The upper layer may start a timer and increment (e.g., to 1) a BFI counter used for counting BFI indications (e.g., by 1), for example, based on receiving a first BFI indication from the lower layer. The upper layer may start the timer, for example, based on the beam failure detection timer value. The timer may be configured, for example, to count down from the beam failure detection timer value to zero or to count up from zero to the beam failure detection timer value. The upper layer may restart the timer based on the beam failure detection timer value and increment the BFI counter (e.g., by 1), for example, at every/each subsequent BFI indication received from the lower layer. The upper layer may reset the BFI counter to zero, for example, if the timer expires. The upper layer may trigger BFR, for example, if the BFI counter reaches the beam failure instance maximum counter value.

The upper layer may send, to the lower layer, a request for a candidate reference signal from the CBD set. The upper layer may send, to the lower layer, a request for a candidate reference signal (RS) from the CBD set, for example, if/when BFR is triggered. The lower layer may respond to the request from the upper layer, for example, by indicating to the upper layer one or more candidate reference signals (RS(s)) from the CBD set. Each of the one or more candidate reference signals (RS(s)) may have a radio link quality higher than a second threshold.

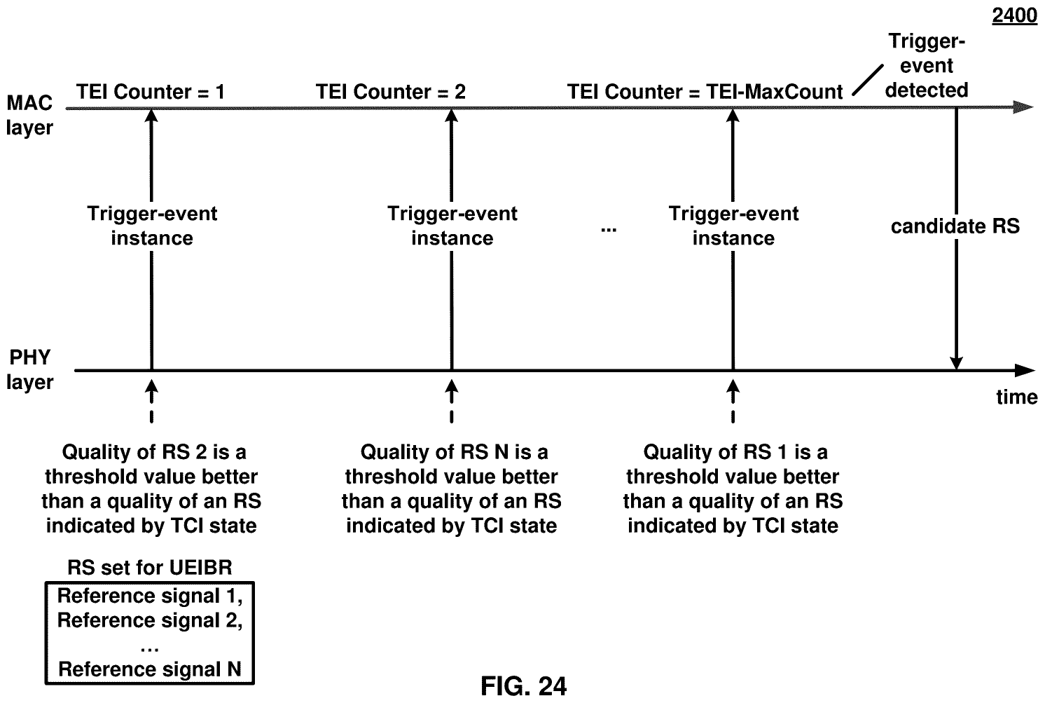

FIG. 24 shows an example for triggering a wireless device-initiated beam report, such as a UE-initiated beam report. A procedure 2400 (e.g., an example procedure) may be used by a wireless device to trigger the UE-initiated beam report. The procedure 2400 may use a triggering mechanism similar to the BFR procedure (e.g., the procedure 2300 shown in FIG. 23).

The wireless device may receive, from a base station, one or more configuration parameters (e.g., RRC parameters). The wireless device may receive, from a base station, one or more configuration parameters (e.g., RRC parameters), for example, before using the procedure 2400. The one or more configuration parameters (e.g., RRC parameters) may be used by the wireless device to detect an event that triggers a UE-initiated beam report by the wireless device. The one or more configuration parameters may comprise/indicate a candidate reference signal (RS) set for wireless device-initiated beam reporting, such as UEIBR. The candidate RS set may comprise/indicate one or more candidate reference signals (e.g., 1, 2, . . . , N candidate reference signals).

The one or more configuration parameters may comprise/indicate one or more parameters. The one or more parameters may be used by the wireless device to detect a trigger-event (e.g., an event that triggers a CSI report according to UEIBR). The one or more configuration parameters may comprise/indicate a first parameter, for example, that indicates a trigger-event instance maximum counter value. The trigger-event instance maximum counter value may indicate/determine a minimum number of trigger-event instances that the wireless device may/should count, for example, before triggering a UE-initiated beam report. A counter of the trigger-event instances may reach the trigger-event instance maximum counter value, for example, to trigger a UE-initiated beam report. The one or more configuration parameters may comprise/indicate a second parameter, for example, that indicates a trigger-event detection timer value. The wireless device may start/restart a timer based on the trigger-event detection timer value, for example, at each trigger-event instance. The wireless device may reset the counter of the trigger-event instances, for example, if the timer expires.

The wireless device may implement the procedure 2400. The wireless device may implement the procedure 2400, for example, after or in response to receiving the one or more configuration parameters. A lower layer (e.g., a PHY layer) of the wireless device may assess a radio link quality of each candidate reference signal of the candidate RS set, for example, against a radio link quality of a current reference signal. The current reference signal may correspond to a current beam used by the wireless device. The current beam may be a beam corresponding to a last TCI state indicated to the wireless device. The current reference signal may be (e.g., implicitly) derived from a QCL RS of the indicated TCI state. The lower layer may determine, for each candidate reference signal, whether/if a radio link quality of the candidate reference signal is better than a radio link quality of the current reference signal by a threshold value (e.g., L1-RSRP of at least one candidate reference signal>threshold+L1-RSRP of the current reference signal), for example, with a pre-determined periodicity.

The lower layer may send, to an upper layer (e.g., a MAC layer or an RRC layer) of the wireless device, a trigger-event instance (TEI) indication. The lower layer may send, to an upper layer (e.g., a MAC layer or an RRC layer) of the wireless device, a trigger-event instance (TEI) indication, for example, if/when the radio link quality of at least one reference signal of the candidate RS set is better than the radio link quality of the current reference signal by the threshold value. The TEI indication may indicate the at least one reference signal of the candidate RS. The lower layer may send (e.g., transmit) to the upper layer: a first TEI indication, for example, after or in response to determining that a radio link quality of a first reference signal (e.g., RS 2) of the candidate RS is better than the radio link quality of the current reference signal by the threshold value (e.g., as shown in FIG. 24); a second TEI indication, for example, after or in response to determining that a radio link quality of a second reference signal (e.g., RSN) of the candidate RS is better than the radio link quality of the current reference signal by the threshold value (e.g., as shown in FIG. 24); and a k-th TEI indication, for example, after or in response to determining that a radio link quality of a third reference signal (e.g., RS 1) of the candidate RS is better than the radio link quality of the current reference signal by the threshold value (e.g., as shown in FIG. 24).

The upper layer may receive, from the lower layer, TEI indications, as shown in FIG. 24. The upper layer may start a timer based on the trigger-event detection timer value and increment (e.g., to 1) a TEI counter used for counting TEI indications, for example, based on receiving the first TEI indication from the lower layer. The upper layer may restart the timer (e.g., based on the same value) and increment the TEI counter (e.g., by one), for example, at every subsequent TEI indication received from the lower layer. The upper layer may reset the TEI counter to zero, for example, if the timer expires. The upper layer may detect a trigger-event and trigger a UE-initiated beam report, for example, if the TEI counter reaches the trigger-event instance maximum counter value. The upper layer may send, to the lower layer, a candidate RS of the candidate RS set for transmission in a beam report to the base station, for example, after or in response to triggering a UE-initiated beam report. The candidate RS may be reference signal associated with the last received TEI indication before the triggering of the UE-initiated beam report.

The example procedure (e.g., the procedure 2400 shown in FIG. 24) may use/comprise a single TEI counter and a single timer for trigger-event detection. The reference signals of the candidate RS set may experience/comprise similar large-scale channel properties. The reference signals of the candidate RS set may be QCL'd such that it can be (e.g., reasonably) assumed that the radio link quality of a first reference signal of the candidate RS set is better than the radio link quality of the current reference signal, for example, if/when the radio link quality of a second reference signal of the candidate RS set is better than the radio link quality of the current reference signal. This assumption may be acceptable in some examples (e.g., for a single transmission point (TP)). This assumption may lead to the wireless device triggering UE-initiated beam reports that report, to the base station, candidate reference signals that are sub-optimal or of a lower radio link quality than the current reference signal, for example, in other examples (e.g., coordinated multipoint CoMP). The TEI counter may reach the trigger-event instance maximum counter value without having a single candidate reference signal that is consistently better (e.g., in terms of radio link quality) than the current reference signal, for example, with the procedure 2400 using a single TEI counter that is incremented for each TEI indication from the lower layer. The UE-initiated beam report may indicate a candidate reference signal that is, for example, only transiently better than the current reference signal. The procedure 2400 may, for example, suffer from the same undesirable ping-pong effect described herein.

Examples described herein may include improved methods for triggering a wireless device-initiated beam report, such as a UE-initiated beam report. Examples described herein may include improved methods for triggering a UE-initiated beam report, for example, to address the problem of at least some wireless communications (e.g., the undesirable ping-pong effect described herein). A wireless device may receive one or more configuration parameters for detecting an event that triggers a CSI/beam report by the wireless device. The one or more configuration parameters may comprise/indicate: a list of reference signals; one or more timer values, for example, where each timer value of the timer values is associated with a respective reference signal in the list of reference signals; a maximum instance count value; and a threshold value. The wireless device may increment a counter associated with the first reference signal, for example, based on a first radio link quality of a first reference signal of the list of reference signals satisfying a condition. The condition may comprise the first radio link quality of the first reference signal being better (e.g., by the threshold value) than a second radio link quality of a second reference signal. The second reference signal may be a reference signal indicated by a TCI state. The wireless device may trigger a first CSI report indicating the first reference signal, for example, based on a counter associated with the first reference signal reaching the maximum instance count value. The wireless device may support a UE-initiated beam report triggering mechanism for each reference signal of a list of candidate reference signals. The wireless may trigger a UE-initiated beam report indicating a candidate reference signal, for example, only if/when the same reference signal has been consistently better than the current reference signal. The examples described herein (e.g., the improved methods for triggering a UE-initiated beam report) may drastically reduce the ping-pong effect described herein.

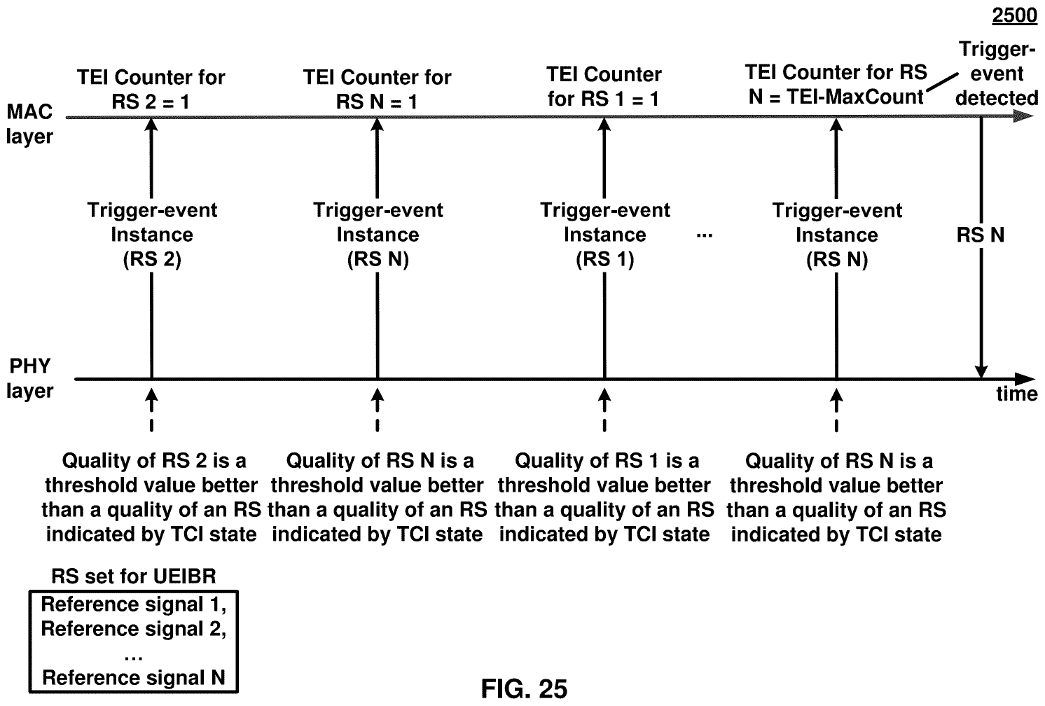

FIG. 25 shows an example for triggering a wireless device-initiated beam report, such as a UE-initiated beam report. A procedure 2500 may be used by a wireless device to trigger a wireless device-initiated report, such as a UE-initiated beam report. The wireless device may, for example, be/comprise the wireless device 1702 (e.g., shown in FIG. 17), the wireless device 2102 (e.g., shown in FIG. 21), or the wireless device 2202 (e.g., shown in FIG. 22).

The wireless device may send (e.g., transmit), to a base station, one or more messages (e.g., wireless device capability messages, UECapabilityInformation). The wireless device may send (e.g., transmit), to a base station, one or more messages (e.g., wireless device capability messages, UECapabilityInformation), for example, before using procedure 2500. The one or more messages (e.g., the wireless device capability messages, UECapabilityInformation) may comprise/indicate one or more parameters for wireless device-initiated reporting, such as UEIBR. The wireless device (e.g., the wireless device 2102 shown in FIG. 21) may send (e.g., transmit) the one or more messages, for example, before step 2106 of the procedure 2100 shown in FIG. 21. The wireless device (e.g., the wireless device 2202 shown in FIG. 22) may send (e.g., transmit) the one or more messages, for example, before step 2206 of the procedure 2200 shown in FIG. 22. The one or more messages may comprise/indicate one or more of:
A first parameter (e.g., maxNumberCSI-RS-SSB-EBD, maxNumberCSI-RS-SSB-UEIBR, maxNumberCSI-RS-SSB-TED, maxNumberCSI-RS-EBD, maxNumberCSI-RS-UEIBR, maxNumberCSI-RS-TED maxNumberSSB-EBD, maxNumberSSB-UEIBR, maxNumberSSB-TED), for example, indicating a maximum/maximal number of different reference signal resources (e.g., CSI-RS resources and/or SSB resources) for new/candidate beam/RS identifications for/associated with a CSI/beam report triggered by the wireless device (where EBD stands for event-based detection and TED stands for trigger-event detection). The first parameter may indicate the maximum/maximal number of different candidate reference signals that the wireless device can simultaneously assess for UEIBR. The first parameter may indicate a maximum/maximal number of timers and/or counters that the wireless device can simultaneously maintain/store for UEIBR. The maximal/maximal number indicated by the first parameter may be across all cells and/or across both a master cell group (MCG) and a secondary cell group (SCG).
A second parameter (e.g., maxNumberCellEBD, maxNumberCellTED, maxNumberCellUEIBR), for example, indicating a maximum number of cells (e.g., SCells only, SCells plus SpCell/PC ell, or all cells) configured for a CSI/beam report triggered by the wireless device. The second parameter may indicate the maximum number of cells that the wireless device can simultaneously support for UEIBR. The one or more messages may comprise/indicate the first parameter, for example, based on the one or more messages comprising/indicating the second parameter.
A third parameter (e.g., maxED-RS-resourcesPerBWP, maxED-RS-resourcesPerBWPPerReportConfig), for example, indicating a maximum supported number of reference signals per BWP for UEIBR. The third parameter may indicate the maximum/maximal number of different candidate reference signals that the wireless device can simultaneously assess per BWP for UEIBR. The third parameter may indicate the maximum/maximal number of timers and/or counters that the wireless device can simultaneously maintain/store per BWP for UEIBR.
A fourth parameter (e.g., rlm-BM-BFD-CSI-RS-OutsideActiveBWP), for example, indicating if/whether the wireless device supports radio link monitoring (RLM)/beam management (BM)/beam failure detection (BFD) measurements based on CSI-RS, if/when cell defining (CD)-SSB is outside active downlink BWP. A wireless device supporting RLM/BM/BFD measurements based on CSI-RS, if/when CD-SSB is outside active downlink BWP, may indicate support of the first parameter. A wireless device supporting RLM/BM/BFD measurements based on CSI-RS, if/when CD-SSB is outside active downlink BWP, may indicate the first parameter.
A fifth parameter (e.g., maxTotalResourcesForAcrossFreqRanges), for example, indicating a maximum total number of SSB/CSI-RS/CSI-IM resources for beam management, pathloss measurement, BFD, RLM, and new beam identification across frequency ranges (e.g., both FR1 and FR2) that the wireless device supports. If/when configuring/indicating the wireless device with SSB/CSI-RS/CSI-IM resources for beam management, pathloss measurement, BFD, RLM, and new beam identification across frequency ranges, the base station may support/consider/account for the fifth parameter and the first parameter. The base station may configure the wireless device with SSB/CSI-RS/CSI-IM resources for beam management, pathloss measurement, BFD, RLM, and new beam identification across frequency ranges, for example, based on the fifth parameter and the first parameter.
A sixth parameter (e.g. maxTotalResourcesForOneFreqRange), for example, indicating a maximum total number of SSB/CSI-RS/CSI-IM resources for beam management, pathloss measurement, BFD, RLM, EBD and new beam identification for one frequency range that the wireless device supports. If/when configuring/indicating the wireless device with SSB/CSI-RS/CSI-IM resources for beam management, pathloss measurement, BFD, RLM, and new beam identification across one frequency range, the base station may support/consider/account for the sixth parameter and the first parameter. The base station may configure the wireless device with SSB/CSI-RS/CSI-IM resources for beam management, pathloss measurement, BFD, RLM, and new beam identification across one frequency range, for example, based on the sixth parameter and the first parameter.

The wireless device may receive (e.g., from the base station) a wireless device capability enquiry message (e.g., UECapabilityEnquiry). The wireless device may send (e.g., transmit), to the base station, the one or more messages (e.g., the wireless device capability messages, UECapabilityInformation), for example, based on receiving the wireless device capability enquiry message.

The wireless device may receive, from a base station, one or more configuration parameters (e.g., RRC) for use by the wireless device for UEIBR. The wireless device may receive, from a base station, one or more configuration parameters (e.g., RRC) for use by the wireless device for UEIBR, for example, before using procedure 2500. The one or more configuration parameters may comprise/indicate one or more of:
A list/set of reference signals (e.g., candidate reference signals or reference signal indexes). The list/set of reference signals may comprise (e.g., up to) a number of/quantity of reference signals. The number of/quantity of reference signals may be fixed (e.g., 2) or as indicated by the third parameter sent (e.g., transmitted) by the wireless device to the base station.
One or more timer values (e.g., trigger-event detection timer values). The one or more configuration parameters may comprise/indicate a respective timer value for each reference signal in the list/set of reference signals. The one or more configuration parameters may comprise/indicate a single timer value for all reference signals in the list/set of reference signals.
One or more maximum TEI counter values (e.g., trigger-event instance maximum counter values). The one or more configuration parameters may comprise/indicate a respective maximum TEI counter value for each reference signal in the list/set of reference signals. The one or more configuration parameters may comprise/indicate a single maximum TEI counter value for all reference signals in the list/set of reference signals.
One or more threshold values. The one or more configuration parameters may comprise/indicate a respective threshold value for each reference signal in the list/set of reference signals. The one or more configuration parameters may comprise/indicate a single threshold value for all reference signals in the list/set of reference signals.

The one or more configuration parameters may be configured using a CSI report configuration (e.g., CSI-ReportConfig, UEIBR-ReportConfig) in an RRC message. The CSI report configuration may comprise one or more of:
One or more event-detection/triggeringInstanceMaxCount parameters for indicating the one or more maximum TEI counter values. The CSI report configuration may indicate an event-detection/triggeringInstanceMaxCount parameter per serving cell, per reference signal (RS) per serving cell, or per event-detection (ED)-RS set (e.g., RS set or candidate RS set for trigger-event detection) of a serving cell configured with two RS sets.

One or more event-detection/triggeringTimer parameters for indicating the one or more timer values. The CSI report configuration may indicate an event-detection/triggeringTimer parameter per serving cell, per RS per serving cell, per ED-RS set of a serving cell configured with two ED-RS sets, or per RS of an ED-RS set of a serving cell configured with two ED-RS sets.
One or more rsrp-Threshold-UEIBR parameters for indicating the one or more threshold values. The CSI report configuration may indicate an rsrp-Threshold-UEIBR parameter per serving cell, per RS per serving cell, or per ED-RS set of a serving cell configured with two ED-RS sets.
One or more sinr-Threshold-UEIBR parameters for indicating one or more SINR threshold values. The CSI report configuration may indicate a sinr-Threshold-UEIBR parameter per serving cell, per RS per serving cell, or per ED-RS set of a serving cell configured with two ED-RS sets.
A candidateBeamRS-List parameter (or csi-RS-ResourceSetList parameter or nzp-CSI-RS-ResourceSetList parameter or csi-SSB-ResourceSetList parameter or eventDetectionResourcesToAddModList parameter or eventDetectionSet1 parameter) for indicating the list/set of reference signals (e.g., candidate reference signals). The list/set of reference signals (e.g., candidate reference signals) indicated by the candidateBeamRS-List parameter may be for a serving cell or for a first ED-RS set of a serving cell configured with two ED-RS sets.
A candidateBeamRS-List2 (or csi-RS-ResourceSetList2 parameter or nzp-CSI-RS-ResourceSetList2 parameter or csi-SSB-ResourceSetList2 parameter or eventDetectionSet2 parameter) for indicating a list/set of reference signals (e.g., candidate reference signals) for a second ED-RS set of a serving cell configured with two ED-RS sets.
A CSI resource parameter (e.g., resourcesForChannelMeasurement, nzp-CSI-RS-ResourcesForInterference, csi-IM-ResourcesForInterference, or CSI-ResourceConfigId) for indicating the list/set of reference signals. The CSI resource parameter may be used with the candidateBeamRS-List parameter to indicate the list/set of reference signals.
A report configuration type parameter set that indicates a time domain reporting configuration. The report configuration type parameter may be set to a first value (e.g., ‘event triggered’ or ‘UE-initiated’), for example, for UEIBR.
A CSI resource configuration identifier/index (e.g., CSI-ResourceConfigId), for example, identifying a CSI resource configuration (e.g., CSI-ResourceConfig). The CSI resource configuration (e.g., CSI-ResourceConfig) may indicate a list of CSI-RS resource sets (e.g., csi-RS-ResourceSetList). The CSI resource configuration (e.g., CSI-ResourceConfig) may comprise the candidateBeamRS-List parameter (or csi-RS-ResourceSetList parameter or nzp-CSI-RS-ResourceSetList parameter), for example, indicating the list/set of reference signals (e.g., candidate reference signals). The list of CSI-RS resource sets may indicate/correspond to the list/set of reference signals (e.g., candidate reference signals) or may be a part of the list/set of reference signals (e.g., candidate reference signals). If/when the report configuration type parameter is set to ‘event-triggered’ or ‘UE-initiated’, the list of CSI-RS resource sets may comprise a single CSI-RS resource set. If/when the report configuration type parameter is set to ‘event-triggered’ or ‘UE-initiated’ and groupBasedBeamReporting is not configured in the CSI report configuration (e.g., CSI-ReportConfig), the list of CSI-RS resource sets may comprise a single CSI-RS resource set. If/when the report configuration type parameter is set to ‘event-triggered’ or ‘UE-initiated’ and groupBasedBeamReporting is configured in the CSI report configuration (e.g., CSI-ReportConfig), the list of CSI-RS resource sets may comprise two CSI-RS resource sets (e.g., two NZP CSI-RS resource sets). A first CSI-RS resource set of the two CSI-RS resource sets may comprise/indicate the list/set of reference signals (e.g., candidate reference signals) for the first ED-RS set. A second CSI-RS resource set of the two CSI-RS resource sets may comprise/indicate the list/set of reference signals (e.g., candidate reference signals) for the second ED-RS set.

The wireless device may be provided, for each BWP of a serving cell, a set l̅₀ of CSI-RS resource configuration indexes and/or SS/PBCH block indexes by the parameter candidateBeamRS-List. The wireless device may be provided, for each BWP of a serving cell, a set l̅₀ of CSI-RS resource configuration indexes and/or SS/PBCH block indexes by the parameter candidateBeamRS-List, for example, for radio link quality measurements for UEIBR on the BWP of the serving cell. The set l̅₀ may correspond to the list/set of reference signals (e.g., candidate reference signals).

If the wireless device is not provided l̅₀ by the parameter candidateBeamRS-List for a BWP of the serving cell, the wireless device may determine the set l̅₀ to comprise CSI-RS resource configuration indexes with same values as the RS indexes in the RS sets indicated by activated TCI state(s) (e.g., TCI-State). If a number of/quantity of active TCI states is larger than two (or the third parameter (e.g., maxED-RS-resourcesPerBWP, maxED-RS-resourcesPerBWPPerReportConfig)), the wireless device may determine the set l̅₀ to comprise periodic CSI-RS resource configuration indexes with same values as the RS indexes in the RS sets associated with the active TCI state(s) (e.g., TCI-State) according to, for example, an ascending order of TCI state identifiers (e.g., TCI-StateId's) (or TCI codepoints). The wireless device may expect the set l̅₀ to comprise up to two RS indexes (or up to a number of/quantity of N_{ED} RS indexes indicated by the third parameter (e.g., maxED-RS-resourcesPerBWP,maxED-RS-resourcesPerBWPPerReportConfig)).

The wireless device may be provided two sets l̅₀ and l̅₁ of CSI-RS resource configuration indexes and/or SS/PBCH block indexes by the parameters candidateBeamRS-List and candidateBeamRS-List2. The set l̅₀ may be associated with a first indicated TCI state. The set l̅₀ may be associated with a second indicated TCI state. The first/second TCI state may be indicated by a MAC CE or DCI. The first TCI state may be associated with a first TRP. The second TCI state may be associated with a second TRP. The wireless device may use the set l̅₀ for UEIBR for the first TRP. The wireless device may use the set l̅₀ for UEIBR for the second TRP.

The wireless device may implement the procedure 2500. The wireless device may implement procedure 2500, for example, after or in response to receiving the one or more configuration parameters. A lower layer (e.g., a PHY layer) of the wireless device may assess/determine a first radio link quality of a first reference signal of the list/set of reference signals, for example, to determine if the first radio link quality of the first reference signal satisfies a condition. The condition may comprise the first radio link quality of the first reference signal being better than a second radio link quality of a second reference signal. The condition may comprise the first radio link quality of the first reference signal being better, by a threshold value, than the second radio link quality of a second reference signal. The second reference signal may correspond to a current beam used by the wireless device. The current beam may be a beam corresponding to a last TCI state indicated to the wireless device. The TCI state may be indicated as described herein with reference to FIG. 17 (e.g., using MAC CE at step 1708 of the procedure 1700 or using DCI at step 1710 of the procedure 1700). The current reference signal may be (e.g., implicitly) derived from a QCL RS (or a QCL RS with QCL-Type D) of the indicated TCI state. The second reference signal may be a CSI-RS. The first radio link quality of the first reference signal being better than the second radio link quality of the second reference signal may comprise an L1-RSRP measurement of the first reference signal being greater than an L1-RSRP measurement of the second reference signal by a threshold value. The first radio link quality of the first reference signal being better than the second radio link quality of the second reference signal may comprise a signal-to-interference-plus-noise ratio (SINR) of the first reference signal being greater than an SINR of the second reference signal by a threshold value.

The lower layer may assess the radio link quality of each reference signal of the list/set of reference signals. The lower layer may assess the radio link quality of each reference signal of the list/set of reference signals, for example, to determine if the radio link quality of the reference signal satisfies the condition. The lower layer may send (e.g., transmit) to an upper layer (e.g., a MAC layer or an RRC layer) of the wireless device a TEI indication, indicating a reference signal (or an index thereof) of the list/set of reference signals, for example, if/when the radio link quality of the reference signal satisfies the condition. The lower layer may send (e.g., transmit) to the upper layer: a first TEI indication, for reference signal RS 2, for example, after or in response to determining that a radio link quality of the reference signal RS 2 satisfies the condition (e.g., is better than the radio link quality of the current reference signal by the threshold value) (e.g., as shown in FIG. 25); a second TEI indication, for reference signal RS N, for example, after or in response to determining that a radio link quality of the reference signal RS N satisfies/meets the condition (e.g., as shown in FIG. 25); a third TEI indication, for reference signal RS 1, for example, after or in response to determining that a radio link quality of the reference signal RS 1 satisfies/meets the condition (e.g., as shown in FIG. 25); and a k-th TEI indication, for the reference signal RS N, for example, after or in response to determining that a radio link quality of the reference signal RS N satisfies/meets the condition (e.g., as shown in FIG. 25).

The wireless device may be provided, for each BWP of a serving cell, a set l̅₀ of CSI-R resource configuration indexes and/or SS/PBCH block indexes or two sets l̅₀ and l̅₁ of CSI-RS resource configuration indexes and/or SS/PBCH block indexes by the parameters candidateBeamRS-List and candidateBeamRS-List2. The lower layer (e.g., the PHY layer) of the wireless device may assess the radio link quality according to the set l̅₀, or l̅₀ and l̅₁, of resource configurations against a threshold and radio link quality(ies) of SS/PBCH block(s) or CSI-RS resource configuration(s) configured with qcl-Type set to ‘typeD’ in the indicated TCI state (e.g., where only the set l̅₀ is configured), or in the indicated TCI states (e.g., where the sets l̅₀ and l̅₁ are configured). For the set l̅₀, the wireless device may assess the radio link quality according to the set l̅₀ of resource configurations against a threshold and radio link quality of an SS/PBCH block or a CSI-RS resource configuration configured with qcl-Type set to ‘typeD’ in the indicated TCI state (e.g., TCI-State). For the sets l̅₀ and/or l̅₁, the wireless device may assess the radio link quality according to the sets l̅₀ and l̅₁ of resource configurations against respective thresholds (or the threshold) and radio link qualities of SS/PBCH blocks or CSI-RS resource configurations configured with qcl-Type set to ‘typeD’ in a first indicated TCI state (e.g., TCI-State) and a second indicated TCI state (e.g., TCI-State), respectively.

The threshold value may be an SSB threshold (e.g., rsrp-ThresholdSSB, sinr-ThresholdSSB). The wireless device may be configured to apply a power control offset (e.g., powerControlOffsetSS) to the first radio link quality (e.g., L1-RSRP or L1-SINR of the first reference signal), if the first reference signal is a CSI-RS, and/or to the second radio link quality (e.g., L1-RSRP or L1-SINR of the second reference signal), if the second reference signal is a CSI-RS, for example, to compare the first and second radio link qualities of the first and second reference signals.

The threshold value may be a CSI threshold (e.g., rsrp-ThresholdCSI, sinr-ThresholdCSI). The wireless device may be configured to apply a power control offset (e.g., powerControlOffsetCSI) to the first radio link quality (e.g., L1-RSRP or L1-SINR of the first reference signal), if the first reference signal is an SS/PBCH block, and/or to the second radio link quality (e.g., L1-RSRP or L1-SINR of the second reference signal), if the second reference signal is an SS/PBCH block, for example, to compare the first and second radio link qualities of the first and second reference signals.

The lower layer (e.g., the PHY layer) of the wireless device may provide an indication (e.g., TEI indication) to the higher layers (e.g., the MAC layer or the RRC layer) in a non-DRX mode operation. The lower layer (e.g., the PHY layer) of the wireless device may provide an indication (e.g., TEI indication) to the higher layers (e.g., the MAC layer or the RRC layer) in a non-DRX mode operation, for example, if/when the radio link quality for at least one corresponding resource configuration in the set l̅₀, or in the set l̅₀ or l̅₁, that the wireless device uses to assess radio link quality is a threshold value (or amount of offset) better than a radio link quality of an SS/PBCH block or a CSI-RS resource configuration configured with qcl-Type set to ‘typeD’ in the indicated TCI state (e.g., where only the set l̅₀ is configured), or in the indicated TCI states (e.g., where the sets l̅₀ and l̅₁ are configured). The lower layer (e.g., the PHY layer) may indicate/provide, to the higher layers, a CSI-RS configuration index and/or an SS/PBCH block index from the set l̅₀, or l̅₀ and l̅₁, with a corresponding L1-RSRP or L1-SINR measurement that is a threshold value (or amount of offset) better (e.g., equal to or larger) than a L1-RSRP or L1-SINR measurement of an SS/PBCH block or a CSI-RS resource configuration configured with qcl-Type set to ‘typeD’ in the indicated TCI-State(s). The lower layer (e.g., PHY layer) may inform the higher layers if/when the radio link quality of an SS/PBCH block and/or a periodic CSI-RS configurations is a threshold value (or amount of offset) better than the threshold, for example, with a periodicity determined by the maximum between the shortest periodicity among the SS/PBCH blocks and/or the periodic CSI-RS configurations in the set l̅₀, l̅₀, or l̅₁ that the wireless device uses to assess the radio link quality and a predefined duration (e.g., 2 milliseconds). The lower layer (e.g., the PHY layer) may inform the higher layers if/when the radio link quality of an SS/PBCH block and/or a periodic CSI-RS configurations is a threshold value (or amount of offset) better than the threshold, for example, with a periodicity determined by the maximum between a periodicity of the SS/PBCH block and/or the CSI-RS configuration and a predefined duration (e.g., 2 milliseconds). The lower layer (e.g., the PHY layer) may provide an indication to the higher layers in DRX mode operation, for example, if/when the radio link quality is a threshold value (or amount of offset) better than the threshold with a periodicity based on a DRX cycle length (e.g., DRX_cycle_length) and if/whether the DRX cycle length is greater than 320 milliseconds.

Successive TEI indications for a reference signal of the list/set of reference signals may be separated by at least an indication interval (e.g., T_{indication_interval_TED}). The indication interval (e.g., T_{indication_interval_TED}) may be based on a periodicity of the reference signal. Each reference signal of the list/set of reference signals may have a respective indication interval (e.g., T_{indication_interval_TED}). A common indication interval (e.g., T_{indication_interval_TED}) may be used for all reference signals of the list/set of reference signals. The common indication interval (e.g., T_{indication_interval_TED}) may be based on a shortest periodicity among all reference signals of the list/set of reference signals.

If/when DRX with a DRX cycle length equal to or less than 320 milliseconds is used/configured, the indication interval (e.g., T_{indication_interval_TED}) for the first reference signal of the list/set of reference signals may be determined based on: a maximum between a periodicity of the first reference signal and the DRX cycle length; or a maximum between a shortest/longest periodicity among the first periodicity of the first reference signal and a second periodicity of the second reference signal (e.g., the current reference signal) and the DRX cycle length. If/when DRX with a DRX cycle length greater than 320 milliseconds is used/configured, the indication interval (e.g., T_{indication_interval_TED}) for the first reference signal may be determined based on the DRX cycle length.

If/when DRX is not used/configured, the periodicity/interval for the first reference signal may be determined based on: a maximum between a first periodicity of the first reference signal and a predefined duration (e.g., 2 milliseconds); or a maximum between a shortest/longest periodicity among a first periodicity of the first reference signal and a second periodicity of the second reference signal (e.g., the current reference signal) and a predefined duration (e.g., 2 milliseconds).

If/when DRX is not used/configured, the indication interval (e.g., T_{indication_interval_TED}) may be the maximum of a predefined duration (e.g., 2 milliseconds) and T_{SSB-RS,M} or the maximum of a predefined duration (e.g., 2 milliseconds) and T_{CSI-RS,M}, where T_{SSB-RS,M} and T_{CSI-RS,M} is the periodicity of the RS resource in set l̅₀ for the accessed cell, corresponding to either the periodicity of the SSB in the set l̅₀ or the CSI-RS resource in the set l̅₀.

If/when DRX is used, for an SSB based radio link quality measurement, the indication interval (e.g., T_{indication_interval_TED}) may be determined as:
T_{indication_interval_TED}=max (1.5×DRX_cycle_length, 1.5×T_{SSB-RS,M}), if DRX_cycle_length≤320 milliseconds,
T_{indication_interval_TED}=DRX_cycle_length, if DRX_cycle_length>320 ms.

If/when DRX is used, for a CSI-RS based radio link quality measurement, the indication interval (e.g., T_{indication_interval_TED}) may be determined as:
T_{indication_interval_TED}=max (1.5×DRX_cycle_length, 1.5×T_{CSI-RS,M}), if DRX_cycle_length≤320 ms,
T_{indication_interval_TED}=DRX_cycle_length, if DRX_cycle_length>320 ms.

The upper layer may receive, from the lower layer, TEI indications, as shown in FIG. 25. The upper layer (e.g., the MAC layer) may start a timer, for the reference signal (e.g., for each reference signal in the list/set of reference signals), and increment (e.g., to 1) a TEI counter used for counting TEI indications for the reference signal (e.g., for each reference signal in the list/set of reference signals), for example, based on receiving the first TEI indication for the reference signal (e.g., for each reference signal in the list/set of reference signals) from the lower layer (e.g., the PHY layer). The upper layer may start the timer, for example, based on a beam failure detection timer value. The timer may be configured, for example, to count down from the beam failure detection timer value to zero or to count up from zero to the beam failure detection timer value. The beam failure detection timer value may be configured to the wireless device, for example, using RRC. The beam failure detection timer value may be associated with the reference signal. The beam failure detection timer value may be common for one or more or all reference signals of the list/set of reference signals. The upper layer may increment the TEI counter associated with the reference signal, for example, at every/each subsequent TEI indication for the reference signal received from the lower layer. The upper layer may reset the TEI counter associated with the reference signal to zero, for example, if the timer associated with the reference signal expires. The upper layer may detect a trigger-event for the reference signal and may trigger a UE-initiated beam report for the reference signal, for example, if the TEI counter associated with the reference signal reaches the trigger-event instance maximum counter value associated with the reference signal. The upper layer may send to the lower layer an indication of the reference signal (or an index thereof) for transmission in a beam report to the base station, for example, after or in response to triggering a UE-initiated beam report for the reference signal. The upper layer (e.g., the MAC layer) may detect a trigger-event, for example, if/when a TEI counter for reference signal RS N reaches a trigger-instance maximum counter value, as shown in FIG. 25. The upper layer (e.g., the MAC layer) may send, to the lower layer (e.g., the PHY layer), an indication of the reference signal RS N. If/when the upper layer detects a trigger-event for the reference signal, a TEI counter for a second reference signal in the list/set of reference signals may not reach a trigger-event instance maximum counter value associated with the second reference signal.

The upper layer (e.g., the MAC layer) of the wireless device may implement a counter variable EDI_COUNTER (e.g., TEI counter). The upper layer (e.g., the MAC layer) of the wireless device may implement a counter variable EDI_COUNTER (e.g., TEI counter), for example, for counting TEI indications from the lower layer. The EDI_COUNTER may be implemented per serving cell, per RS per serving cell, per ED-RS set of a serving cell configured with two ED-RS sets, or per RS of an ED-RS set of a serving cell configured with two ED-RS sets.

The upper layer (e.g., the MAC layer) may, for each serving cell configured for UEIBR, if the serving cell is configured with two ED-RS sets and if a TEI indication for an RS in an ED-RS set is received from the lower layer:
start or restart a timer (e.g., eventDetection/triggeringTimer) of the RS in the ED-RS set;
increment an EDI_COUNTER of the RS in the ED-RS set by 1; and
if the EDI_COUNTER of the RS in the ED-RS set is greater than or equal to event-detection/triggeringInstanceMaxCount:
   trigger a wireless device-initiated/UE-initiated CSI reporting (or an event-based CSI reporting or a PUCCH transmission (e.g., as shown at step 2110 in FIG. 21 and at step 2210 in FIG. 22)) for the RS in the ED-RS set of the serving cell; or
   indicate, to the lower layer (e.g., PHY layer), the RS in the ED-RS set of the serving cell for a wireless device-initiated/UE-initiated CSI reporting, or
   instruct the lower layer (e.g., PHY layer) to send (e.g., transmit)/signal a wireless device-initiated/UE-initiated CSI report indicating/for the RS (or a PUCCH transmission (e.g., as shown at step 2110 in FIG. 21 and at step 2210 in FIG. 22) on one valid PUCCH resource).

The upper layer (e.g., the MAC layer) may, for each serving cell configured for UEIBR, if a TEI indication for an RS is received from the lower layer:
start or restart a timer (e.g., eventDetection/triggeringTimer) of the RS;
increment an EDI_COUNTER of the RS by 1; and
if the EDI_COUNTER of the RS is greater than or equal to event-detection/triggeringInstanceMaxCount:
   trigger a wireless device-initiated/UE-initiated CSI reporting (or an event-based CSI reporting, or a PUCCH transmission (e.g., as shown at step 2110 in FIG. 21 and at step 2210 in FIG. 22) pre-notifying/requesting an uplink resource to carry a beam/CSI report) for the RS; or
   indicate, to the lower layer (e.g., the PHY layer), the RS for a wireless device-initiated/UE-initiated CSI reporting, or
   instruct the lower layer (e.g., the PHY layer) to send (e.g., transmit) a wireless device-initiated/UE-initiated CSI report indicating/for the RS.

The lower layer (e.g., the PHY layer) may receive the indication from the upper layer (e.g., the MAC layer). The lower layer (e.g., the PHY layer) may trigger/initiate a CSI/beam report (e.g., wireless device-initiated/UE-initiated CSI report, wireless device-initiated/UE-initiated CSI reporting procedure, event-based/trigged CSI report, event-based/trigged CSI reporting procedure, and the like) for the reference signal, for example, based on receiving the indication from the upper layer (e.g., the MAC layer). The lower layer (e.g., the PHY layer) may send (e.g., transmit) a first uplink transmission for the reference signal, for example, based on receiving the indication from the upper layer (e.g., the MAC layer).

The first uplink transmission may request an uplink resource (e.g., PUSCH/PUCCH resource) for a second uplink transmission to carry the CSI/beam report for the reference signal. The first uplink transmission may request an uplink resource (e.g., PUSCH/PUCCH resource) for a second uplink transmission to carry the CSI/beam report for the reference signal, for example, based on the first mode/option of UEIBR. The first uplink transmission may comprise a PUCCH transmission. The first uplink transmission may comprise a request that requests the resource for the second uplink transmission. The request may have a format similar to an SR. The request may be based on a new UCI type. The requested resource may be a PUSCH and/or a PUCCH resource. The wireless device may receive DCI indicating an uplink resource for the second uplink transmission, for example, based on (e.g., in response to) the first uplink transmission. The uplink resource for the second uplink transmission may comprise a PUSCH and/or a PUCCH resource. The wireless device may send (e.g., transmit) the second uplink transmission via the uplink resource for the second uplink transmission, for example, after or in response to receiving the DCI. The second uplink transmission may comprise the UE-initiated beam report for the reference signal.

The first uplink transmission may notify of a second uplink transmission that will carry the CSI/beam report for the reference signal. The first uplink transmission may notify of a second uplink transmission that will carry the CSI/beam report for the reference signal, for example, based on the second mode/operation of UEIBR. The first uplink transmission may comprise a PUCCH transmission. The first uplink transmission may comprise a notification that indicates an uplink resource, of pre-configured uplink resources. The uplink resource, of the pre-configured uplink resources, may be used by the wireless device for the second uplink transmission. The notification may have a format similar to an SR. The notification may be based on a new UCI type. The wireless device may send (e.g., transmit) the second uplink transmission via the uplink resource indicated in the first uplink transmission, for example, after or in response to notifying the second uplink transmission.

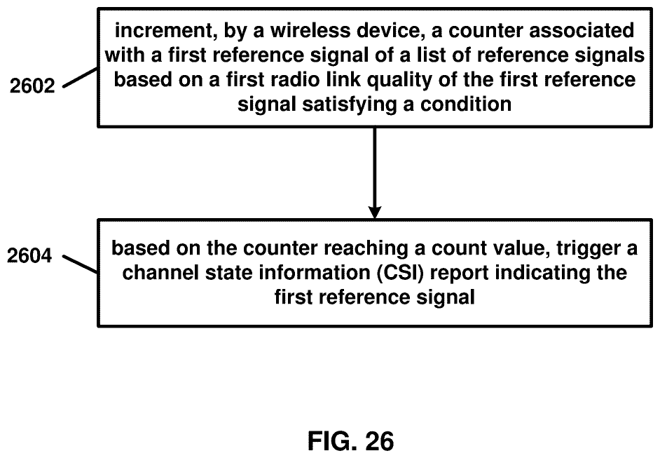

FIG. 26 shows an example method of CSI report triggering. The example method of CSI report triggering may be performed by a wireless device. At step 2602, the wireless device may increment a counter associated with a first reference signal of a list of reference signals, for example, based on a first radio link quality of the first reference signal satisfying a condition. At step 2604, the wireless device may trigger a CSI report indicating the first reference signal, for example, based on the counter reaching a count value.

The wireless device may increment the counter associated with the first reference signal based on the first radio link quality of the first reference signal satisfying a condition, as described at step 2602 in FIG. 26. The condition may comprise the first radio quality of the first reference signal being better than a second radio quality of a second reference signal. The condition may comprise the first radio quality of the reference signal being better than the second radio quality of the second reference signal, for example, by a threshold value.

The second reference signal may be indicated in a TCI state. The wireless device may receive a control command that indicates the TCI state. The control command may indicate that the TCI state is for downlink receptions, for example, by the wireless device. The TCI state may indicate/have a number of reference signals (e.g., two reference signals). The second reference signal may be associated with a quasi co-location type D (QCL-TypeD).

The wireless device may receive one or more configuration parameters. The one or more configuration parameters may indicate one or more timer values. Each timer value of the one or more timer values may be associated with a respective reference signal in the list of reference signals. The one or more timer values may comprise a timer value associated with the first reference signal.

The wireless device may start/restart a timer associated with the first reference signal. The wireless device may start/restart a timer associated with the first reference signal, for example, based on the first radio link quality of the first reference signal satisfying the condition. The timer associated with the first reference signal may start/restart, for example, based on the timer value associated with the first reference signal. The one or more configuration parameters may further indicate one or more of the list of reference signals, the count value, and/or the threshold value.

The wireless device may send a first trigger-event instance (TEI) indication. A physical layer of the wireless device may send a TEI indication to a MAC layer of the wireless device, for example, based on the first radio link quality of the first reference signal satisfying the condition. The first TEI indication may indicate the first reference signal or a reference signal index identifying the first reference signal. The MAC layer of the wireless device may increment the counter associated with the first reference signal, for example, based on the first TEI indication. The MAC layer of the wireless device may start the timer associated with the first reference signal, for example, based on the first TEI indication.

The MAC layer of the wireless may be configured. The MAC layer of the wireless device may be configured, for example, based on the counter associated with the first reference signal reaching the count value, to: trigger the CSI report; trigger an uplink transmission for the first reference signal; indicate, to the physical layer, the first reference signal for the CSI report; instruct the physical layer to send (e.g., transmit) the uplink transmission and/or the first reference signal; or instruct the physical layer to send (e.g., transmit) the CSI report indicating/for the first reference signal. The CSI report may be sent (e.g., transmitted) on an uplink channel (e.g., PUCCH/PUSCH).

The physical layer of the wireless device may be configured. The physical layer of the wireless device may be configured, for example, based on the indication of the first reference signal (or a reference signal index of the second reference signal) from the MAC layer, to: trigger the CSI report for the first reference signal; or send (e.g., transmit) the uplink transmission for the first reference signal.

The wireless device may send a second TEI indication. The physical layer of the wireless device may send a second TEI indication to the MAC layer of the wireless device, for example, based on the first radio link quality of the first reference signal satisfying the condition. The second TEI indication may indicate the first reference signal. The second TEI indication may be successive (e.g., subsequent) to the first TEI indication. The sending of the second TEI indication may be separated from the sending of the first TEI indication, for example, by at least an indication interval.

If/when discontinuous reception (DRX) is not used/configured, the indication interval may be determined by: a maximum between a first periodicity of the first reference signal and a predefined duration (e.g., 2 milliseconds); or a maximum between a shortest/longest periodicity among a first periodicity of the first reference signal and a second periodicity of the second reference signal and a predefined duration (e.g., 2 milliseconds). If/when DRX with a DRX cycle length less than or equal to 320 milliseconds is used/configured, the indication interval may be determined based on: a maximum between a periodicity of the first reference signal and a predefined duration (e.g., the DRX cycle length); or a maximum between a shortest/longest periodicity among the first periodicity of the first reference signal and a second periodicity of the second reference signal and a predefined duration (e.g., the DRX cycle length). If/when DRX with a DRX cycle length greater than 320 milliseconds is used/configured, the indication interval may be determined based on a predefined duration (e.g., the DRX cycle length).

The wireless device may receive one or more configuration parameters. The one or more configuration parameters may comprise one or more CSI reporting configuration parameters (e.g., CSI-ReportConfig). The one or more CSI reporting configuration parameters (e.g., CSI-ReportConfig) may be used to configure the CSI report. The one or more CSI reporting configuration parameters may comprise a CSI resource parameter (e.g., resourcesForChannelMeasurement, nzp-CSI-RS-ResourcesForInterference, csi-IM-ResourcesForInterference, CSI-ResourceConfigId), for example, indicating the list of reference signals. The one or more CSI reporting configuration parameters may comprise a report configuration type parameter that indicates a time domain reporting configuration. The report configuration type parameter may be set to a first value (e.g., ‘event triggered’), for example, to indicate wireless device-initiated/UE-initiated/trigger-event/event-driven reporting.

The one or more CSI reporting configuration parameters may comprise a CSI resource configuration identifier/index (e.g., CSI-ResourceConfigId). The CSI resource configuration identifier/index (e.g., CSI-ResourceConfigId) may identify a CSI resource configuration (e.g., CSI-ResourceConfig), for example, indicating a list of channel state information reference signal (CSI-RS) resource sets (e.g., csi-RS-ResourceSetList). The list of CSI-RS resource sets may comprise a single CSI-RS resource set, for example, based on the report configuration type parameter being set to the first value (e.g., ‘event triggered’). The list of CSI-RS resource sets (or the single CSI-RS resource set) may indicate the list of reference signals.

The wireless device may send (e.g., transmit) a first uplink transmission for the CSI report. The first uplink transmission may request an uplink resource (e.g., PUSCH/PUCCH resource) for transmission of the CSI report; or notify/pre-notify transmission of the CSI report. The wireless device may send (e.g., transmit) the CSI report, for example, after or in response to sending (e.g., transmitting) the first uplink transmission.

The second reference signal may be a CSI-RS. The first/second radio link quality may comprise a layer 1 received signal received power (L1-RSRP) measurement of the first/second reference signal or a signal-to-interference-plus-noise ratio (SINR) based on the first/second reference signal.

The first/second radio link quality may comprise: the L1-RSRP measurement of the first/second reference signal, for example, based on the first/second reference signal being an SS/PBCH block; or the L1-RSRP measurement of the first/second reference signal scaled by a power control offset (e.g., powerControlOffsetSS), for example, based on the first/second reference signal being a CSI_RS. The first/second radio link quality may comprise: the L1-RSRP measurement of the first reference signal, for example, based on the first reference signal being a CSI-RS; or the L1-RSRP measurement of the first reference signal scaled by a power control offset (e.g., powerControlOffsetCSI), for example, based on the first reference signal being a synchronization signal (SS)/physical broadcast channel (PBCH) block.

The wireless device may send (e.g., transmit) a capability message (e.g. a wireless device capability message). The capability message (e.g. the wireless device capability message) may comprise a first parameter (e.g., maxNumberCSI-RS-SSB-EBD, maxNumberCSI-RS-SSB-UEIBR, maxNumberCSI-RS-EBD, maxNumberCSI-RS-UEIBR, maxNumberSSB-EBD, maxNumberSSB-UEIBR), for example, indicating a maximum/maximal number of different reference signal (e.g., CSI-RS and/or SSB) resources across all cells and across a master cell group (MCG) and a secondary cell group (SCG) for new/candidate beam/RS identifications for the CSI report triggered by the wireless device. The capability message (e.g. the wireless device capability message) may comprise a second parameter (e.g., maxNumberCellEBD, maxNumberCellUEIBR), for example, indicating a maximum number of cells (e.g., SCells only or all cells) configured for the CSI report triggered by the wireless device. The capability message may comprise the first parameter, for example, based on the capability message comprising the second parameter.

The list of reference signals may comprise a number of/quantity of reference signals (or a number of/quantity of reference signal indexes). The list of reference signals may comprise up to a number of/quantity of reference signals (or up to a number of/quantity of reference signal indexes), for example, where the number of/quantity of reference signals is: fixed (e.g., 2); or indicated by a third parameter (e.g., maxED-RS-resourcesPerBWP, maxED-RS-resourcesPerBWPPerReportConfig) in a capability message sent (e.g., transmitted) by the wireless device. Based on a third radio link quality of a third reference signal, in the list of the reference signals, not satisfying the condition, the wireless device may determine to: not start a timer associated with the third reference signal; or not increment a counter associated with the third reference signal.

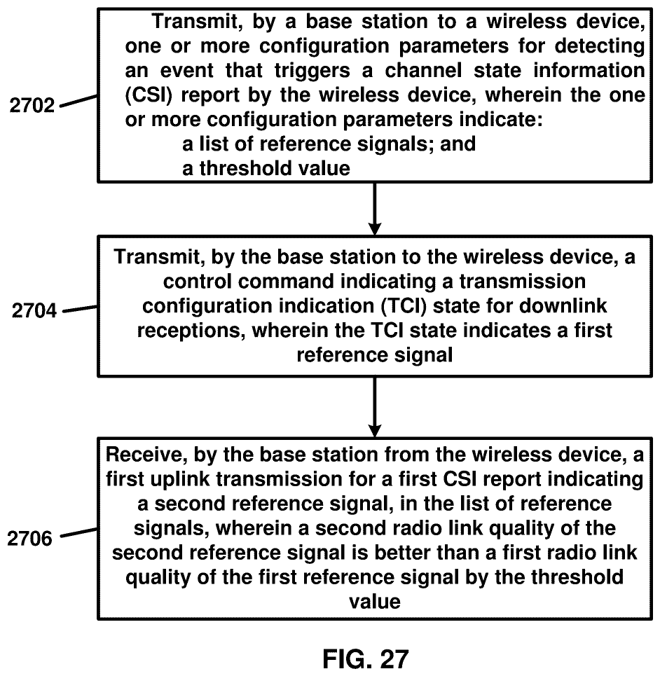

FIG. 27 shows an example method of CSI report triggering. The example method of CSI report triggering may be performed by a base station. At step 2702, the base station may send (e.g., transmit) (e.g., to a wireless device) one or more configuration parameters for detecting an event that triggers a CSI report by the wireless device. The one or more configuration parameters may indicate: a list of reference signals and/or a threshold value. The one or more configuration parameters may, for example, indicate a maximum instance count value. At step 2704, the base station may send (e.g., transmit) (e.g., to the wireless device) a control command indicating a TCI state for downlink receptions. The TCI state may indicate a first reference signal. At step 2706, the base station may receive (e.g., from the wireless device) a first uplink transmission for a first CSI report indicating a second reference signal, in the list of reference signals, for example, where a second radio link quality of the second reference signal is better than a first radio link quality of the first reference signal by the threshold value.

The base station may receive (e.g., from the wireless device) the first CSI report. The base station may receive (e.g., from the wireless device) the first CSI report, for example, after or in response to receiving the first uplink transmission (e.g., the first uplink transmission at step 2706 in FIG. 27). The base station may receive the first CSI report on an uplink channel (e.g., a PUCCH and/or a PUSCH).

The one or more configuration parameters further comprise one or more CSI reporting configuration parameters (e.g., CSI-ReportConfig). The one or more CSI reporting configuration parameters (e.g., CSI-ReportConfig) may be used to configure the CSI report. The one or more CSI reporting configuration parameters may comprise a CSI resource parameter (e.g., resourcesForChannelMeasurement, nzp-CSI-RS-ResourcesForInterference, csi-IM-ResourcesForInterference, CSI-ResourceConfigId), for example, indicating the list of reference signals. The one or more CSI reporting configuration parameters may comprise a report configuration type parameter, for example, indicating a time domain reporting configuration. The report configuration type parameter may be set to a first value (e.g., ‘event triggered’), for example, to indicate wireless-device-initiated/UE-initiated/trigger-event/event-driven reporting.

The one or more CSI reporting configuration parameters may comprise a CSI resource configuration identifier/index (e.g., CSI-ResourceConfigId). The CSI resource configuration identifier/index (e.g., CSI-ResourceConfigId) may identify a CSI resource configuration (e.g., CSI-ResourceConfig), for example, indicating a list of channel state information reference signal (CSI-RS) resource sets (e.g., csi-RS-ResourceSetList). The list of CSI-RS resource sets may comprise a single CSI-RS resource set, for example, based on the report configuration type parameter being set to the first value (e.g., ‘event triggered’). The list of CSI-RS resource sets (or the single CSI-RS resource set) may indicate the list of reference signals.

The first uplink transmission may request an uplink resource (e.g., a PUSCH/PUCCH resource). The first uplink transmission may request an uplink resource (e.g., a PUSCH resource and/or a PUCCH resource), for example, for transmission of the CSI report and/or to notify/pre-notify the transmission of the CSI report.

The first reference signal may be a CSI-RS. The first/second radio link quality may comprise a layer 1 received signal received power (L1-RSRP) measurement of the first/second reference signal or a signal-to-interference-plus-noise ratio (SINR) based on the first/second reference signal. The first/second radio link quality may comprise: the L1-RSRP measurement of the first/second reference signal, for example, based on the first/second reference signal being an SS/PBCH block; or the L1-RSRP measurement of the first/second reference signal scaled by a power control offset (e.g., powerControlOffsetSS), for example, based on the first/second reference signal being a CSI_RS. The first/second radio link quality may comprise: the L1-RSRP measurement of the first reference signal, for example, based on the first reference signal being a CSI-RS; or the L1-RSRP measurement of the first reference signal scaled by a power control offset (e.g., powerControlOffsetCSI), for example, based on the first reference signal being a SS/PBCH block.

The base station may receive (e.g., from the wireless device) a capability message (e.g., a wireless device capability message). The capability message (e.g., the wireless device capability message) may comprise a first parameter (e.g., maxNumberCSI-RS-SSB-EBD, maxNumberCSI-RS-SSB-UEIBR, maxNumberCSI-RS-EBD, maxNumberCSI-RS-UEIBR, maxNumberSSB-EBD, maxNumberSSB-UEIBR), for example, indicating a maximum/maximal number of different reference signal (e.g., CSI-RS and/or SSB) resources across all cells and across a master cell group (MCG) and a secondary cell group (SCG) for new/candidate beam/RS identifications for the CSI report triggered by the wireless device.

The base station may receive (e.g., from the wireless device) a capability message (e.g., a wireless device capability message). The capability message (e.g., the wireless device capability message) may comprise a second parameter (e.g., maxNumberCellEBD, maxNumberCellUEIBR), for example, indicating a maximum number of cells (e.g., SCells (e.g., only SCells) or all cells) configured for the CSI report triggered by the wireless device. The capability message may comprise the first parameter, for example, based on the capability message comprising the second parameter.

The list of reference signals may comprise up to a number of/quantity of reference signals (or up to a number of/quantity of reference signal indexes). The list of reference signals may comprise up to a number of/quantity of reference signals (or up to a number of/quantity of reference signal indexes), for example where the number of/quantity of reference signals is: fixed (e.g., 2, or any other value); or indicated by a third parameter (e.g., maxED-RS-resourcesPerBWP, maxED-RS-resourcesPerBWPPerReportConfig) in a capability message (e.g., received from the wireless device).

A wireless device may perform a method comprising multiple operations. The wireless device may send an indication of a maximum number of reference signals associated with channel state information (CSI) reporting triggered by the wireless device. The wireless device may receive at least one radio resource control (RRC) message, for example, comprising at least one CSI report configuration parameter associated with CSI reporting triggered by the wireless device. The at least one CSI report configuration parameter may indicate a reference signal resource set, for example, comprising at least one reference signal. The at least one CSI report configuration parameter may indicate a threshold radio link quality. The at least one CSI report configuration parameter may indicate an event instance count value, for example, associated with a reference signal. The wireless device may receive a control command, for example, indicating a transmission configuration indication (TCI) state. The TCI state may indicate a second reference signal. The wireless device may send a first uplink transmission for a CSI report triggered by the wireless device, for example, based on a first radio link quality of a first reference signal in the reference signal resource set satisfying the threshold radio link quality above a second radio link quality of the second reference signal a threshold number of times satisfying the event instance count value. The wireless device may send the CSI report indicating the first reference signal, for example, after or in response to sending the first uplink transmission. The wireless device may determine an evaluation periodicity for CSI reporting triggered by the wireless device. The evaluation periodicity may be determined, for example, based on a shortest periodicity of the at least one reference signal and the second reference signal indicated by the TCI state. The evaluation periodicity may be determined, for example, based on a maximum of a predefined duration and at least one of: a shortest periodicity of the at least one reference signal and the second reference signal indicated by the TCI state; a largest periodicity of the at least one reference signal and the second reference signal indicated by the TCI state; or a periodicity of a reference signal in the at least one reference signal. The wireless device may send a second uplink transmission, for example, via an uplink resource of a Type 1 configured grant and at a time offset after the first uplink transmission. The second uplink transmission may carry a CSI report indicating the first reference signal. The first uplink transmission may comprise a notification of the second uplink transmission. The uplink resource may be an earliest uplink resource, among uplink resources of the Type 1 configured uplink grant, for example, that occurs the time offset after the first uplink transmission. The at least one CSI report configuration parameter may indicate the time offset. The at least one reference signal may be a CSI reference signal (CSI-RS). The at least one reference signal may be a synchronization and system block (SSB). The second reference signal may be a CSI-RS associated with a quasi co-location type D (QCL-TypeD). The second reference signal may be an SSB that is quasi co-located with the CSI-RS. The wireless device may send a second uplink transmission, for example, via an uplink resource and after or in response to the first uplink transmission. The second uplink transmission may carry a CSI report indicating the first reference signal. The first uplink transmission may comprise a request for the uplink resource. The wireless device may receive downlink control information (DCI), for example, after or in response to the first uplink transmission. The DCI may indicate the uplink resource. The wireless device may increment an event instance counter associated with the first reference signal, for example, based on the first radio link quality of the first reference signal satisfying the threshold radio link quality above the second radio link quality of the second reference signal. Each reference signal of the at least one reference signal may have/comprise a respective event instance counter. The wireless device may send a first uplink transmission for a CSI report triggered by the wireless device, for example, based on an event instance counter associated with the first reference signal satisfying the event instance count value. The wireless device may start an event detection timer associated with the first reference signal, for example, based on the first radio link quality of the first reference signal satisfying the threshold radio link quality above the second radio link quality of the second reference signal. The at least one CSI report configuration parameter may indicate a respective event detection timer value for each reference signal of the at least one reference signal. The event detection timer associated with the first reference signal may be based on an event detection timer value associated with the first reference signal. The at least one CSI report configuration parameter may comprise a report configuration type parameter, for example, set to be event triggered. The at least one CSI report configuration parameter may comprise a report configuration type parameter, for example, set to be wireless device-initiated. The report configuration type parameter may indicate a time domain reporting configuration. The wireless device may compare a respective radio link quality of each reference signal of the at least one reference signal with the radio link quality of the second reference signal. The wireless device may increment a second event instance counter associated with a third reference signal in the reference signal resource set, for example, based on a third radio link quality of the third reference signal satisfying the threshold radio link quality above the second radio link quality of the second reference signal. The wireless device may reset the event instance counter associated with the first reference signal, for example, based on an expiry of the event detection timer. A higher layer of the wireless device may be configured to indicate, to a lower layer of the wireless device, the first reference signal for the CSI report. The lower layer may be configured to notify the first CSI report indicating the first reference signal, for example, based on an indication of the first reference signal from the higher layer. The lower layer may be configured to send the first uplink transmission for the first CSI report, for example, based on an indication of the first reference signal from the higher layer. The wireless device may comprise one or more processors; and memory storing instructions that, when executed by the one or more processors, cause the wireless device to perform the described method, additional operations and/or include the additional elements. A system may comprise a wireless device configured to perform the described method, additional operations and/or include the additional elements; and a base station configured to send one or more messages. A computer-readable medium may store instructions that, when executed, cause performance of the described method, additional operations, and/or include the additional elements.

A wireless device may perform a method comprising multiple operations. The wireless device may receive at least one message, for example, comprising at least one configuration parameter for detecting an event that triggers a CSI report by the wireless device. The at least one configuration parameter may indicate a list of reference signals comprising at least one reference signal. The at least one configuration parameter may indicate a threshold radio link quality. The at least one configuration parameter may indicate an event instance count value, for example, associated with a reference signal. The wireless device may receive a control command, for example, indicating a TCI state for downlink reception. The TCI state may indicate a second reference signal. The wireless device may send a first uplink transmission for a first CSI report indicating a first reference signal, for example, based on a first radio link quality of the first reference signal in the list of reference signals satisfying the threshold radio link quality above a second radio link quality of the second reference signal a threshold number of times satisfying the event instance count value. The wireless device may send the first CSI report, for example, based on a first radio link quality of the first reference signal in the list of reference signals satisfying the threshold radio link quality above a second radio link quality of the second reference signal a threshold number of times satisfying the event instance count value. The wireless device may send the first CSI report, for example, after or in response to sending the first uplink transmission. The wireless device may send an indication of a maximum number of reference signals for the detecting an event that triggers a CSI report by the wireless device. A lower layer of the wireless device may send, to a higher layer of the wireless device, a first trigger-event instance (TEI) indication, for example, based on the first radio link quality of the first reference signal satisfying the threshold radio link quality above the second radio link quality of the second reference signal. The first TEI indication may indicate the first reference signal. The higher layer of the wireless device may increment a counter associated with the first reference signal, for example, based on the first TEI indication. The higher layer of the wireless device may start a timer associated with the first reference signal, for example, based on the first TEI indication. The lower layer of the wireless device may send, to the higher layer of the wireless device, a second TEI indication, for example, based on the first radio link quality of the first reference signal satisfying the threshold radio link quality above the second radio link quality of the second reference signal. The second TEI indication may indicate the first reference signal. The lower layer of the wireless device may send the second TEI indication, for example, an indication interval after sending the first TEI indication. The higher layer of the wireless device may increment the counter associated with the first reference signal, for example, based on the second TEI indication. The higher layer of the wireless device may restart the timer associated with the first reference signal, for example, based on the second TEI indication. The lower layer of the wireless device may send the first TEI indication, for example, based on the first radio link quality of the first reference signal being greater than the second radio link quality of the second reference signal by the threshold radio link quality. The threshold number of times satisfying the event instance counter may correspond to the threshold number of times being greater than or equal to the event instance count value. The wireless device may determine an indication interval for the detecting an event that triggers a CSI report by the wireless device. The wireless device may determine the indication interval, for example, based on a shortest periodicity of the at least one reference signal in the list of reference signals and the second reference signal indicated by the TCI state. The wireless device may determine the indication interval, for example, based on a maximum of a predefined duration and at least one of: a shortest periodicity of the at least one reference signal in the list of reference signals and the second reference signal indicated by the TCI state; a largest periodicity of the at least one reference signal in the list of reference signals and the second reference signal indicated by the TCI state; or a periodicity of a reference signal in the list of reference signals. The first uplink transmission may request an uplink resource for transmission of the first CSI report. The first uplink transmission may notify transmission of the CSI report. The wireless device may comprise one or more processors; and memory storing instructions that, when executed by the one or more processors, cause the wireless device to perform the described method, additional operations and/or include the additional elements. A system may comprise a wireless device configured to perform the described method, additional operations and/or include the additional elements; and a base station configured to send one or more messages. A computer-readable medium may store instructions that, when executed, cause performance of the described method, additional operations, and/or include the additional elements.

A base station may perform a method comprising multiple operations. The base station may send at least one message, for example, comprising at least one CSI report configuration parameter for detecting an event that triggers a CSI report by a wireless device. The at least one CSI report configuration parameter may indicate a reference signal resource set, for example, comprising at least one reference signal. The at least one CSI report configuration parameter may indicate a threshold radio link quality. The at least one CSI report configuration parameter may indicate an event instance count value, for example, associated with a reference signal. The base station may send a control command, for example, indicating a TCI state for downlink reception. The TCI state may indicate a second reference signal. The base station may receive a first uplink transmission for a first CSI report, for example, indicating a first reference signal of the at least one reference signal. A first radio link quality of the first reference signal may satisfy the threshold radio link quality above a second radio link quality of the second reference signal. The base station may receive the first CSI report, for example, after or in response to receiving the first uplink transmission. The base station may receive the first CSI report, for example, based on the first radio link quality of the first reference signal satisfying the threshold radio link quality above the second radio link quality of the second reference signal a threshold number of times satisfying the event instance count value. The base station may receive the first CSI report, for example, via an uplink channel. The first uplink transmission may comprise a notification of a second uplink transmission that carries the first CSI report, for example, via an uplink resource of a Type 1 configured uplink grant. The base station may receive an indication of a maximum number of reference signals for the detecting an event that triggers a CSI report by a wireless device. The indication of a maximum number of reference signals may comprise a second parameter, for example, indicating a maximum number of cells configured for the CSI reporting triggered by the wireless device. The indication of a maximum number of reference signals may comprise a first parameter, for example, indicating a maximum number of reference signals across all cells and across a master cell group (MCG) and a secondary cell group (SCG). The base station may comprise one or more processors; and memory storing instructions that, when executed by the one or more processors, cause the base station to perform the described method, additional operations and/or include the additional elements. A system may comprise a base station configured to perform the described method, additional operations and/or include the additional elements; and a wireless device configured to receive the one or more messages. A computer-readable medium may store instructions that, when executed, cause performance of the described method, additional operations, and/or include the additional elements.

A wireless device may perform a method comprising multiple operations. The wireless device may send (e.g., transmit), to a base station, a capability information message, for example, indicating a maximum number of reference signals for a channel state information (CSI) reporting triggered by the wireless device. The wireless device may receive one or more radio resource control (RRC) messages, for example, comprising one or more CSI report configuration parameters for the CSI reporting triggered by the wireless device. The one or more CSI report configuration parameters may indicate a reference signal resource set, for example, comprising one or more reference signals. The one or more CSI report configuration parameters may indicate a threshold value. The one or more CSI report configuration parameters may indicate a maximum instance count value. The wireless device may receive a control command, for example, indicating a transmission configuration indication (TCI) state. The TCI state may indicate a second reference signal. The wireless device may increment an event instance counter of a first reference signal, for example, based on a first radio link quality of the first reference signal of the one or more reference signals being higher than a second radio link quality of the second reference signal by the threshold value. Each reference signal of the one or more reference signals may have/comprise a respective event instance counter. The wireless device may send (e.g., transmit) a first uplink transmission for the CSI reporting triggered by the wireless device, for example, based on the event instance counter of the first reference signal being equal to or greater than the maximum instance count value. The wireless device may determine an evaluation periodicity of/for the CSI reporting triggered by the wireless device, for example, based on a shortest periodicity of the one or more reference signals and the second reference signal indicated by the TCI state. The wireless device may determine an evaluation periodicity of/for the CSI reporting triggered by the wireless device, for example, based on a maximum of a predefined duration and at least one of: a shortest periodicity of the one or more reference signals and the second reference signal indicated by the TCI state; a largest periodicity of the one or more reference signals and the second reference signal indicated by the TCI state; or a periodicity of a reference signal in the one or more reference signals. The evaluation periodicity of/for the CSI reporting may be, for example, based on DRX cycle length. The one or more reference signals may be/comprise one or more CSI reference signals (CSI-RSs). The one or more reference signals may be/comprise one or more synchronization and system blocks (SSBs). The control command may be/comprise downlink control information (DCI). The control command may be/comprise a medium-access control element (MAC CE). The second reference signal may be/comprise a CSI-RS associated with a quasi co-location type D (QCL-TypeD). The second reference signal may be/comprise an SSB that is quasi co-located with the CSI-RS. The first radio link quality may be/comprise a first layer 1 reference signal received power (L1-RSRP). The second radio link quality may be/comprise a second L1-RSRP. The wireless device may increment the event instance counter of the first reference signal, for example, by one. The wireless device may compare a respective radio link quality of each reference signal of the one or more reference signals with a radio link quality of the second reference signal. The wireless device may increment a second event instance counter of a third reference signal, for example, based on a third radio link quality of the third reference signal of the one or more reference signals being higher (e.g., greater) than the second radio link quality of the second reference signal by the threshold value. The one or more CSI report configuration parameters may further indicate a respective event detection timer for each reference signal of the one or more reference signals. The wireless device may start an event detection timer of the first reference signal, for example, based on the first radio link quality of the first reference signal being higher than the second radio link quality of the second reference signal by the threshold value. The wireless device may reset the event instance counter of the first reference signal, for example, based on an expiry of the event detection timer. The first uplink transmission may request an uplink resource for a second uplink transmission that carries a CSI report indicating the first reference signal, for example, in a first CSI reporting mode. The wireless device may receive DCI indicating the uplink resource, for example, after or in response to the first uplink transmission. The wireless device may send (e.g., transmit) the second uplink transmission, for example, via the uplink resource. The first uplink transmission may notify of a second uplink transmission that carries a CSI report indicating the first reference signal, for example, in a second CSI reporting mode. The wireless device may send (e.g., transmit) the second uplink transmission, for example, a time offset after the first uplink transmission. The one or more CSI report configuration parameters may indicate the time offset. The wireless device may send (e.g., transmit) the second uplink transmission, for example, via an uplink resource of a Type 1 configured uplink grant. The uplink resource may be an earliest uplink resource, among uplink resources of the Type 1 configured uplink grant, for example, that occurs the time offset after the first uplink transmission. The wireless device may trigger the CSI reporting, for example, based on the event instance counter of the first reference signal being equal to or greater than the maximum instance count value. The maximum number of reference signals may be across all cells in both a master cell group (MCG) and a secondary cell group (SCG). The maximum number of reference signals may be per bandwidth part (BWP). The capability information message may indicate a maximum number of cells configured with CSI reporting triggered by the wireless device. A number of the one or more reference signals may be up to the maximum number of reference signals. The one or more CSI report configuration parameters may comprise a report configuration type parameter, for example, set to event triggered. The one or more CSI report configuration parameters may comprise a report configuration type parameter, for example, set to UE-initiated. The wireless device may comprise one or more processors; and memory storing instructions that, when executed by the one or more processors, cause the wireless device to perform the described method, additional operations and/or include the additional elements. A system may comprise a wireless device configured to perform the described method, additional operations and/or include the additional elements; and a base station configured to send one or more messages. A computer-readable medium may store instructions that, when executed, cause performance of the described method, additional operations, and/or include the additional elements.

A wireless device may perform a method comprising multiple operations. The wireless device may receive one or more configuration parameters for detecting an event that triggers a channel state information (CSI) report by the wireless device. The one or more configuration parameters may indicate a list of reference signals. The one or more configuration parameters may indicate timer values. Each timer value of the timer values may be associated with a respective reference signal in the list of reference signals. The one or more configuration parameters may indicate a maximum instance count value. The one or more configuration parameters may indicate a threshold value. The wireless device may receive a control command, for example, indicating a transmission configuration indication (TCI) state for downlink receptions. The TCI state may indicate a first reference signal. The wireless device may increment a counter associated with a second reference signal, for example, based on a second radio link quality of the second reference signal in the list of reference signals being better than a first radio link quality of the first reference signal by the threshold value. The wireless device may start/restart a timer associated with the second reference signal based on a timer value, of the timer values, associated with the second reference signal, for example, based on the second radio link quality of the second reference signal in the list of reference signals being better than the first radio link quality of the first reference signal by the threshold value. The wireless device may trigger a first CSI report indicating the second radio link quality of the second reference signal, for example, based on the counter associated with the second reference signal reaching the maximum instance count value. The wireless device may send (e.g., transmit) a first uplink transmission for the first CSI report, for example, based on the counter associated with the second reference signal reaching the maximum instance count value. The wireless device may send (e.g., transmit) the first CSI report, for example, based on the counter associated with the second reference signal reaching the maximum instance count value. The wireless device may send (e.g., transmit) the first CSI report, for example, after or in response to sending (e.g., transmitting) the first uplink transmission. The wireless device may comprise one or more processors; and memory storing instructions that, when executed by the one or more processors, cause the wireless device to perform the described method, additional operations and/or include the additional elements. A system may comprise a wireless device configured to perform the described method, additional operations and/or include the additional elements; and a base station configured to send one or more messages. A computer-readable medium may store instructions that, when executed, cause performance of the described method, additional operations, and/or include the additional elements.

A wireless device may perform a method comprising multiple operations. The wireless device may increment a counter associated with a first reference signal of a list of reference signals, for example, based on a first radio link quality of the first reference signal satisfying a condition. The wireless device may trigger a channel state information (CSI) report indicating the first reference signal, for example, based on the counter reaching a count value. The condition may comprise the first radio quality of the first reference signal being better than a second radio quality of a second reference signal. The condition may comprise the first radio quality of the reference signal being better than the second radio quality of the second reference signal by a threshold value. A transmission configuration indication (TCI) state may indicate the second reference signal. The wireless device may receive a control command that indicates the TCI state. The control command may indicate that the TCI state is for downlink receptions, for example, by the wireless device. The wireless device may receive one or more configuration parameters, for example, indicating timer values. Each timer value of the timer values may be associated with a respective reference signal in the list of reference signals. The timer values may comprise a timer value associated with the first reference signal. The wireless device may start (e.g., restart) a timer associated with the first reference signal, for example, based on the first radio link quality of the first reference signal satisfying the condition. The wireless device may start the timer associated with the first reference signal, for example, based on the timer value associated with the first reference signal. The one or more configuration parameters may indicate the list of reference signals. The one or more configuration parameters may indicate the count value. The one or more configuration parameters may indicate the threshold value. A physical layer of the wireless device may send a first trigger-event instance (TEI) indication to a medium access control (MAC) layer of the wireless device, for example, based on the first radio link quality of the first reference signal satisfying the condition. The first TEI indication may indicate the first reference signal. The MAC layer of the wireless device may increment the counter associated with the first reference signal, for example, based on the first TEI indication. The MAC layer of the wireless device may start (e.g., restart) the timer associated with the first reference signal. The MAC layer of the wireless device may be configured to trigger the CSI report. The MAC layer of the wireless device may be configured to trigger an uplink transmission for the first reference signal. The MAC layer of the wireless device may be configured to indicate, to the physical layer, the first reference signal for the CSI report. The MAC layer of the wireless device may be configured to instruct the physical layer to send (e.g., transmit) the uplink transmission and/or the first reference signal. The MAC layer of the wireless device may be configured to instruct the physical layer to send (e.g., transmit) the CSI report indicating/for the first reference signal. The physical layer of the wireless device may be configured to trigger the CSI report for the first reference signal, for example, based on (e.g., upon) indication of the first reference signal (or a reference signal index of the second reference signal) from the MAC layer. The physical layer of the wireless device may be configured to send (e.g., transmit) the uplink transmission for the first reference signal, for example, based on (e.g., upon) indication of the first reference signal (or a reference signal index of the second reference signal) from the MAC layer. The physical layer of the wireless device may send, to the MAC layer of the wireless device, a second TEI indication indicating the first reference signal, for example, based on the first radio link quality of the first reference signal satisfying the condition. The second TEI indication may be, for example, successive to the first TEI indication. The sending of the second TEI indication may be separated from the sending of the first TEI indication, for example, by at least an (e.g., one) indication interval. The wireless device may determine the indication interval by/based on a maximum between a first periodicity of the first reference signal and 2 milliseconds, for example, if/when discontinuous reception (DRX) is not used/configured. The wireless device may determine the indication interval by/based on a maximum between a shortest/longest periodicity among a first periodicity of the first reference signal, a second periodicity of the second reference signal, and 2 milliseconds, for example, if/when DRX is not used/configured. The wireless device may determine the indication interval based on a maximum between a periodicity of the first reference signal and a DRX cycle length, for example, if/when DRX with the DRX cycle length equal to or less than 320 milliseconds is used/configured. The wireless device may determine the indication interval based on a maximum between a shortest/longest periodicity among the first periodicity of the first reference signal, a second periodicity of the second reference signal, and the DRX cycle length, for example, if/when DRX with the DRX cycle length equal to or less than 320 milliseconds is used/configured. The transmission configuration indication (TCI) state may indicate the second reference signal. The TCI state may indicate/have/comprise two reference signals. The second reference signal may be associated with a quasi co-location type D (QCL-TypeD). The wireless device may determine the indication interval based on a DRX cycle length, for example, if/when DRX with the DRX cycle length greater than 320 milliseconds is used/configured. The wireless device may receive one or more configuration parameters, for example, comprising one or more CSI reporting configuration parameters that are used to configure the CSI report. The wireless device may send (e.g., transmit) the CSI report, for example, on an uplink channel. The one or more CSI reporting configuration parameters may comprise a CSI resource parameter, for example, indicating the list of reference signals. The one or more CSI reporting configuration parameters may comprise a report configuration type parameter, for example, set to event triggered. The report configuration type parameter may indicate a time domain reporting configuration. The one or more CSI reporting configuration parameters may comprise a CSI resource configuration identifier/index, for example, identifying a CSI resource configuration indicating a list of channel state information reference signal (CSI-RS) resource sets. The list of CSI-RS resource sets may comprise a single CSI-RS resource set, for example, based on the report configuration type parameter being set to event triggered. The list of CSI-RS resource sets may indicate the list of reference signals. The wireless device may send (e.g., transmit) a first uplink transmission for the CSI report. The first uplink transmission may request an uplink resource for transmission of the CSI report. The first uplink transmission may notify/pre-notify transmission of the CSI report. The wireless device may send (e.g., transmit) the CSI report, for example, after or in response to sending (e.g., transmitting) the first uplink transmission. The second reference signal may be/comprise a CSI-RS. The first radio link quality may comprise a layer 1 received signal received power (L1-RSRP) measurement of the first reference signal. The first radio link quality may comprise a signal-to-interference-plus-noise ratio (SINR) based on the first reference signal. The first radio link quality may comprise the L1-RSRP measurement of the first reference signal, for example, based on the first reference signal being a synchronization signal (SS) and/or a physical broadcast channel (PBCH) block. The first radio link quality may comprise the L1-RSRP measurement of the first reference signal scaled by a power control offset, for example, based on the first reference signal being a CSI-RS. The first radio link quality may comprise the L1-RSRP measurement of the first reference signal, for example, based on the first reference signal being a CSI-RS. The first radio link quality may comprise the L1-RSRP measurement of the first reference signal scaled by a power control offset, for example, based on the first reference signal being a SS and/or a PBCH block. The wireless device may send (e.g., transmit) a capability message comprising a first parameter, for example, indicating a maximum/maximal number of different reference signal (e.g., CSI-RS and/or SSB) resources across all cells and across a master cell group (MCG) and a secondary cell group (SCG) for new/candidate beam/RS identifications for the CSI report triggered by the wireless device. The wireless device may send (e.g., transmit) a capability message comprising a second parameter, for example, indicating a maximum number of cells configured for the CSI report triggered by the wireless device. A capability message may comprise the first parameter, for example, based on the capability message comprising the second parameter. The list of reference signals may comprise, for example, up to a number of reference signals. The number of reference signals may be fixed. The number of reference signals may be indicated by a third parameter in a capability message sent (e.g., transmitted) by the wireless device. The wireless device may not start a timer associated with a third reference signal, for example, based on a third radio link quality of the third reference signal, in the list of the reference signals, not satisfying the condition. The wireless device may not increment a counter associated with the third reference signal, for example, based on the third radio link quality of the third reference signal, in the list of the reference signals, not satisfying the condition. The wireless device may comprise one or more processors; and memory storing instructions that, when executed by the one or more processors, cause the wireless device to perform the described method, additional operations and/or include the additional elements. A system may comprise a wireless device configured to perform the described method, additional operations and/or include the additional elements; and a base station configured to send one or more messages. A computer-readable medium may store instructions that, when executed, cause performance of the described method, additional operations, and/or include the additional elements.

A base station may perform a method comprising multiple operations. The base station may send (e.g., transmit), to a wireless device, one or more configuration parameters for detecting an event that triggers a channel state information (CSI) report by the wireless device. The one or more configuration parameters may indicate a list of reference signals. The one or more configuration parameters may indicate a maximum instance count value. The one or more configuration parameters may indicate a threshold value. The base station may send (e.g., transmit), to the wireless device, a control command, for example, indicating a transmission configuration indication (TCI) state for downlink receptions. The TCI state may indicate a first reference signal. The base station may receive, from the wireless device, a first uplink transmission for a first CSI report, for example, indicating a second reference signal, in the list of reference signals. A second radio link quality of the second reference signal may be better than a first radio link quality of the first reference signal by the threshold value. The base station may receive, from the wireless device, the first CSI report, for example, after or in response to receiving the first uplink transmission. The wireless device may trigger the first CSI report, for example, based on a counter associated with the second reference signal reaching the maximum instance count. The base station may comprise one or more processors; and memory storing instructions that, when executed by the one or more processors, cause the base station to perform the described method, additional operations and/or include the additional elements. A system may comprise a base station configured to perform the described method, additional operations and/or include the additional elements; and a wireless device configured to receive the one or more messages. A computer-readable medium may store instructions that, when executed, cause performance of the described method, additional operations, and/or include the additional elements.

A base station may perform a method comprising multiple operations. The base station may send (e.g., transmit), to a wireless device, one or more configuration parameters for detecting an event that triggers a channel state information (CSI) report by the wireless device. The one or more configuration parameters may indicate a list of reference signals. The one or more configuration parameters may indicate a threshold value. The base station may send (e.g., transmit), to the wireless device, a control command, for example, indicating a transmission configuration indication (TCI) state for downlink receptions. The TCI state may indicate a first reference signal. The base station may receive, from the wireless device, a first uplink transmission for a first CSI report, for example, indicating a second reference signal, in the list of reference signals. A second radio link quality of the second reference signal may be better than a first radio link quality of the first reference signal by the threshold value. The base station may receive, from the wireless device, the first CSI report, for example, after or in response to receiving the first uplink transmission. The one or more configuration parameters may indicate a maximum instance count value. The one or more configuration parameters may comprise one or more CSI reporting configuration parameters, for example, used to configure the CSI report. The base station may receive the CSI report, for example, on an uplink channel. The one or more CSI reporting configuration parameters may comprise a CSI resource parameter, for example, indicating the list of reference signals. The one or more CSI reporting configuration parameters may comprise a report configuration type parameter, for example, set to event triggered. The report configuration type parameter may indicate a time domain reporting configuration. The one or more CSI reporting configuration parameters may comprise a CSI resource configuration identifier/index, for example, identifying a CSI resource configuration indicating a list of channel state information reference signal (CSI-RS) resource sets. The list of CSI-RS resource sets may comprise a single CSI-RS resource set, for example, based on the report configuration type parameter being set to event triggered. The list of CSI-RS resource sets may indicate the list of reference signals. The first uplink transmission may request an uplink resource for transmission of the CSI report. The first uplink transmission may notify/pre-notify transmission of the CSI report. The first reference signal may be/comprise a channel state information reference signal (CSI-RS). The first/second radio link quality may comprise a layer 1 received signal received power (L1-RSRP) measurement of the first/second reference signal. The first/second radio link quality may comprise a signal-to-interference-plus-noise ratio (SINR) based on the first/second reference signal. The first/second radio link quality may comprise the L1-RSRP measurement of the first/second reference signal, for example, based on the first/second reference signal being a synchronization signal (SS) and/or a physical broadcast channel (PBCH) block. The first/second radio link quality may comprise the L1-RSRP measurement of the first/second reference signal scaled by a power control offset, for example, based on the first/second reference signal being a channel state information reference signal (CSI-RS). The first/second radio link quality may comprise the L1-RSRP measurement of the first/second reference signal, for example, based on the first/second reference signal being a CSI-RS. The first/second radio link quality may comprise the L1-RSRP measurement of the first/second reference signal scaled by a power control offset, for example, based on the first/second reference signal being a SS and/or a PBCH block. The base station may receive, from the wireless device, a capability message comprising a first parameter. The first parameter may indicate a maximum/maximal number of (different) reference signal (e.g., CSI-RS and/or SSB) resources across all cells and across a master cell group (MCG) and a secondary cell group (SCG) for new/candidate beam/RS identifications for the CSI report triggered by the wireless device. The base station may receive, from the wireless device, a capability message comprising a second parameter. The second parameter may indicate a maximum number of cells configured for the CSI report triggered by the wireless device. A capability message may comprise the first parameter, for example, based on the capability message comprising the second parameter. The list of reference signal may comprise, for example, up to a number of reference signals. The number of reference signals may be fixed. The number of reference signals may be indicated by a third parameter in a capability message, for example, received from the wireless device. The base station may comprise one or more processors; and memory storing instructions that, when executed by the one or more processors, cause the base station to perform the described method, additional operations and/or include the additional elements. A system may comprise a base station configured to perform the described method, additional operations and/or include the additional elements; and a wireless device configured to receive the one or more messages. A computer-readable medium may store instructions that, when executed, cause performance of the described method, additional operations, and/or include the additional elements.

One or more of the operations described herein may be conditional. For example, one or more operations may be performed if certain criteria are met, such as in a wireless device, a base station, a radio environment, a network, a combination of the above, and/or the like. Example criteria may be based on one or more conditions such as wireless device and/or network node configurations, traffic load, initial system set up, packet sizes, traffic characteristics, a combination of the above, and/or the like. If the one or more criteria are met, various examples may be used. It may be possible to implement any portion of the examples described herein in any order and based on any condition.

A base station may communicate with one or more of wireless devices. Wireless devices and/or base stations may support multiple technologies, and/or multiple releases of the same technology. Wireless devices may have some specific capability(ies) depending on wireless device category and/or capability(ies). A base station may comprise multiple sectors, cells, and/or portions of transmission entities. A base station communicating with a plurality of wireless devices may refer to a base station communicating with a subset of the total wireless devices in a coverage area. Wireless devices referred to herein may correspond to a plurality of wireless devices compatible with a given LTE, 5G, 6G, or other 3GPP or non-3GPP release with a given capability and in a given sector of a base station. A plurality of wireless devices may refer to a selected plurality of wireless devices, a subset of total wireless devices in a coverage area, and/or any group of wireless devices. Such devices may operate, function, and/or perform based on or according to drawings and/or descriptions herein, and/or the like. There may be a plurality of base stations and/or a plurality of wireless devices in a coverage area that may not comply with the disclosed methods, for example, because those wireless devices and/or base stations may perform based on older releases of LTE, 5G, 6G, or other 3GPP or non-3GPP technology.

One or more parameters, fields, and/or Information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAS, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

A non-transitory tangible computer readable media may comprise instructions executable by one or more processors configured to cause operations of multi-carrier communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as base stations, wireless devices or user equipment (wireless device), servers, switches, antennas, and/or the like. A network may comprise any wireless technology, including but not limited to, cellular, wireless, WiFi, 4G, 5G, 6G, any generation of 3GPP or other cellular standard or recommendation, any non-3GPP network, wireless local area networks, wireless personal area networks, wireless ad hoc networks, wireless metropolitan area networks, wireless wide area networks, global area networks, satellite networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

1. A method comprising:
sending, by a wireless device, an indication of a maximum number of reference signals associated with channel state information (CSI) reporting triggered by the wireless device;
receiving at least one radio resource control (RRC) message comprising at least one CSI report configuration parameter associated with CSI reporting triggered by the wireless device, wherein the at least one CSI report configuration parameter indicates:
a reference signal resource set comprising at least one reference signal;
a threshold radio link quality; and
an event instance count value associated with a reference signal;
receiving a control command indicating a transmission configuration indication (TCI) state, wherein the TCI state indicates a second reference signal; and
based on a first radio link quality of a first reference signal in the reference signal resource set satisfying the threshold radio link quality above a second radio link quality of the second reference signal a threshold number of times satisfying the event instance count value, sending a first uplink transmission for a CSI report triggered by the wireless device.

2. The method of claim 1, further comprising:
after sending the first uplink transmission, sending the CSI report indicating the first reference signal.

3. The method of claim 1, further comprising determining an evaluation periodicity for CSI reporting triggered by the wireless device, wherein the evaluation periodicity is determined based on:
a shortest periodicity of the at least one reference signal and the second reference signal indicated by the TCI state; or
a maximum of:
a predefined duration; and
at least one of:
a shortest periodicity of the at least one reference signal and the second reference signal indicated by the TCI state;
a largest periodicity of the at least one reference signal and the second reference signal indicated by the TCI state; or
a periodicity of a reference signal in the at least one reference signal.

4. The method of claim 1, further comprising sending, via an uplink resource of a Type 1 configured uplink grant and at a time offset after the first uplink transmission, a second uplink transmission that carries a CSI report indicating the first reference signal, wherein:
the first uplink transmission comprises a notification of the second uplink transmission;
the uplink resource is an earliest uplink resource, among uplink resources of the Type 1 configured uplink grant, that occurs the time offset after the first uplink transmission; and
the at least one CSI report configuration parameter indicates the time offset.

5. The method of claim 1, wherein the at least one reference signal is a CSI reference signal (CSI-RS) or a synchronization and system block (SSB), and wherein the second reference signal is a CSI-RS associated with a quasi co-location type D (QCL-TypeD) or an SSB that is quasi co-located with the CSI-RS.

6. The method of claim 1, further comprising sending, via an uplink resource and after the first uplink transmission, a second uplink transmission that carries a CSI report indicating the first reference signal, wherein:
the first uplink transmission comprises a request for the uplink resource; and
downlink control information (DCI), received after the first uplink transmission, indicates the uplink resource.

7. The method of claim 1, further comprising:
incrementing, based on the first radio link quality of the first reference signal satisfying the threshold radio link quality above the second radio link quality of the second reference signal, an event instance counter associated with the first reference signal, wherein:
each reference signal of the at least one reference signal has a respective event instance counter; and
the sending a first uplink transmission for a CSI report triggered by the wireless device is based on an event instance counter associated with the first reference signal satisfying the event instance count value.

8. The method of claim 1, further comprising:
starting, based on the first radio link quality of the first reference signal satisfying the threshold radio link quality above the second radio link quality of the second reference signal, an event detection timer associated with the first reference signal, wherein:
the at least one CSI report configuration parameter indicates a respective event detection timer value for each reference signal of the at least one reference signal; and
the event detection timer associated with the first reference signal is based on an event detection timer value associated with the first reference signal.

9. The method of claim 1, wherein the at least one CSI report configuration parameter comprises a report configuration type parameter set to be event triggered or wireless device-initiated, and wherein the report configuration type parameter indicates a time domain reporting configuration.

10. A method comprising:
receiving, by a wireless device, at least one message comprising at least one configuration parameter for detecting an event that triggers a CSI report by the wireless device, wherein the at least one configuration parameter indicates:
a list of reference signals comprising at least one reference signal;
a threshold radio link quality; and
an event instance count value associated with a reference signal;
receiving a control command indicating a TCI state for downlink reception, wherein the TCI state indicates a second reference signal; and
based on a first radio link quality of a first reference signal in the list of reference signals satisfying the threshold radio link quality above a second radio link quality of the second reference signal a threshold number of times satisfying the event instance count value:
sending a first uplink transmission for a first CSI report indicating the first reference signal; and
after sending the first uplink transmission, sending the first CSI report.

11. The method of claim 10, further comprising:
sending an indication of a maximum number of reference signals for the detecting an event that triggers a CSI report by the wireless device.

12. The method of claim 10, further comprising:
based on the first radio link quality of the first reference signal satisfying the threshold radio link quality above the second radio link quality of the second reference signal, sending, by a lower layer of the wireless device to a higher layer of the wireless device, a first trigger-event instance (TEI) indication, wherein the first TEI indication indicates the first reference signal; and
based on the first TEI indication:
incrementing, by the higher layer of the wireless device, a counter associated with the first reference signal; and
starting, by the higher layer of the wireless device, a timer associated with the first reference signal.

13. The method of claim 12, further comprising:
based on the first radio link quality of the first reference signal satisfying the threshold radio link quality above the second radio link quality of the second reference signal, sending, by the lower layer of the wireless device to the higher layer of the wireless device, a second TEI indication, wherein:
the second TEI indication indicates the first reference signal; and
the sending of the second TEI indication is an indication interval after the sending of the first TEI indication; and
based on the second TEI indication:
incrementing, by the higher layer of the wireless device, the counter associated with the first reference signal; and
restarting, by the higher layer of the wireless device, the timer associated with the first reference signal.

14. The method of claim 12, wherein the sending the first TEI indication is based on the first radio link quality of the first reference signal being greater than the second radio link quality of the second reference signal by the threshold radio link quality, and wherein the threshold number of times satisfying the event instance count value corresponds to the threshold number of times being greater than or equal to the event instance count value.

15. The method of claim 10, further comprising determining an indication interval for the detecting an event that triggers a CSI report by the wireless device, wherein the indication interval is determined based on:
a shortest periodicity of the at least one reference signal in the list of reference signals and the second reference signal indicated by the TCI state; or
a maximum of:
a predefined duration; and
at least one of:
a shortest periodicity of the at least one reference signal in the list of reference signals and the second reference signal indicated by the TCI state;
a largest periodicity of the at least one reference signal in the list of reference signals and the second reference signal indicated by the TCI state; or
a periodicity of a reference signal in the list of reference signals.

16. The method of claim 10, wherein the first uplink transmission:
requests an uplink resource for transmission of the first CSI report; or
notifies transmission of the CSI report.

17. A method comprising:
sending, by a base station, at least one message comprising at least one CSI report configuration parameter for detecting an event that triggers a CSI report by a wireless device, wherein the at least one CSI report configuration parameter indicates:
a reference signal resource set comprising at least one reference signal;
a threshold radio link quality; and
an event instance count value associated with a reference signal;
sending a control command indicating a TCI state for downlink reception, wherein the TCI state indicates a second reference signal;
receiving a first uplink transmission for a first CSI report indicating a first reference signal of the at least one reference signal, wherein a first radio link quality of the first reference signal satisfies the threshold radio link quality above a second radio link quality of the second reference signal; and
after receiving the first uplink transmission, receiving the first CSI report, wherein the receiving the first CSI report is based on the first radio link quality of the first reference signal satisfying the threshold radio link quality above the second radio link quality of the second reference signal a threshold number of times satisfying the event instance count value.

18. The method of claim 17, wherein the receiving the first CSI report comprises receiving the first CSI report via an uplink channel.

19. The method of claim 17, wherein the first uplink transmission comprises a notification of a second uplink transmission that carries the first CSI report via an uplink resource of a Type 1 configured uplink grant.

20. The method of claim 17, further comprising receiving an indication of a maximum number of reference signals for the detecting an event that triggers a CSI report by a wireless device, wherein the indication of a maximum number of reference signals comprises:
a second parameter indicating a maximum number of cells configured for the CSI reporting triggered by the wireless device; and
a first parameter indicating a maximum number of reference signals across all cells and across a master cell group (MCG) and a secondary cell group (SCG).
